(19) United States
(12) Patent Application Publication
(10) Pub. No.: US 2026/0101212 A1
(43) Pub. Date: Apr. 9, 2026

(54) DATA PROCEDURES ASSOCIATED WITH ACCESS STRATUM STATES OR USE CASES

(71) Applicant: QUALCOMM Incorporated, San Diego, CA (US)

(72) Inventors: Rajeev KUMAR, San Diego, CA (US); Mohammed Ali Mohammed HIRZALLAH, San Diego, CA (US); Aziz GHOLMIEH, Del Mar, CA (US); Taesang YOO, San Diego, CA (US)

(21) Appl. No.: 19/348,745

(22) Filed: Oct. 2, 2025

Related U.S. Application Data
(60) Provisional application No. 63/703,134, filed on Oct. 3, 2024.

(51) Int. Cl. H04W 24/08; H04L 41/16; H04W 74/0833

(52) U.S. Cl. CPC H04W 24/08; H04L 41/16; H04W 74/0833

(57) ABSTRACT

Some examples of the techniques described herein may include handling one or more data collection procedures based on an access stratum state or access stratum buffer status. In some approaches, a user equipment (UE) may be configured for training data collection for one or more use cases (e.g., artificial intelligence or machine learning (AI/ML)-related use cases for one or more access stratum states). Collected training data may be reported to different network entities (e.g., to a network node for channel state information (CSI) feedback, beam management, or AI/ML based mobility, or to a location management function (LMF) for positioning, among other examples). In some approaches, data collection configuration may be performed based on an access stratum state. For instance, one or more indications may be utilized regarding one or more access stratum states in which training data collection may be performed.

### CROSS REFERENCE

The present Application for Patent claims priority to U.S. Provisional Ser. No. 63/703,134 by KUMAR et al., entitled “DATA PROCEDURES ASSOCIATED WITH ACCESS STRATUM STATES OR USE CASES FOR ARTIFICIAL INTELLIGENCE OR MACHINE LEARNING-BASED TRAINING,” filed Oct. 3, 2024, assigned to the assignee hereof, and expressly incorporated by reference in its entirety herein.

### FIELD OF TECHNOLOGY

The following relates to wireless communications, including data procedures associated with access stratum states or use cases for artificial intelligence or machine learning-based training.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a wireless device is described. The method may include outputting, to one or more network entities based on one or more use cases, capability information indicating a capability of the wireless device to participate in a data collection procedure, where the capability information indicates one or more parameters for the data collection procedure, and where the data collection procedure is associated with data for the one or more use cases and obtaining, from the one or more network entities based on the one or more use cases, configuration information indicating that the wireless device is configured for the data collection procedure.

A wireless device is described. The wireless device may include one or more memories storing processor executable code, and one or more processors coupled with the one or more memories. The one or more processors may individually or collectively be operable to execute the code to cause the wireless device to output, to one or more network entities based on one or more use cases, capability information indicating a capability of the wireless device to participate in a data collection procedure, where the capability information indicates one or more parameters for the data collection procedure, and where the data collection procedure is associated with data for the one or more use cases and obtain, from the one or more network entities based on the one or more use cases, configuration information indicating that the wireless device is configured for the data collection procedure.

Another wireless device is described. The wireless device may include means for outputting, to one or more network entities based on one or more use cases, capability information indicating a capability of the wireless device to participate in a data collection procedure, where the capability information indicates one or more parameters for the data collection procedure, and where the data collection procedure is associated with data for the one or more use cases and means for obtaining, from the one or more network entities based on the one or more use cases, configuration information indicating that the wireless device is configured for the data collection procedure.

A non-transitory computer-readable medium storing code is described. The code may include instructions executable by one or more processors to output, to one or more network entities based on one or more use cases, capability information indicating a capability of the wireless device to participate in a data collection procedure, where the capability information indicates one or more parameters for the data collection procedure, and where the data collection procedure is associated with data for the one or more use cases and obtain, from the one or more network entities based on the one or more use cases, configuration information indicating that the wireless device is configured for the data collection procedure.

In some examples of the method, wireless devices, and non-transitory computer-readable medium described herein, the capability information indicates at least one of the one or more use cases corresponding to the capability of the wireless device to participate in the data collection procedure.

In some examples of the method, wireless devices, and non-transitory computer-readable medium described herein, the one or more use cases include an AI/ML-based channel state information (CSI) feedback use case, an AI/ML-based beam management use case, an AI/ML-based mobility use case, an AI/ML-based positioning use case, an AI/ML-based cell reselection use case, an AI/ML-based random access channel (RACH) procedure, a use case for AI/ML-based power management, a non-AI/ML-based CSI feedback use case, a non-AI/ML-based beam management use case, a non-AI/ML-based mobility use case, a non-AI/ML-based positioning use case, a non-AI/ML-based cell reselection use case, a non-AI/ML-based RACH procedure, a use case for non-AI/ML-based power management, or a sensing use case.

In some examples of the method, wireless devices, and non-transitory computer-readable medium described herein, the one or more parameters indicated by the capability information include a quantity of samples of at least a portion of the data, a size of at least a portion of the data, an age of at least a portion of the data, a quality of the data collected, or any combination thereof.

In some examples of the method, wireless devices, and non-transitory computer-readable medium described herein, one or more access stratum states include a connected state, an inactive state, or an idle state and the configuration information indicates that the wireless device may be configured to participate in the data collection procedure in at least one of the connected state, the inactive state, the idle state, or any combination thereof.

Some examples of the method, wireless devices, and non-transitory computer-readable medium described herein may further include operations, features, means, or instructions for participating in the data collection procedure for at least one of the one or more access stratum states based on the configuration information, where participating in the data collection procedure includes performing one or more measurements associated with data collection, data logging, data reporting, or any combination thereof.

Some examples of the method, wireless devices, and non-transitory computer-readable medium described herein may further include operations, features, means, or instructions for outputting, to the one or more network entities based on the one or more use cases, an indication of availability of the data.

In some examples of the method, wireless devices, and non-transitory computer-readable medium described herein, the indication of availability indicates at least one of the one or more use cases associated with the data.

In some examples of the method, wireless devices, and non-transitory computer-readable medium described herein, the indication of availability indicates a quantity of samples of the data, a size of the data, an age of the data corresponding to at least one of the one or more use cases, or a quality of the data collected (e.g., in at least one of the one or more access stratum states or of the one or more use cases).

Some examples of the method, wireless devices, and non-transitory computer-readable medium described herein may further include operations, features, means, or instructions for obtaining, from at least one of the one or more network entities, a request for at least a portion of the data.

In some examples of the method, wireless devices, and non-transitory computer-readable medium described herein, the request indicates a condition to select the at least a portion of the data and the at least a portion of the data may be selected based on the condition.

In some examples of the method, wireless devices, and non-transitory computer-readable medium described herein, the condition includes a quantity of samples of the at least a portion of the data, a size of the at least a portion of the data, an age of the at least a portion of the data, a use case of the at least a portion of the data, a quality of the at least a portion of the data collected (e.g., in at least one of the one or more access stratum states or of the one or more use cases), or any combination thereof.

Some examples of the method, wireless devices, and non-transitory computer-readable medium described herein may further include operations, features, means, or instructions for outputting, to at least one of the one or more network entities, at least a portion of the data.

Some examples of the method, wireless devices, and non-transitory computer-readable medium described herein may further include operations, features, means, or instructions for outputting, to at least one of the one or more network entities, an indication of an access stratum state associated with the at least a portion of the data, an indication of a configuration identifier associated with the at least a portion of the data, an indication of a level of a configuration associated with the at least a portion of the data, or any combination thereof.

Some examples of the method, wireless devices, and non-transitory computer-readable medium described herein may further include operations, features, means, or instructions for outputting the at least a portion of the data includes outputting all of the data to the one or more network entities, outputting the at least a portion of the data based on at least one use case, or outputting the at least a portion of the data based on a requested size or quantity of samples.

In some examples of the method, wireless devices, and non-transitory computer-readable medium described herein, the configuration information indicates at least one use case or at least one access stratum state for performing one or more measurements associated with data collection, for performing data logging, for performing data reporting, or any combination thereof.

In some examples of the method, wireless devices, and non-transitory computer-readable medium described herein, the configuration information indicates a first level of the data collection procedure and a second level of the data collection procedure for at least one use case or for at least one access stratum state and the second level of the data collection procedure utilizes fewer resources than the first level.

In some examples of the method, wireless devices, and non-transitory computer-readable medium described herein, the second level of the data collection procedure may be associated with an operating condition of the wireless device.

In some examples of the method, wireless devices, and non-transitory computer-readable medium described herein, the wireless device may be a user equipment (UE) and the one or more network entities include a network node, a network function, an access and mobility management function (AMF), a location management function (LMF), a sensing management function (SnMF), or a server.

A method by a network entity is described. The method may include obtaining, from a wireless device based on one or more use cases, capability information indicating a capability of the wireless device to participate in a data collection procedure, where the capability information indicates one or more parameters for the data collection procedure, and where the data collection procedure is associated with data for the one or more use cases and outputting, to the wireless device based on the one or more use cases, configuration information indicating that the wireless device is configured for the data collection procedure.

A network entity is described. The network entity may include one or more memories storing processor executable code, and one or more processors coupled with the one or more memories. The one or more processors may individually or collectively be operable to execute the code to cause the network entity to obtain, from a wireless device based on one or more use cases, capability information indicating a capability of the wireless device to participate in a data collection procedure, where the capability information indicates one or more parameters for the data collection procedure, and where the data collection procedure is associated with data for the one or more use cases and output, to the wireless device based on the one or more use cases, configuration information indicating that the wireless device is configured for the data collection procedure.

Another network entity is described. The network entity may include means for obtaining, from a wireless device based on one or more use cases, capability information indicating a capability of the wireless device to participate in a data collection procedure, where the capability information indicates one or more parameters for the data collection procedure, and where the data collection procedure is associated with data for the one or more use cases and means for outputting, to the wireless device based on the one or more use cases, configuration information indicating that the wireless device is configured for the data collection procedure.

A non-transitory computer-readable medium storing code is described. The code may include instructions executable by one or more processors to obtain, from a wireless device based on one or more use cases, capability information indicating a capability of the wireless device to participate in a data collection procedure, where the capability information indicates one or more parameters for the data collection procedure, and where the data collection procedure is associated with data for training an AI/ML model for the one or more use cases and output, to the wireless device based on the one or more use cases, configuration information indicating that the wireless device is configured for the data collection procedure.

In some examples of the method, network entities, and non-transitory computer-readable medium described herein, the capability information indicates at least one of the one or more use cases corresponding to the capability of the wireless device to participate in the data collection procedure.

In some examples of the method, network entities, and non-transitory computer-readable medium described herein, the one or more use cases include an AI/ML-based CSI feedback use case, an AI/ML-based beam management use case, an AI/ML-based mobility use case, an AI/ML-based positioning use case, an AI/ML-based cell reselection use case, an AI/ML-based RACH procedure, a use case for AI/ML-based power management, a non-AI/ML-based CSI feedback use case, a non-AI/ML-based beam management use case, a non-AI/ML-based mobility use case, a non-AI/ML-based positioning use case, a non-AI/ML-based cell reselection use case, a non-AI/ML-based RACH procedure, a use case for non-AI/ML-based power management, or a sensing use case.

In some examples of the method, network entities, and non-transitory computer-readable medium described herein, the one or more parameters indicated by the capability information include a quantity of samples of at least a portion of the data, a size of at least a portion of the data, or an age of at least a portion of the data, a quality of the data collected, or any combination thereof.

In some examples of the method, network entities, and non-transitory computer-readable medium described herein, one or more access stratum states include a connected state, an inactive state, or an idle state and the configuration information indicates that the wireless device may be configured to participate in the data collection procedure in at least one of the connected state, the inactive state, the idle state, or any combination thereof.

Some examples of the method, network entities, and non-transitory computer-readable medium described herein may further include operations, features, means, or instructions for obtaining, from the wireless device based on the one or more use cases, an indication of availability of the data.

In some examples of the method, network entities, and non-transitory computer-readable medium described herein, the indication of availability indicates at least one of the one or more use cases associated with the data.

In some examples of the method, network entities, and non-transitory computer-readable medium described herein, the indication of availability indicates a quantity of samples of the data, a size of the data, an age of the data corresponding to at least one of the one or more use cases, or a quality of the data collected (e.g., in at least one of the one or more access stratum states or of the one or more use cases).

Some examples of the method, network entities, and non-transitory computer-readable medium described herein may further include operations, features, means, or instructions for outputting, to the wireless device, a request for at least a portion of the data.

In some examples of the method, network entities, and non-transitory computer-readable medium described herein, the request indicates a condition to select the at least a portion of the data and the at least a portion of the data may be selected based on the condition.

In some examples of the method, network entities, and non-transitory computer-readable medium described herein, the condition includes a quantity of samples of the at least a portion of the data, a size of the at least a portion of the data, an age of the at least a portion of the data, a use case of the at least a portion of the data, a quality of the at least a portion of the data collected (e.g., in at least one of the one or more access stratum states or of the one or more use cases), or any combination thereof.

Some examples of the method, network entities, and non-transitory computer-readable medium described herein may further include operations, features, means, or instructions for obtaining, from the wireless device, at least a portion of the data.

Some examples of the method, network entities, and non-transitory computer-readable medium described herein may further include operations, features, means, or instructions for obtaining, from the wireless device, an indication of an access stratum state associated with the at least a portion of the data, an indication of a configuration identifier associated with the at least a portion of the data, or an indication of a level of a configuration associated with the at least a portion of the data.

Some examples of the method, network entities, and non-transitory computer-readable medium described herein may further include operations, features, means, or instructions for obtaining the at least a portion of the data includes obtaining all of the data from the wireless device, obtaining the at least a portion of the data based on at least one use case, or obtaining the at least a portion of the data based on a requested size or quantity of samples.

In some examples of the method, network entities, and non-transitory computer-readable medium described herein, the configuration information indicates at least one use case and at least one access stratum state for performing one or more measurements associated with data collection, for performing data logging, for performing data reporting, or any combination thereof.

In some examples of the method, network entities, and non-transitory computer-readable medium described herein, the configuration information indicates a first level of the data collection procedure and a second level of the data collection procedure for at least one use case or for at least one access stratum state and the second level of the data collection procedure utilizes fewer resources than the first level.

In some examples of the method, network entities, and non-transitory computer-readable medium described herein, the second level of the data collection procedure may be associated with an operating condition of the wireless device.

In some examples of the method, network entities, and non-transitory computer-readable medium described herein, the wireless device may be a UE and the network entity includes a network node, a network function, an AMF, a LMF, SnMF, or a server.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports data procedures associated with access stratum states or use cases in accordance with one or more aspects of the present disclosure.

FIG. 2 shows an example of a network structure that supports data procedures associated with access stratum states or use cases in accordance with one or more aspects of the present disclosure.

FIG. 3 shows an example of a network architecture that supports data procedures associated with access stratum states or use cases in accordance with one or more aspects of the present disclosure.

FIG. 4 shows an example of a wireless communications system that supports data procedures associated with access stratum states or use cases in accordance with one or more aspects of the present disclosure.

FIG. 5 shows an example of a process flow that supports data procedures associated with access stratum states or use cases in accordance with one or more aspects of the present disclosure.

FIG. 6 shows an example of a process flow that supports data procedures associated with access stratum states or use cases in accordance with one or more aspects of the present disclosure.

FIG. 7 shows an example of a process flow that supports data procedures associated with access stratum states or use cases in accordance with one or more aspects of the present disclosure.

FIG. 8 shows an example of a process flow that supports data procedures associated with access stratum states or use cases in accordance with one or more aspects of the present disclosure.

FIGS. 9 and 10 show block diagrams of devices that support data procedures associated with access stratum states or use cases in accordance with one or more aspects of the present disclosure.

FIG. 11 shows a block diagram of a communications manager that supports data procedures associated with access stratum states or use cases in accordance with one or more aspects of the present disclosure.

FIG. 12 shows a diagram of a system including a device that supports data procedures associated with access stratum states or use cases in accordance with one or more aspects of the present disclosure.

FIGS. 13 and 14 show block diagrams of devices that support data procedures associated with access stratum states or use cases in accordance with one or more aspects of the present disclosure.

FIG. 15 shows a block diagram of a communications manager that supports data procedures associated with access stratum states or use cases in accordance with one or more aspects of the present disclosure.

FIG. 16 shows a diagram of a system including a device that supports data procedures associated with access stratum states or use cases in accordance with one or more aspects of the present disclosure.

FIGS. 17 through 20 show flowcharts illustrating methods that support data procedures associated with access stratum states or use cases in accordance with one or more aspects of the present disclosure.

FIG. 21 shows examples of wireless communications systems that support data procedures associated with access stratum states or use cases in accordance with one or more aspects of the present disclosure.

FIG. 22 shows an example of a node diagram that supports data procedures associated with access stratum states or use cases in accordance with one or more aspects of the present disclosure.

FIGS. 23A and 23B show examples of block diagrams that support data procedures associated with access stratum states or use cases in accordance with one or more aspects of the present disclosure.

FIG. 24 shows examples of block diagrams that support data procedures associated with access stratum states or use cases in accordance with one or more aspects of the present disclosure.

FIG. 25 shows examples of sensing modes that support data procedures associated with access stratum states or use cases in accordance with one or more aspects of the present disclosure

### DETAILED DESCRIPTION

Some wireless communication systems may perform one or more operations associated with one or more use cases. A use case may be an indication of one or more operations (e.g., tasks, functions, or procedures). Examples of use cases may include channel state information (CSI) feedback (e.g., CSI measurement or reporting, among other examples), beam management (e.g., beam measurement or beam switching, among other examples), positioning (e.g., position determination or tracking, among other examples), or mobility (e.g., cell switching or handover, among other examples), among other examples.

In some approaches, one or more operations associated with one or more use cases may be partially or completely performed using one or more artificial intelligence or machine learning (AI/ML) models (e.g., network-side models). Training data may be information that may be utilized to train one or more AI/ML models. Some examples of training data may include ground truth data (e.g., data representing one or more target outputs or labels) or input data (e.g., input data associated with the ground truth data). Training data may be obtained (e.g., measured or captured) or generated.

Some wireless communications systems may include one or more network entities. Examples of network entities may include a gNodeB (gNB), access and mobility management function (AMF), location management function (LMF), or other network functions or services, among other examples. Different network entities may utilize different training data associated with different use cases for training one or more AI/ML models to perform one or more of the operations associated with the one or more use cases. For instance, a gNB may utilize training data related to AI/ML-based CSI feedback, a gNB may utilize training data related to AI/ML-based beam management, an LMF or sensing management function (SnMF) may utilize training data related to AI/ML-based positioning or sensing or non-AI/ML-based positioning or sensing, or a gNB may utilize training data related to AI/ML-based mobility or non-AI/ML-based mobility. As illustrated by this discussion, there may be a demand for procedures or signaling for collecting training data for one or more network entities or for one or more use cases.

In some approaches, data collection for AI/ML model training may be performed for one or more access stratum states. The access stratum may be a layer in a protocol for communications between devices (e.g., between a user equipment (UE) and a network entity). For example, the access stratum may be a layer at which one or more operations for data connectivity or radio resource management may be performed. An access stratum state may be an operating state of one or more devices (e.g., a UE) that may impact or relate to one or more operations of the access stratum. Examples of access stratum states may include a connected state (e.g., a radio resource control (RRC) connected state), an inactive state (e.g., an RRC inactive state), or an idle state (e.g., an RRC idle state). In some approaches, training data collection may be performed for CSI feedback, beam management, positioning, sensing, or other use cases in the connected state (e.g., RRC connected state). Additionally, or alternatively, training data collection may be performed for positioning, sensing, or other uses cases in the inactive state or the idle state (e.g., RRC inactive or idle state).

In some examples, a UE may store logged training data at the access stratum layer with a memory size (e.g., minimum access stratum layer memory size) supported by the UE for one or more (e.g., all) use cases. When a UE reaches a buffer limitation, the UE may stop measurement for data collection purposes or logging. In some approaches, access stratum buffer event-based reporting may be supported. For instance, communicating an availability indication or a report may be supported.

Some examples of the techniques described herein may include handling one or more data collection procedures based on an access stratum state or access stratum buffer status. In some approaches, a UE may be configured for training data collection for one or more use cases (e.g., AI/ML-related use cases for one or more access stratum states). Collected training data may be reported to different network entities (e.g., to a gNB for CSI feedback, beam management, or AI/ML based mobility, to an LMF for positioning, or to an SnMF for sensing, among other examples).

In some examples, data collection configuration may be performed based on an access stratum state. For instance, one or more indications may be utilized regarding one or more access stratum states in which training data collection may be performed. Additionally, or alternatively, a relaxation specific to an access stratum state may be configured (for one or more different use cases) at a UE. A “relaxation” may refer to a reduction in a quantity of resources utilized to perform an operation (e.g., data collection). For instance, a relaxation (e.g., a second level of a training data collection procedure) may utilize fewer resources to conduct data collection (e.g., relative to a first level of a training data collection procedure). In some approaches, a relaxation may utilize fewer measurement targets (e.g., fewer transmission-reception points (TRPs)), fewer reference signals, or a larger measurement periodicity.

In some examples, collected training data may be reported based on access stratum buffer status. In some approaches, an availability indication may be sent in complete RRC messages. Utilizing complete RRC messages for an availability indication may increase overhead consumption. In some approaches, UE assistance information may be utilized for communicating an availability indication or for a positioning or sensing use case. In some aspects, an availability indication or collected training data report may be communicated per use case.

Some examples of the techniques described herein may support UE reporting of an availability indication concurrently to a radio access network (RAN) and one or more network functions or services. In some aspects, an availability indication may be communicated via a long term evolution (LTE) positioning protocol (LPP) for a positioning or sensing use case. In some examples of the techniques described herein, a gNB may request training data reporting per use case.

Aspects of the disclosure are described in the context of wireless communications systems. Aspects of the disclosure are also described in the context of a wireless network structure. Aspects of the disclosure are further described in the context of a network architecture. Aspects of the disclosure are additionally described in the context of process flows. Aspects of the disclosure are further illustrated by and described with reference to apparatus diagrams, system diagrams, flowcharts, a node diagram, and block diagrams that relate to data procedures associated with access stratum states or use cases.

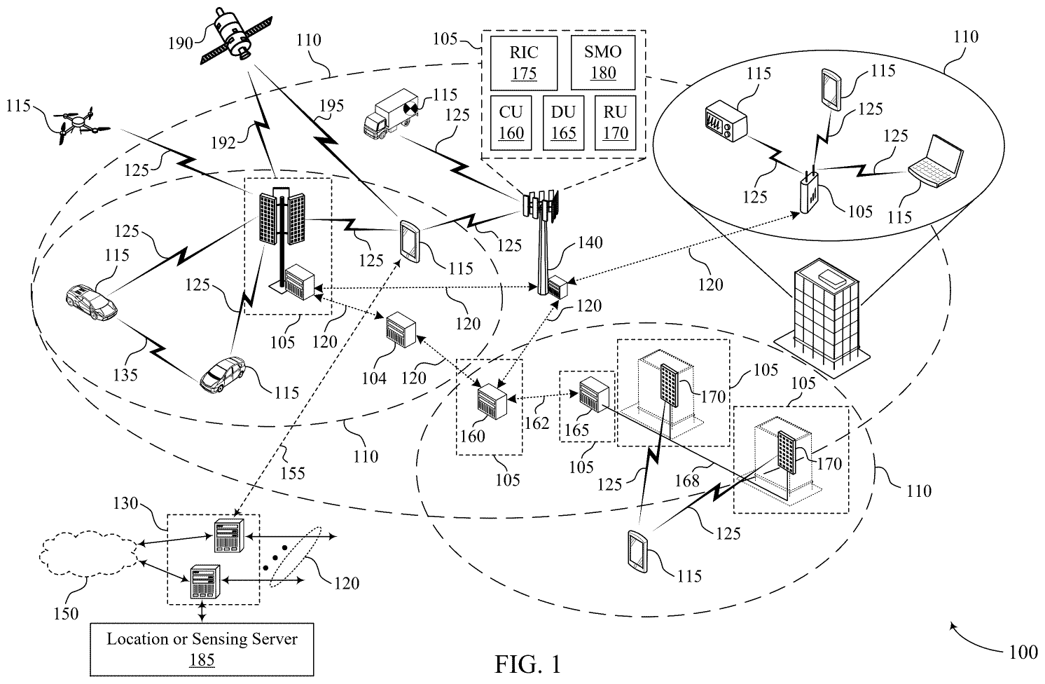

FIG. 1 shows an example of a wireless communications system 100 that supports data procedures associated with access stratum states or use cases in accordance with one or more aspects of the present disclosure. The wireless communications system 100 may include one or more devices, such as one or more network devices (e.g., network nodes 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network nodes 105 may be dispersed throughout a geographic area to form the wireless communications system 100 and may include devices in different forms or having different capabilities. In various examples, a network node 105 may be referred to as a network element, a network entity, a mobility element, a radio access network (RAN) node, or network equipment, among other nomenclature. In some examples, network nodes 105 and UEs 115 may wirelessly communicate via communication link(s) 125 (e.g., a radio frequency (RF) access link). For example, a network node 105 may support a coverage area 110 (e.g., a geographic coverage area) over which the UEs 115 and the network node 105 may establish the communication link(s) 125. The coverage area 110 may be an example of a geographic area over which a network node 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or have different capabilities. Some example UEs 115 are illustrated in FIG. 1. The UEs 115 described herein may be capable of supporting communications with various types of devices in the wireless communications system 100 (e.g., other wireless communication devices, including UEs 115 or network nodes 105), as shown in FIG. 1.

As described herein, a node of the wireless communications system 100, which may be referred to as a network entity or a wireless node, may be a network node 105 (e.g., any network node described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network node 105. As another example, a first node may be configured to communicate with a second node or a third node. In one aspect of this example, the first node may be a UE 115, the second node may be a network node 105, and the third node may be another UE 115. In another aspect of this example, the first node may be a UE 115, the second node may be a network node 105, and the third node may be another network node 105. In yet other aspects of this example, the first, second, and third nodes may be different relative to these examples. Similarly, reference to a UE 115, network node 105, apparatus, device, computing system, or the like may include disclosure of the UE 115, network node 105, apparatus, device, computing system, or the like being a node. For example, disclosure that a UE 115 is configured to receive information from a network node 105 also discloses that a first node is configured to receive information from a second node.

In some examples, network nodes 105 may communicate with a core network 130, or with one another, or both. For example, network nodes 105 may communicate with the core network 130 via wired or wireless backhaul communication link(s) 120 (e.g., in accordance with an S1, N2, N3, or other interface protocol). In some examples, network nodes 105 may communicate with one another via backhaul communication link(s) 120 (e.g., in accordance with an X2, Xn, or other interface protocol) either directly (e.g., directly between network nodes 105) or indirectly (e.g., via the core network 130). In some examples, network nodes 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network nodes 105 or network equipment described herein may include or may be referred to as a base station 140 (e.g., a base transceiver station, a radio base station, an NR base station, an access point (AP), a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network node 105 (e.g., a base station 140) may be implemented in an aggregated (e.g., monolithic, standalone) base station architecture, which may be configured to utilize a protocol stack that is physically or logically integrated within one network node (e.g., a network node 105 or a single RAN node, such as a base station 140).

In some examples, a network node 105 may be implemented in a disaggregated architecture (e.g., a disaggregated base station architecture, a disaggregated RAN architecture), which may be configured to utilize a protocol stack that is physically or logically distributed among multiple network entities (e.g., network nodes 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network node 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a TRP. One or more components of the network nodes 105 in a disaggregated RAN architecture may be co-located, or one or more components of the network nodes 105 may be located in distributed locations (e.g., separate physical locations). In some examples, one or more of the network nodes 105 of a disaggregated RAN architecture may be implemented as virtual units (e.g., a virtual CU (VCU), a virtual DU (VDU), a Virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1 interface, F1-c interface, or F1-u, among other examples), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network nodes 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network nodes 105 (e.g., network nodes 105 or IAB node(s) 104) may be partially controlled by each other. The IAB node(s) 104 may be referred to as a donor entity or an IAB donor. A DU 165 or an RU 170 may be partially controlled by a CU 160 associated with a network node 105 or base station 140 (such as a donor network node or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support testing as described herein. For example, some operations described as being performed by a UE 115 or a network node 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network nodes 105 and the network equipment including macro eNBs or gNBs, small cell eNBs or gNBs, or relay base stations, among other examples, as shown in FIG. 1.

The UEs 115 and the network nodes 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network node 105 and other devices may refer to communication between the devices and any portion (e.g., entity, sub-entity) of a network node 105. For example, the terms “transmitting,” “receiving,” or “communicating,” when referring to a network node 105, may refer to any portion of a network node 105 (e.g., a base station 140, a CU 160, a DU 165, a RU 170) of a RAN communicating with another device (e.g., directly or via one or more other network entities, such as one or more of the network nodes 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network node 105 to a UE 115, uplink transmissions (e.g., return link transmissions) from a UE 115 to a network node 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network nodes 105, the UEs 115, or both) may have hardware configurations that support communications using a particular carrier bandwidth or may be configurable to support communications using one of a set of carrier bandwidths. In some examples, the wireless communications system 100 may include network nodes 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network nodes 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network node 105 may provide communication coverage via one or more cells, for example a macro cell, a small cell, a hot spot, or other types of cells, or any combination thereof. The term “cell” may refer to a logical communication entity used for communication with a network node 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network node 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network node 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network node 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network node 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network node (e.g., a network node 105). In some other examples, overlapping coverage areas, such as a coverage area 110, associated with different technologies may be supported by different network entities (e.g., the network nodes 105). The wireless communications system 100 may include, for example, a heterogeneous network in which different types of the network nodes 105 support communications for coverage areas 110 (e.g., different coverage areas) using the same or different RATs.

The wireless communications system 100 may support synchronous or asynchronous operation. For synchronous operation, network nodes 105 (e.g., base stations 140) may have similar frame timings, and transmissions from different network entities (e.g., different ones of the network nodes 105) may be approximately aligned in time. For asynchronous operation, network nodes 105 may have different frame timings, and transmissions from different network entities (e.g., different ones of network nodes 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network node 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network node 105 (e.g., a base station 140, an RU 170), which may support aspects of such D2D communications being configured by (e.g., scheduled by) the network node 105. In some examples, one or more UEs 115 of such a group may be outside the coverage area 110 of a network node 105 or may be otherwise unable to or not configured to receive transmissions from a network node 105. In some examples, groups of the UEs 115 communicating via D2D communications may support a one-to-many (1:M) system in which each UE 115 transmits to one or more of the UEs 115 in the group. In some examples, a network node 105 may facilitate the scheduling of resources for D2D communications. In some other examples, D2D communications may be carried out between the UEs 115 without an involvement of a network node 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network entities (e.g., network nodes 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an AMF) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network nodes 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may include an location or sensing server 185 (e.g., LMF or SnMF). The location or sensing server 185 may provide positioning, sensing, location, or tracking functions. For instance, the location or sensing server 185 may participate in one or more positioning or sensing procedures to determine a location of (e.g., coordinates of, relative distance(s) to, or an address of) one or more of the UEs 115. Examples of positioning procedures may include one or more operations of assisted global navigation satellite system (A-GNSS), observed time difference of arrival (OTDOA), enhanced cell identifier (E-CID), sensor-based positioning, wireless local area network (WLAN)-based positioning, Bluetooth-based positioning, terrestrial beacon systems (TBS) positioning, downlink time difference of arrival (DL-TDOA), downlink angle of departure (DL-AOD), multi-round-trip time (Multi-RTT), New Radio enhanced cell identifier (NR E-CID), uplink time difference of arrival (UL-TDOA), and uplink angle of arrival (UL-AOA), among other examples. Some examples of the positioning or sensing procedures may be managed by, assisted by, or performed with the location or sensing server 185. For instance, measurements associated with reference signaling may be provided to the location or sensing server 185, which may estimate a location of a UE 115 based on the measurements. In some aspects, the location or sensing server 185 may track or store location information corresponding to one or more UEs 115. Some examples of the positioning or sensing procedures may be performed without the location or sensing server 185.

The location or sensing server 185 may be included in the core network 130 or may be separate from the core network 130. In some examples, a location or sensing server 185 may be a standalone device or may be included in (e.g., integrated with) a network node 105, a base station 140, a UE 115, a satellite 190, a server, or another device. For instance, the location or sensing server 185 may be (or may be included in) a secure user plane location (SUPL) location platform (SLP) device, a third-party server, or another device. The location or sensing server 185 may generally refer to a positioning or sensing device, a location device, a computing device, or a server, among other examples.

A UE 115 may communicate with the location or sensing server 185 directly or indirectly. For example, a UE 115 may communicate with the location or sensing server 185 via a network node 105 that is serving the UE 115 and via the core network 130. Additionally, or alternatively, a UE 115 may communicate with the location or sensing server 185 through another path (e.g., via an application server) or via another network (e.g., via a WLAN AP), among other examples. Communication between a UE 115 and the location or sensing server 185 may be represented via an indirect connection (e.g., through a communication link 125, a network node 105, a communication link 155, a backhaul communication link 120, or the core network 130) or as a direct connection, with one or more intervening nodes (if any) omitted for concision or convenience.

A satellite 190 may be an aerial or space vehicle with signaling capability. In some examples, the wireless communications system 100 may include or communicate with one or more satellites 190. The satellite(s) 190 may be included in one or more satellite positioning systems (e.g., GNSS(s)). A satellite positioning system may include any combination of one or more global or regional navigation satellites associated with one or more satellite positioning systems (e.g., global positioning system (GPS), global navigation satellite system (GLONASS), BeiDou navigation satellite system (BDS), or Galileo, among other examples). A satellite positioning system may include satellites 190 or other transmitters positioned to enable receivers (e.g., UEs 115) to determine a location on or above the Earth based on signals (e.g., the signals 195) received from the satellites 190. For instance, each satellite 190 may transmit a signal 195 marked with a repeating pseudo-random noise (PN) code of a set quantity of chips. In some cases, one or more transmitters located on ground-based control stations, network nodes 105, or UEs 115 may transmit signals for enabling a UE 115 to determine a location.

A UE 115 may include one or more receivers designed to receive the signal(s) 195 from the satellite(s) 190 for determining location information (e.g., a geographic location of the UE 115). For instance, the UE 115 may receive one or more signals 195 from the satellite(s) 190, which may be utilized to determine a location of the UE 115.

In a satellite positioning system, the use of signals 195 may be augmented with one or more satellite-based augmentation systems (SBAS) that may be associated with or enabled for use with one or more global or regional navigation satellite systems. An SBAS may provide integrity information, differential corrections, or other information for use in conjunction with a satellite positioning system. An SBAS may include one or more augmentation systems, such as the Wide Area Augmentation System (WAAS), the European Geostationary Navigation Overlay Service (EGNOS), the Multi-functional Satellite Augmentation System (MSAS), or the GPS Aided Geo Augmented Navigation (GAGAN) system, among other examples.

In some aspects, the satellite(s) 190 may be included in one or more non-terrestrial networks (NTNs). In an NTN, a satellite 190 may communicate with one or more devices (e.g., network entities, ground stations, NTN gateways, or gateways) located on or above the Earth. For example, the satellite 190 may send or receive one or more communications 192 with a network node 105. In some aspects, the communication(s) 192 may include one or more signals relayed to or from a UE 115. Additionally, or alternatively, the satellite 190 may communicate with another terrestrial device that is connected to one or more elements of the wireless communications system 100. For instance, the satellite 190 may communicate with a ground station or NTN gateway, which may provide access to the wireless communications system 100 or one or more other entities (e.g., Internet web servers or one or more other user devices) external to the wireless communications system 100. In some examples, a UE 115 may receive communication signals 195 from the satellite 190 instead of, or in addition to, communication signals from a terrestrial network entity.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network nodes 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize licensed or unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. Devices in the wireless communications system 100 may communicate over unlicensed spectrum, such as the 5 GHz band, the 2.4 GHz band, the 60 GHz band, the 3.6 GHz band, and/or the 900 MHz band. The unlicensed spectrum may also include other frequency bands. While operating using unlicensed RF spectrum bands, devices such as the network nodes 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network node 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network node 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network node 105 may be located at diverse geographic locations. A network node 105 may include an antenna array with a set of rows and columns of antenna ports that the network node 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network nodes 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network node 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network node 105 or a UE 115 may use beam sweeping techniques as part of beamforming operations. For example, a network node 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network node 105 multiple times along different directions. For example, the network node 105 may transmit a signal according to different beamforming weight sets associated with different directions of transmission. Transmissions along different beam directions may be used to identify (e.g., by a transmitting device, such as a network node 105, or by a receiving device, such as a UE 115) a beam direction for later transmission or reception by the network node 105.

Some signals, such as data signals associated with a particular receiving device, may be transmitted by a transmitting device (e.g., a network node 105 or a UE 115) along a single beam direction (e.g., a direction associated with the receiving device, such as another network node 105 or UE 115). In some examples, the beam direction associated with transmissions along a single beam direction may be determined based on a signal that was transmitted along one or more beam directions. For example, a UE 115 may receive one or more of the signals transmitted by the network node 105 along different directions and may report to the network node 105 an indication of the signal that the UE 115 received with a highest signal quality or an otherwise acceptable signal quality.

In some examples, transmissions by a device (e.g., by a network node 105 or a UE 115) may be performed using multiple beam directions, and the device may use a combination of digital precoding or beamforming to generate a combined beam for transmission (e.g., from a network node 105 to a UE 115). The UE 115 may report feedback that indicates precoding weights for one or more beam directions, and the feedback may correspond to a configured set of beams across a system bandwidth or one or more sub-bands. The network node 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network node 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network node 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network node 105 or a core network 130 supporting radio bearers for user plane data. A PHY layer may map transport channels to physical channels.

The UEs 115 and the network nodes 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communication systems may perform one or more operations associated with one or more use cases. A use case may be an indication of one or more operations (e.g., tasks, functions, or procedures). Examples of use cases may include CSI feedback (e.g., CSI measurement or reporting, among other examples), beam management (e.g., beam measurement or beam switching, among other examples), positioning (e.g., position determination or tracking, among other examples), sensing (e.g., for sensing one or more characteristics of one or more objects), or mobility (e.g., cell switching or handover, among other examples), among other examples.

In some approaches, one or more operations associated with one or more use cases may be partially or completely performed using one or more AI/ML models (e.g., network-side models). Training data may be information that may be utilized to train one or more AI/ML models. Some examples of training data may include ground truth data (e.g., data representing one or more target outputs or labels) or input data (e.g., input data associated with the ground truth data). Training data may be obtained (e.g., measured or captured) or generated.

Some wireless communications systems may include one or more network entities. Examples of network entities may include a network node 105 (e.g., gNB), AMF, location or sensing server 185 (e.g., LMF), or other network functions or services, among other examples. Different network entities may utilize different training data associated with different use cases for training one or more AI/ML models to perform one or more of the operations associated with the one or more use cases. For instance, a network node 105 may utilize training data related to AI/ML-based CSI feedback, a network node 105 may utilize training data related to AI/ML-based beam management, a location or sensing server 185 (e.g., LMF) may utilize training data related to AI/ML-based positioning or sensing, or a network node 105 may utilize training data related to AI/ML-based mobility. As illustrated by this discussion, there may be a demand for procedures or signaling for collecting training data for one or more network entities or for one or more use cases.

In some approaches, data collection for AI/ML model training may be performed for one or more access stratum states. The access stratum may be a layer in a protocol for communications between devices (e.g., between a UE 115 and a network entity). For example, the access stratum may be a layer at which one or more operations for data connectivity or radio resource management may be performed. An access stratum state may be an operating state of one or more devices (e.g., a UE 115) that may impact or relate to one or more operations of the access stratum. Examples of access stratum states may include a connected state (e.g., an RRC connected state), an inactive state (e.g., an RRC inactive state), or an idle state (e.g., an RRC idle state). In some approaches, training data collection may be performed for CSI feedback, beam management, positioning, sensing, or other use cases in the connected state (e.g., RRC connected state). Additionally, or alternatively, training data collection may be performed for positioning, sensing, or other uses cases in the inactive state or the idle state (e.g., RRC inactive or idle state).

In some examples, a UE 115 may store logged training data at the access stratum layer with a memory size (e.g., minimum access stratum layer memory size) supported by the UE 115 for one or more (e.g., all) use cases. When a UE 115 reaches a buffer limitation, the UE 115 may stop measurement for data collection purposes or logging. In some approaches, access stratum buffer event-based reporting may be supported. For instance, communicating an availability indication or a report may be supported.

Some examples of the techniques described herein may include handling one or more data collection procedures based on an access stratum state or access stratum buffer status. In some approaches, a UE 115 may be configured for training data collection for one or more use cases (e.g., AI/ML-related use cases for one or more access stratum states). Collected training data may be reported to different network entities (e.g., to a gNB for CSI feedback, beam management, or AI/ML based mobility, to an LMF for positioning, or to an SnMF for sensing, among other examples).

In some examples, data collection configuration may be performed based on an access stratum state. For instance, one or more indications may be utilized regarding one or more access stratum states in which training data collection may be performed. Additionally, or alternatively, a relaxation specific to an access stratum state may be configured (for one or more different use cases) at a UE 115. A “relaxation” may refer to a reduction in a quantity of resources utilized to perform an operation (e.g., data collection). For instance, a relaxation (e.g., a second level of a training data collection procedure) may utilize fewer resources to conduct data collection (e.g., relative to a first level of a training data collection procedure). In some approaches, a relaxation may utilize fewer measurement targets (e.g., fewer TRPs), fewer reference signals, or a larger measurement periodicity.

In some examples, collected training data may be reported based on access stratum buffer status. In some approaches, an availability indication may be sent in complete RRC messages. Utilizing complete RRC messages for an availability indication may increase overhead consumption. In some approaches, UE 115 assistance information may be utilized for communicating an availability indication or for a positioning or sensing use case. In some aspects, an availability indication or collected training data report may be communicated per use case.

Some examples of the techniques described herein may support UE 115 reporting of an availability indication concurrently to a RAN and one or more network functions or services. In some aspects, an availability indication may be communicated via an LPP for a positioning or sensing use case. In some examples of the techniques described herein, a network node 105 (e.g., gNB) may request training data reporting per use case.

As used herein, the terms “AI,” “AI/ML,” “AI-based,” or “ML-based” may refer to AI or machine learning techniques. The term “AI model” may refer to one or more AI models (with or without machine learning) or to one or more machine learning models. As used herein, an AI model may be referred to as an “AI-based model,” an “ML model,” or an “ML-based model.”

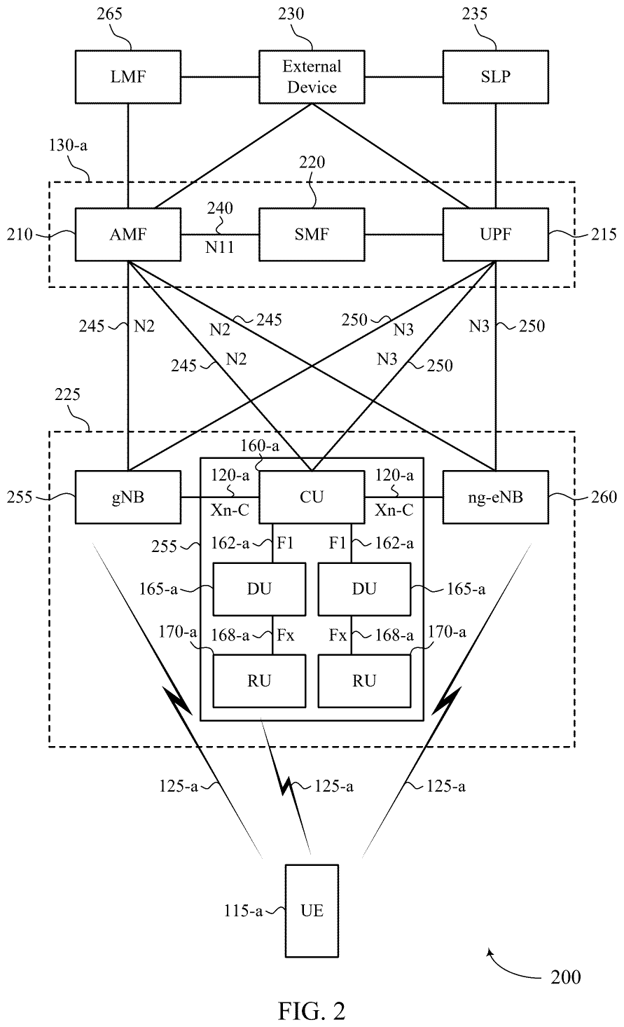

FIG. 2 shows an example of a network structure 200 (e.g., a disaggregated base station architecture, a disaggregated RAN architecture) that supports data procedures associated with access stratum states or use cases in accordance with one or more aspects of the present disclosure. The wireless network structure 200 may include a core network 130-a, a RAN 225, a UE 115-a, an LMF 265, an external device 230 (e.g., third-party device or server), or an SLP 235. In some examples, the wireless network structure 200 may be included in the wireless communications system 100 described with reference to FIG. 1. The core network 130-a may be an example of the core network 130, the UE 115-a may be an example of the UEs 115, or the LMF 265 may be an example of the location or sensing server 185, as described with reference to FIG. 1.

The core network 130-a may provide one or more control plane (C-plane) functions (e.g., UE registration, authentication, network access, or gateway selection, among other examples) or one or more user plane (U-plane) functions (e.g., UE gateway function, data network access, or IP routing, among other examples). One or more of the functions of the core network 130-a may be implemented in one or more devices (e.g., one or more electronic devices, computing devices, servers, among other examples) in hardware (e.g., circuitry) or a combination of hardware and instructions (e.g., a processor with instructions). The core network 130-a may be an EPC, 5GC, or a Next Generation Core (NGC), among other examples.

The core network 130-a may provide an AMF 210, a session management function (SMF) 220, or a user plane function (UPF) 215. The AMF 210 may provide one or more C-plane functions, such as registration management, connection management, reachability management, mobility management, lawful interception, transport for session management (SM) messages between one or more UEs 115-a and the SMF 220, transparent proxy services for routing SM messages, access authentication and access authorization, transport for short message service (SMS) messages between the UE 115-a and the short message service function (SMSF), or security anchor functionality (SEAF), among other examples. In some aspects, the AMF 210 may interact with an authentication server function (AUSF) and the UE 115-a, and may receive an intermediate key established as a result of a UE 115-a authentication process. In a case of authentication based on a universal mobile telecommunications system (UMTS) subscriber identity module (USIM), the AMF 210 may retrieve security information from the AUSF. In some examples, the AMF 210 may provide a security context management (SCM) function. The SCM function may receive a key from the SEAF that may be utilized to derive access-network specific keys. The AMF 210 may provide location services management for regulatory services, transport for location services messages between the UE 115-a and an LMF 265, transport for location services messages between the RAN 225 and the LMF 265, evolved packet system (EPS) bearer identifier allocation for interworking with the EPS, or UE 115-a mobility event notification. In some approaches, the AMF 210 may support one or more functionalities for Third Generation Partnership Project (3GPP) access networks or non-3GPP access networks.

The UPF 215 may provide one or more U-plane functions, such as acting as an anchor point for intra/inter-RAT mobility, acting as an external protocol data unit (PDU) session point of interconnection to a data network, providing packet routing and forwarding, packet inspection, user plane policy rule enforcement (e.g., gating, redirection, or traffic steering), user plane collection (e.g., interception), traffic usage reporting, quality of service (QoS) handling for the U-plane (e.g., uplink or downlink rate enforcement, reflective QoS marking in the downlink), uplink traffic verification (e.g., service data flow (SDF) to QoS flow mapping), transport level packet marking in the uplink or downlink, downlink packet buffering, downlink data notification triggering, or sending or forwarding one or more indications of an end of a transmission (e.g., “end markers”) to a source RAN node, among other examples. In some examples, the UPF 215 may support the transfer of location services messages over a U-plane between the UE 115-a and another device (e.g., the SLP 235 or the external device 230.

The SMF 220 may provide one or more functions, such as session management, UE IP address allocation and management, selection and control of user plane functions, configuration of traffic steering at the UPF 215 to route traffic to a destination, control (e.g., partial control) of policy enforcement or QoS, or downlink data notification. In some aspects, the SMF 220 may communicate with the AMF 210 over an N11 interface 240.

The RAN 225 may include one or more gNBs 255 or one or more ng-eNBs 260. The gNB(s) 255 or the ng-eNB(s) 260 may be examples of the network nodes 105 described with reference to FIG. 1. For instance, a next generation RAN (NG-RAN) may include one or more gNBs 255, or other examples of the RAN 225 may include one or more ng-eNBs 260 or gNBs 255.

The core network 130-a may communicate with the RAN 225 via a C-plane interface 245 (e.g., NG-C or N2 interface) or a U-plane interface 250 (e.g., NG-U or N3 interface). The C-plane interface 245 or the U-plane interface 250 may connect the gNB 255 or the ng-eNB 260 to the core network 130-a (e.g., to one or more control plane functions or one or more user plane functions). For instance, the C-plane interface 245 may connect the AMF 210 to one or more gNBs 255 or ng-eNBs 260 in the RAN 225, or the U-plane interface 250 may connect the UPF 215 to one or more gNBs 255 or ng-eNBs 260 in the RAN 225. The gNB(s) 255 or ng-eNB(s) 260 of the RAN 225 may communicate with each other via one or more backhaul communication links 120-a (e.g., Xn-C interface). The backhaul communication link(s) 120-a may be examples of the backhaul communication links 120 described with reference to FIG. 1. One or more of the gNBs 255 or ng-eNBs 260 may communicate with one or more UEs 115-a over one or more communication links 125-a (e.g., the Uu interface). The communication link(s) 125-a may be examples of the communication links 125 described with reference to FIG. 1.

The LMF 265 may communicate with the core network 130-a to provide location functionality (e.g., to participate in one or more positioning or sensing procedures) for the UE(s) 115-a. The LMF 265 may be an example of the location or sensing server 185 described with reference to FIG. 1. The LMF 265 may be implemented as one or more devices (e.g., one or more servers, such as physically separate servers, one or more instruction sets on a single server, or instruction sets distributed across multiple physical servers, among other examples). The LMF 265 may support one or more location services for one or more UEs 115-a that may connect to the LMF 265 via the RAN 225, via the core network 130-a, or via another connection (e.g., the Internet). In some examples, the LMF 265 may communicate with a UE 115-a or another device via a C-plane connection (e.g., using one or more interfaces or protocols for signaling control information, or separate from voice or payload data). In some aspects, the LMF 265 may be integrated into a component of the core network 130-a or may be external to the core network 130-a (e.g., on an external device 230, such as an original equipment manufacturer (OEM) server or other server).

In some examples, the SLP 235 may provide location functionality (e.g., may participate in one or more positioning or sensing procedures) for the UE(s) 115-a. The SLP 235 may be an example of the location or sensing server 185 described with reference to FIG. 1. The SLP 235 may be implemented as one or more devices (e.g., one or more servers, such as physically separate servers, one or more instruction sets on a single server, or instruction sets distributed across multiple physical servers, among other examples). The SLP 235 may support one or more location services for one or more UEs 115-a that may connect to the SLP 235 via the RAN 225, via the core network 130-a, or via another connection (e.g., the Internet). In some examples, the SLP 235 may communicate with a UE 115-a or another device via a U-plane connection (e.g., using one or more interfaces or protocols for signaling voice or payload data, such as a transmission control protocol (TCP) or IP).

In some examples, the external device 230 may communicate with the LMF 265, the SLP 235, the core network 130-a (e.g., via the AMF 210 or the UPF 215), the RAN 225, or the UE 115-a to obtain location information (e.g., a location estimate) for the UE 115-a. The external device 230 may be referred to as a location services (LCS) client or an external client. The external device 230 may be implemented as one or more devices (e.g., one or more servers, such as physically separate servers, one or more instruction sets on a single server, or instruction sets distributed across multiple physical servers, among other examples). The external device 230 may support one or more location services for one or more UEs 115-a that may connect to the external device 230 via the RAN 225, via the core network 130-a, or via another connection (e.g., the Internet).

In some approaches, the functionality of a gNB 255 may be divided between a CU 160-a, one or more DUs 165-a, or one or more RUs 170-a. The CU 160-a may be an example of the CU 160 described with reference to FIG. 1, the one or more DUs 165-a may be examples of the DU 165 described with reference to FIG. 1, or the one or more RUs 170-a may be examples of the RU 170 described with reference to FIG. 1. In some examples, the CU 160-a may provide one or more functions, such as transferring user data, mobility control, radio access network sharing, positioning, sensing, session management, or others, except for one or more functions allocated exclusively to the DU(s) 165-a. A DU 165-a may support one or more cells. The DUs 165-a may communicate with the CU 160-a via midhaul communication links 162-a (e.g., via the F1 interface). The midhaul communication links 162-a may be examples of the midhaul communication links 162 described with reference to FIG. 1. The RUs 170-a may perform one or more functions such as power amplification, signal transmission, or signal reception. The RUs 170-a may communicate with the DUs 165-a via fronthaul communication links 168-a (e.g., via the Fx interface). The fronthaul communication links 168-a may be examples of the fronthaul communication links 168 described with reference to FIG. 1. The UE 115-a may communicate with the gNB 255, RU 170-a, or ng-eNB 260 a via communication links 125-a. The communication links 125-a may be examples of the communication links 125 described with reference to FIG. 1. The UE 115-a may communicate with the CU 160-a via the RRC, SDAP, and PDCP layers, with a DU 165-a via the RLC and MAC layers, or with an RU 170-a via the PHY layer.

As described herein, when a wireless device (e.g., UE 115-a, gNB 255, ng-eNB 260, RU 170-a, DU 165-a, or CU 160-a, among other examples) communicates (e.g., outputs, transmits, obtains, or receives) signaling or information with a network entity (e.g., LMF 265, external device 230, SLP 235, AMF 210, SMF 220, UPF 215, gNB 255, ng-eNB 260, CU 160-a, DU 165-a, or RU 170-a, among other examples), the communication (e.g., transmission or reception) may be carried out directly (without one or more intervening devices or entities) or indirectly (with one or more intervening devices or entities). For example, if the UE 115-a transmits signaling or information to the LMF 265, the signaling or information may be communicated via (or independently from) one or more of the gNB 255, ng-eNB 260, RU 170-a, DU 165-a, CU 160-a, AMF 210, SMF 220, UPF 215, SLP 235, or external device 230, among other examples.

Additionally, or alternatively, if the LMF 265 transmits signaling or information to the UE 115-a, the signaling or information may be communicated via (or independently from) one or more of the gNB 255, ng-eNB 260, RU 170-a, DU 165-a, CU 160-a, AMF 210, SMF 220, UPF 215, SLP 235, or external device 230, among other examples.

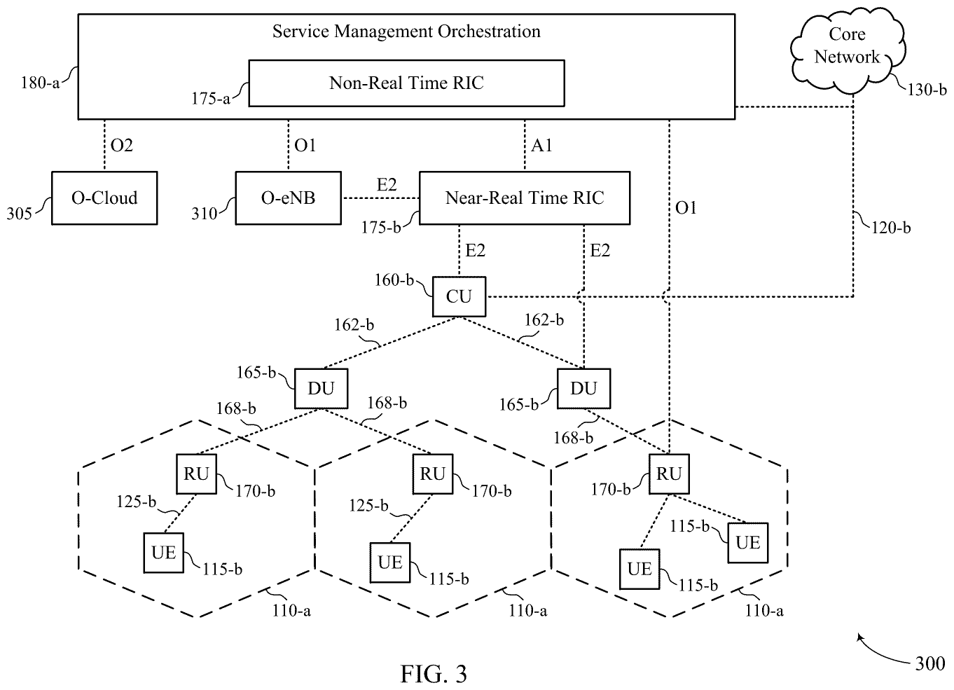

FIG. 3 shows an example of a network architecture 300 (e.g., a disaggregated base station architecture, a disaggregated RAN architecture) that supports data procedures associated with access stratum states or use cases in accordance with one or more aspects of the present disclosure. The network architecture 300 may illustrate an example for implementing one or more aspects of the wireless communications system 100. The network architecture 300 may include one or more CUs 160-b that may communicate directly with a core network 130-b via a backhaul communication link 120-b, or indirectly with the core network 130-b through one or more disaggregated network nodes 105 (e.g., a Near-RT RIC 175-b via an E2 link, or a Non-RT RIC 175-a associated with an SMO 180-a (e.g., an SMO Framework), or both). A CU 160-b may communicate with one or more DUs 165-b via respective midhaul communication links 162-b (e.g., an F1 interface). The DUs 165-b may communicate with one or more RUs 170-b via respective fronthaul communication links 168-b. The RUs 170-b may be associated with respective coverage areas 110-a and may communicate with UEs 115-b via one or more communication links 125-b. In some implementations, a UE 115-b may be simultaneously served by multiple RUs 170-b.

Each of the network nodes 105 of the network architecture 300 (e.g., CUs 160-b, DUs 165-b, RUs 170-b, Non-RT RICs 175-a, Near-RT RICs 175-b, SMOs 180-a, Open Clouds (O-Clouds) 305, Open eNBs (O-eNBs) 310) may include one or more interfaces or may be coupled with one or more interfaces configured to receive or transmit signals (e.g., data, information) via a wired or wireless transmission medium. Each network node 105, or an associated processor (e.g., controller) providing instructions to an interface of the network node 105, may be configured to communicate with one or more of the other network nodes 105 via the transmission medium. For example, the network nodes 105 may include a wired interface configured to receive or transmit signals over a wired transmission medium to one or more of the other network nodes 105. Additionally, or alternatively, the network nodes 105 may include a wireless interface, which may include a receiver, a transmitter, or transceiver (e.g., an RF transceiver) configured to receive or transmit signals, or both, over a wireless transmission medium to one or more of the other network nodes 105.

In some examples, a CU 160-b may host one or more higher layer control functions. Such control functions may include RRC, PDCP, SDAP, or the like. Each control function may be implemented with an interface configured to communicate signals with other control functions hosted by the CU 160-b. A CU 160-b may be configured to handle user plane functionality (e.g., CU-UP), control plane functionality (e.g., CU-CP), or a combination thereof. In some examples, a CU 160-b may be logically split into one or more CU-UP units and one or more CU-CP units. A CU-UP unit may communicate bidirectionally with the CU-CP unit via an interface, such as an E1 interface when implemented in an O-RAN configuration. A CU 160-b may be implemented to communicate with a DU 165-b, as necessary, for network control and signaling.

A DU 165-b may correspond to a logical unit that includes one or more functions (e.g., base station functions, RAN functions) to control the operation of one or more RUs 170-b. In some examples, a DU 165-b may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-b may further host one or more low PHY layers. Each layer may be implemented with an interface configured to communicate signals with other layers hosted by the DU 165-b, or with control functions hosted by a CU 160-b.

In some examples, lower-layer functionality may be implemented by one or more RUs 170-b. For example, an RU 170-b, controlled by a DU 165-b, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-b may be implemented to handle over the air (OTA) communication with one or more UEs 115-b. In some implementations, real-time and non-real-time aspects of control and user plane communication with the RU(s) 170-b may be controlled by the corresponding DU 165-b. In some examples, such a configuration may enable a DU 165-b and a CU 160-b to be implemented in a cloud-based RAN architecture, such as a vRAN architecture.

The SMO 180-a may be configured to support RAN deployment and provisioning of non-virtualized and virtualized network nodes 105. For non-virtualized network nodes 105, the SMO 180-a may be configured to support the deployment of dedicated physical resources for RAN coverage requirements which may be managed via an operations and maintenance interface (e.g., an O1 interface). For virtualized network nodes 105, the SMO 180-a may be configured to interact with a cloud computing platform (e.g., an O-Cloud 305) to perform network node life cycle management (e.g., to instantiate virtualized network nodes 105) via a cloud computing platform interface (e.g., an O2 interface). Such virtualized network nodes 105 can include, but are not limited to, CUs 160-b, DUs 165-b, RUs 170-b, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-b via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, artificial intelligence (AI) or machine learning (ML) workflows including model training and updates, or policy-based guidance of applications/features in the Near-RT RIC 175-b. The Non-RT RIC 175-a may be coupled with or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-b, one or more DUs 165-b, or both, as well as an O-eNB 310, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

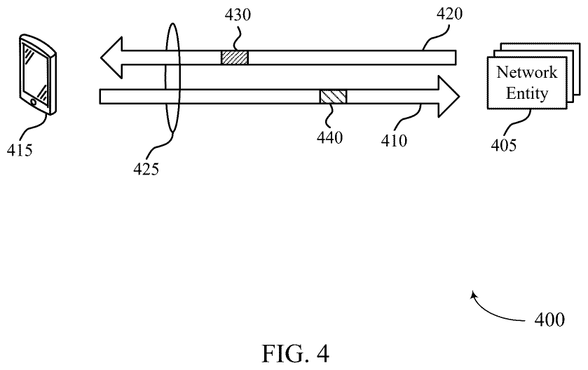

FIG. 4 shows an example of a wireless communications system 400 that supports data procedures associated with access stratum states or use cases in accordance with one or more aspects of the present disclosure. The wireless communications system 400 may implement aspects of or may be implemented by aspects of the wireless communications system 100. For example, the wireless communications system 400 includes a wireless device 415, which may be an example of a UE 115, network node 105, RU 170, DU 165, or CU 160 described with reference to FIG. 1, a UE 115-a, gNB 255, RU 170-a, DU 165-a, CU 160-a, or ng-eNB 260 described with reference to FIG. 2, or a UE 115-b, RU 170-b, DU 165-b, or CU 160-b described with reference to FIG. 3. The wireless communications system 400 also includes one or more network entities 405, one or more of which may be examples of a network node 105, location or sensing server 185, RU 170, DU 165, or CU 160 described with reference to FIG. 1, an LMF 265, external device 230, SLP 235, AMF 210, SMF 220, UPF 215, gNB 255, RU 170-a, DU 165-a, CU 160-a, or ng-eNB 260 described with reference to FIG. 2, or an RU 170-b, DU 165-b, or CU 160-b described with reference to FIG. 3. For example, the wireless device 415 may be a UE, or the one or more network entities 405 may include one or more network nodes, network functions, AMFs, LMFs, or servers. As used herein, a “network function” or a “service” may refer to a device (e.g., server, computing device, network node, gNB, AMF, LMF, SnMF, network entity, base station, wireless device, or UE, among other examples) for performing a function or service.

The wireless device 415 may communicate with the network entity 405 using a link 425, which may be an example of a communication link 125, a backhaul communication link 120, or a communication link 155 described with reference to FIG. 1, a communication link 125-a, a backhaul communication link 120-a, a C-plane interface 245, or a U-plane interface 250 described with reference to FIG. 2, a communication link 125-b or a backhaul communication link 120-b described with reference to FIG. 3, another link, or a combination thereof. The link 425 may include one or more uni-directional or bi-directional links that enable uplink or downlink network communications. For example, the wireless device 415 may transmit one or more uplink transmissions 410, such as uplink control signals or uplink data signals, to the one or more network entities 405 using the link 425, or the one or more network entities 405 may transmit one or more downlink transmissions 420, such as downlink control signals or downlink data signals, to the wireless device 415 using the link 425.

The wireless device 415 may output (e.g., transmit), or one or more of the network entities 405 may obtain (e.g., receive), based on one or more use cases, capability information 440. For example, the capability information 440 may be signaled to one or more of the network entities 405 corresponding to one or more use cases. Examples of the one or more use cases may include an AI/ML-based CSI feedback use case, an AI/ML-based beam management use case, an AI/ML-based mobility use case, an AI/ML-based positioning use case, an AI/ML-based cell reselection use case, an AI/ML-based random access channel (RACH) procedure, or a use case for AI/ML-based power management, a non-AI/ML-based CSI feedback use case, a non-AI/ML-based beam management use case, a non-AI/ML-based mobility use case, a non-AI/ML-based positioning use case, a non-AI/ML-based cell reselection use case, a non-AI/ML-based RACH procedure, a use case for non-AI/ML-based power management, or a sensing use case such as an AI/ML-based sensing use case or a non-AI/ML-based sensing use case (e.g., for one or more access stratum states), among other examples. In some examples, information or signaling (e.g., the capability information 440 or other signals or information) may be transmitted to a network entity (e.g., LMF) directly or via one or more intervening devices or entities. Examples of intervening devices or entities may include one or more network nodes, base stations, RUs, DUs, CUs, AMFs, or other devices. For instance, information or signaling (e.g., capability information 440) may be transmitted to an LMF or SnMF, where the information or signaling may be transmitted to an AMF, and where the information or signaling is encapsulated in an RRC message and the encapsulated information or signaling is provided to the LMF or SnMF via the AMF (for LPP signaling, for instance).

In some examples, if the capability information 440 indicates a capability of the wireless device 415 related to an AI/ML-based CSI feedback use case, an AI/ML-based beam management use case, an AI/ML-based mobility use case, an AI/ML-based cell reselection use case, an AI/ML-based RACH procedure, a use case for AI/ML-based power management, a non-AI/ML-based CSI feedback use case, a non-AI/ML-based beam management use case, a non-AI/ML-based mobility use case, a non-AI/ML-based positioning use case, a non-AI/ML-based cell reselection use case, a non-AI/ML-based RACH procedure, a use case for non-AI/ML-based power management, or a sensing use case (e.g., AI/ML-based sensing use case or a non-AI/ML-based sensing use case), or another use case relevant to a network node (e.g., RAN entity, gNB, CU, DU, or RU, among other examples) of the one or more network entities 405, the wireless device 415 may output the capability information 440 to the network node. The capability information 440 for the network node may be communicated (e.g., output, transmitted, obtained, or received) via control plane signaling. As described herein, a “sensing use case” may refer to an AI/ML-based sensing use case or a non-AI/ML-based sensing use case.

In some approaches, if the capability information 440 indicates a capability of the wireless device 415 related to an AI/ML-based or non-AI/ML-based positioning or sensing use case or another use case relevant to a location or sensing server (e.g., LMF) of the one or more network entities 405, the wireless device 415 may output the capability information 440 to the location or sensing server. The capability information 440 for the location or sensing server may be communicated (e.g., output, transmitted, obtained, or received) via control plane or user plane signaling (e.g., using LPP signaling).

In some aspects, if the capability information 440 indicates a capability of the wireless device 415 related to an AI/ML-based use case or a non-AI/ML-based use case relevant to a network function or service of the one or more network entities 405 (and if the wireless device 415 may communicate with the network function or service directly or transparently, for instance), the wireless device 415 may output the capability information 440 to the network function or service. The capability information 440 for the network function or service may be communicated (e.g., output, transmitted, obtained, or received) via control plane or user plane signaling.

In some approaches, if the capability information 440 indicates a capability of the wireless device 415 related to an AI/ML-based use case or a non-AI/ML-based use case relevant to a network function or service of the one or more network entities 405 (and if the wireless device 415 may not communicate with the network function or service directly or transparently, for instance), the wireless device 415 may output the capability information 440 to an AMF (of the one or more network entities 405), which may communicate (e.g., relay) the capability information 440 to the network function or service (of the one or more network entities 405). The capability information 440 for the network function or service may be communicated (e.g., output, transmitted, obtained, or received) via non-access stratum (NAS) signaling.

In some examples, the capability information 440 may indicate at least one of the one or more use cases corresponding to the capability of the wireless device 415 to participate in the data collection procedure (e.g., training data collection procedure). For instance, the capability information 440 may include an indicator (e.g., code, bit pattern, or data, among other examples) or an implicit indication (e.g., type of training data, message type, or other information) of the use case corresponding to the capability.

In some examples, the capability information 440 may indicate a capability of the wireless device 415 to participate in a data (e.g., training data, measurement data, or other data) collection procedure in association with one or more access stratum states. A data collection procedure may be, or may include, one or more operations related to obtaining (e.g., capturing, measuring, generating), logging (e.g., storing, recording), or reporting (e.g., communicating) data. In some examples, the data collection procedure may be associated with training data for training an AI/ML model for the one or more use cases. In some examples, a data collection procedure may be performed to collect, log, or report training data that is specific to training an AI/ML model that is specific to a use case. For instance, a data collection procedure may be performed to collect, log, or report data for one of CSI feedback, beam management, mobility, positioning, sensing, a RACH procedure, or power management, among other examples (e.g., for training an AI/ML model for one of CSI feedback, beam management, mobility, positioning, a RACH procedure, sensing, or power management, among other examples).

In some examples, a data (e.g., training data, measurement data, or other data) collection procedure may be performed in association with (e.g., with the wireless device 415 in is) one or more access stratum states. For instance, data collection may be allowed or prohibited for one or more access stratum states, or different amounts of data collection may be performed for one or more access stratum states. Examples of the one or more access stratum states may include a connected state (e.g., RRC connected state), an inactive state (e.g., RRC inactive state), or an idle state (e.g., RRC idle state). For instance, the wireless device 415 may perform one or more operations that may differ between access stratum states. The connected state may allow more operations or power consumption than the inactive state, which may allow more operations or power consumption than the idle state. For example, the wireless device may generally perform more operations (e.g., more operation types or more frequent operations) or consume more power in the connected state than in the inactive state or the idle state, or the wireless device may perform more operations or consume more power in the inactive state than in the idle state.

In some aspects, one or more amounts of data (e.g., training data, measurement data, or other data) collection for one or more use cases (e.g., each use case) may be configured, allowed, or instructed for each access stratum state. Additionally, or alternatively, one or more amounts of data collection may be performed for differing access stratum states based on the use case. For example, data collection (or data collection in accordance with a relaxation) may be allowed in an idle state for a positioning or sensing use case, while data collection may not be allowed in the idle state for a beam management use case. Other variations for use cases and access stratum states may be implemented in some examples.

In some approaches, the capability information 440 may indicate one or more parameters for the data (e.g., training data, measurement data, or other data) collection procedure. The one or more parameters may indicate one or more capacities, conditions, constraints, or limitations relating to resources of the wireless device 415 (e.g., memory, buffer, or processing bandwidth, among other examples) or a quantity of data. For instance, the one or more parameters indicated by the capability information 440 may include a quantity of samples of at least a portion of the data, a size of at least a portion of the data, an age of at least a portion of the data, a quality of data collected, or any combination thereof (e.g., for or in at least one of the one or more access stratum states and/or for the one or more use cases). In some examples, the quantity of samples may indicate a maximum quantity of samples per access stratum state (and/or per AI/ML use case). The size of at least a portion of the data may indicate, for example, a maximum data size (e.g., maximum data size per sample) per access stratum state and/or per use case (e.g., AI/ML-based use case, non-AI/ML-based use case, or AI/ML-based or non-AI/ML-based sensing use case). The age of at least a portion of the data may indicate, for instance, a maximum length of time samples that may be stored at the wireless device 415 (e.g., UE) buffer per access stratum state and/or per use case (e.g., AI/ML-based use case, non-AI/ML-based use case, or sensing use case). The quality of data may indicate, for example, a quality (e.g., probabilistic certainty or other characteristic) of the data collected for one or more access stratum states (e.g., for a connected state, an inactive state, or an idle state, among other examples) or one or more use cases. Different quantities of memory (e.g., buffer) may be utilized (e.g., permitted or available) for different respective access stratum states or one or more use cases. In some approaches, the parameter(s) may indicate an amount of memory (e.g., buffer) that may be utilized (e.g., permitted or available) for storing data (e.g., portion(s) of data) in one or more of the access stratum states or one or more use cases.

In some examples, the quality parameter may provide an indication of reliability or characteristics of collected data. For instance, data collected in different access stratum states may have varying quality levels due to different operational constraints (e.g., data collected in a connected state may have relatively higher quality due to more frequent measurements or better synchronization, while data collected in an idle state may have relatively lower quality due to reduced measurement opportunities). Additionally, or alternatively, different use cases may demand different quality thresholds. The quality parameter may enable a network entity to make informed decisions about data utilization or processing based on the quality (e.g., reliability) of the collected data.

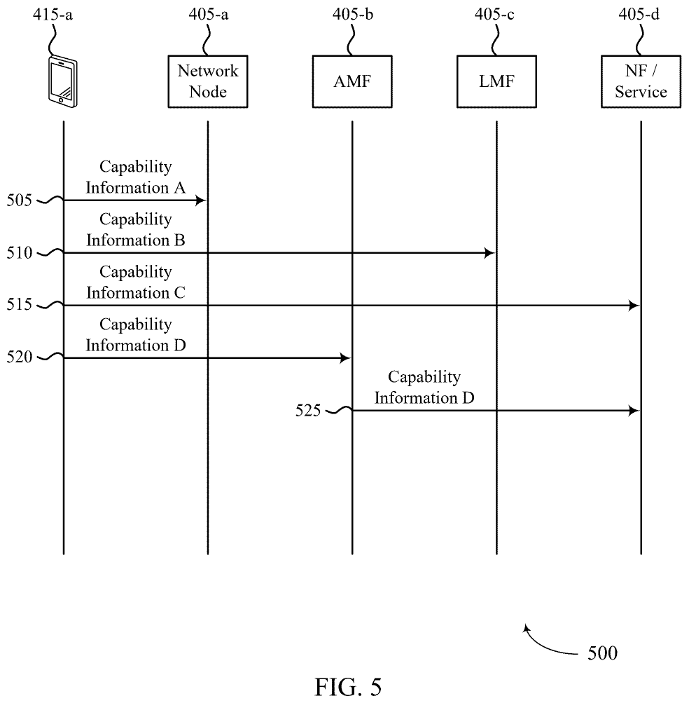

In accordance with some examples of the techniques described herein, the wireless device 415 (e.g., UE) may indicate to a terminating node (e.g., an ending or initiating (or non-intermediate) network entity for one or more of the communications described) of the one or more network entities 405 (e.g., RAN node, network function, or service), the capability information 440 indicating a capability of the wireless device 415 to perform data (e.g., training data, measurement data, or other data) collection per access stratum state (e.g., connected state, inactive state, or idle state) and/or per use case (e.g., AI/ML-based use case, non-AI/ML-based use case, or sensing use case). For instance, the capability information 440 may indicate a data collection capability (e.g., capability for data collection or support for data logging) per access stratum (e.g., connectivity) state or per use case (e.g., AI/ML use case, non-AI/ML use case, or sensing use case). In some approaches, the wireless device 415 (e.g., UE) may communicate the capability information 440 based on a request from the terminating node of the one or more network entities 405 (e.g., RAN node, network function, or service, among other examples). For instance, a network entity (e.g., terminating node) of the one or more network entities 405 may output (e.g., transmit), or the wireless device 415 may obtain (e.g., receive), a request for the capability information 440. The wireless device 415 may output (e.g., transmit), or the network entity (e.g., terminating node) of the one or more network entities 405 may obtain (e.g., receive) the capability information 440 based on (e.g., in response to) the request. Examples of the capability information 440 are provided with reference to FIG. 5.

The one or more network entities 405 (e.g., at least one of the one or more network entities 405) may output (e.g., transmit), or the wireless device 415 may obtain (e.g., receive), based on the one or more use cases, configuration information 430 indicating that the wireless device 415 is configured for the data (e.g., training data, measurement data, or other data) collection procedure (e.g., for at least one of the one or more access stratum states and/or for one or more use cases). In some aspects, the configuration information 430 may indicate a data collection configuration per connectivity state or per use case. In some approaches, the configuration information 430 may indicate that the wireless device 415 is to participate in the data collection procedure. Additionally, or alternatively, signaling or information separate from the configuration information 430 may indicate that the wireless device 415 is to participate in the data collection procedure.

In some aspects, the wireless device 415 (e.g., UE) may be configured (via the configuration information 430) regarding one or more access stratum states in which data collection, logging, or reporting is to be performed. For instance, the configuration information 430 may indicate that the wireless device 415 may be configured to participate in the data collection procedure in at least one of the connected state, the inactive state, the idle state, or any combination thereof.

In some examples, the configuration information 430 may indicate at least one use case or at least one access stratum state for performing one or more measurements associated with data (e.g., training data, measurement data, or other data) collection, for performing data logging, for performing data reporting, or any combination thereof. For instance, one or more network entities 405 (e.g., terminating entities) may indicate one or more of the following via the configuration information 430 per use case for data collection: one or more access stratum states in which data collection is to be performed, one or more access stratum states in which data logging is be performed, or one or more access stratum states in which data reporting is to be performed.

In some approaches, the configuration information 430 may indicate an access stratum state-specific relaxation that may be configured (per different use cases, for instance) at the wireless device 415 (e.g., UE). For instance, data (e.g., training data, measurement data, or other data) collection in multiple access stratum states may be supported. The wireless device 415 (e.g., UE) may be provided with a relaxation configuration per use case (e.g., for measurement or reporting) and/or for one or more access stratum states (e.g., each access stratum state). The one or more network entities 405 may provide the relaxation configuration. Additionally, or alternatively, separate configurations per use case (e.g., for measurement or reporting) for one or more (e.g., each) access stratum state may be provided to the wireless device 415 by the one or more network entities 405. In some examples, the configuration information 430 may indicate a first level (e.g., non-relaxation configuration) of the data collection procedure and a second level (e.g., relaxation configuration) of the data collection procedure for at least one use case or for at least one access stratum state, where the second level (e.g., the relaxation configuration) of the data collection procedure utilizes fewer resources than the first level (e.g., the non-relaxation configuration).

In some aspects, the one or more network entities 405 may provide relaxation configurations for different wireless device 415 (e.g., UE) operating conditions (e.g., temperature (for overheating, for instance) or position in a cell (e.g., cell center versus cell edge), among other examples). In some approaches, the second level (e.g., relaxation configuration) of the data collection procedure may be associated with an operating condition of the wireless device 415 (e.g., above a threshold temperature, signal strength measurement below a threshold (indicating a cell edge scenario, for instance), or available processing bandwidth below a threshold, among other examples).

In some examples, a network node (e.g., RAN entity, gNB, CU, DU, or RU, among other examples) of the one or more network entities 405 may output the configuration information 430 to the wireless device 415, where the configuration information 430 indicates a configuration for the wireless device 415 related to an AI/ML-based CSI feedback use case, an AI/ML-based beam management use case, an AI/ML-based mobility use case, an AI/ML-based positioning use case, an AI/ML-based cell reselection use case, an AI/ML-based RACH procedure, a use case for AI/ML-based power management, a non-AI/ML-based CSI feedback use case, a non-AI/ML-based beam management use case, a non-AI/ML-based mobility use case, a non-AI/ML-based positioning use case, a non-AI/ML-based cell reselection use case, a non-AI/ML-based RACH procedure, a use case for non-AI/ML-based power management, or a sensing use case (e.g., or another use case relevant to, corresponding to, or managed by, the network node). The configuration information 430 from the network node may be communicated (e.g., output, transmitted, obtained, or received) via control plane signaling.

In some approaches, a location or sensing server (e.g., LMF or SnMF) of the one or more network entities 405, may output the configuration information 430 to the wireless device 415, where the configuration information 430 indicates a configuration for the wireless device 415 related to an AI/ML-based positioning use case, a non-AI/ML-based positioning use case, or another use case relevant to the location or sensing server. The configuration information 430 from the location or sensing server may be communicated (e.g., output, transmitted, obtained, or received) via control plane or user plane signaling (e.g., using LPP signaling).

In some aspects, a network function or service of the one or more network entities 405 (if the wireless device 415 may communicate with the network function or service directly or transparently, for instance), may output the configuration information 430 to the wireless device 415, where the configuration information 430 indicates a configuration for the wireless device 415 related to an AI/ML-based use case or a non-AI/ML-based use case relevant to the network function or service. The configuration information 430 from the network function or service may be communicated (e.g., output, transmitted, obtained, or received) via control plane or user plane signaling.

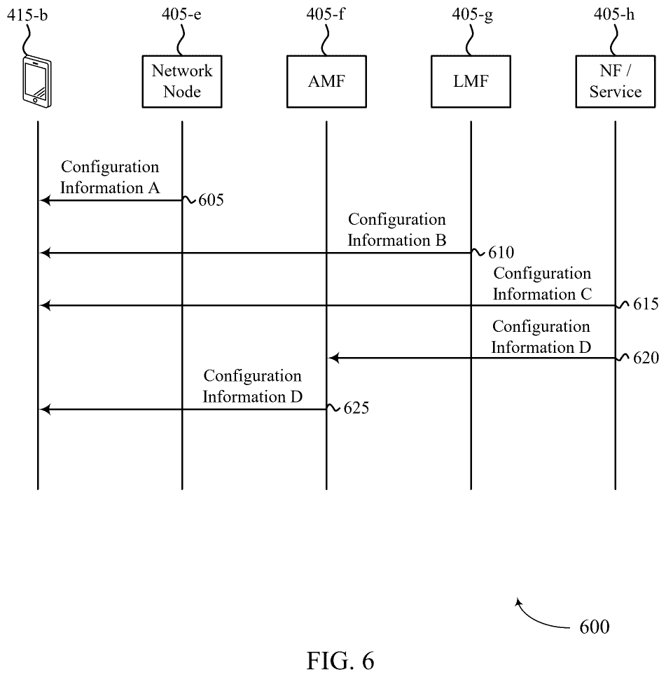

In some approaches, a network function or service of the one or more network entities 405 (if the wireless device 415 may not communicate with the network function or service directly or transparently, for instance) may output the configuration information 430 to an AMF (of the one or more network entities 405), which may communicate (e.g., relay) the configuration information 430 to the wireless device 415, where the configuration information 430 indicates a configuration for the wireless device 415 related to an AI/ML-based use case or a non-AI/ML-based use case relevant to the network function or service. The configuration information 430 from the network function or service may be communicated (e.g., output, transmitted, obtained, or received) via control plane signaling. Examples of the configuration information 430 are provided with reference to FIG. 6.

In some examples, the wireless device 415 may participate in the data collection procedure (e.g., for at least one of the one or more access stratum states or for at least one of the one or more use cases) based on the configuration information 430. For instance, participating in the data collection procedure may include performing one or more measurements associated with data collection, data logging, data reporting, or any combination thereof. In some approaches, the wireless device 415 may obtain (e.g., receive) one or more signals (e.g., reference signals, positioning reference signals (PRSs), sensing reference signals, CSI-RSs, or signals via one or more beams, among other examples) from one or more devices (e.g., one or more network nodes, TRPs, access points, satellites, or positioning reference units (PRUs), among other examples). The wireless device 415 may measure the one or more signals to produce measurements, which may be utilized as data. For example, CSI-RS measurements may be utilized as data for a CSI-RS feedback use case, beam measurements may be utilized as data for a beam management use case, signal strength measurements may be utilized as data for a mobility use case, or PRS measurements may be utilized as data for a positioning or sensing use case, among other examples. In some approaches, the wireless device 415 may collect the data (e.g., measure the signal(s)), may log the data (e.g., store or record the data or metadata (such as timestamps or quality information) associated with the data), or may report (e.g., communicate) the data. Training data (e.g., data for training an AI/ML model) may be an example of the data described herein (e.g., “data” may refer to “training data” in some examples of the techniques described herein).

In some examples, the wireless device 415 may output (e.g., transmit), or the one or more network entities 405 may obtain (e.g., receive), based on the one or more use cases, an indication of availability of the data. For instance, the wireless device 415 may output a data availability indicator for data collected during a connectivity state or per use case. In some aspects, the indication of availability of the data may be information (e.g., a flag, a bit, or a signal, among other examples) indicating an availability of data per use case.

In some aspects, the wireless device 415 (e.g., UE) may output (e.g., transmit), or the one or more network entities 405 may obtain (e.g., receive), the indication of availability per terminating node (e.g., RAN node, network function, or service, among other examples). For instance, the indication of availability may be communicated to one or more of the network entities to which the data corresponds.

In some examples, the indication of availability may indicate one or more use cases (e.g., AI/ML-based CSI feedback, AI/ML-based beam management, AI/ML-based mobility, AI/ML-based positioning, AI/ML-based RACH procedure, or AI/ML-based power management or control, non-AI/ML-based CSI feedback, non-AI/ML-based beam management, non-AI/ML-based mobility, non-AI/ML-based positioning, non-AI/ML-based cell reselection, a non-AI/ML-based RACH procedure, a use case for non-AI/ML-based power management or control, or a sensing use case, among other examples) associated with the data. For instance, the indication of availability may include a per use case indication (e.g., for data collection reporting to a gNB).

In some approaches, the indication of availability may indicate a quantity of samples of the data, a size of the data, an age of the data corresponding to at least one of the one or more use cases, or a quality of data collected (e.g., in at least one of the one or more access stratum states or of the one or more use cases). For instance, the wireless device 415 (e.g., UE) may indicate a size (e.g., size in kilobytes (KB) or quantity of samples, among other examples) or age (e.g., a time stamp of data generation, an age per sample or size, an oldest data age, or an amount of time for which the data has been logged, among other examples) of data logged per use case (e.g., per a logging or reporting identifier configured at the wireless device 415).

In some examples, if the indication of availability corresponds to data related to an AI/ML-based CSI feedback use case, an AI/ML-based beam management use case, an AI/ML-based mobility use case, an AI/ML-based positioning use case, an AI/ML-based cell reselection use case, an AI/ML-based RACH procedure, a use case for AI/ML-based power management, a non-AI/ML-based CSI feedback use case, a non-AI/ML-based beam management use case, a non-AI/ML-based mobility use case, a non-AI/ML-based positioning use case, a non-AI/ML-based cell reselection use case, a non-AI/ML-based RACH procedure, a use case for non-AI/ML-based power management, or a sensing use case, or another use case relevant to a network node (e.g., RAN entity, gNB, CU, DU, or RU, among other examples) of the one or more network entities 405, the wireless device 415 may output the indication of availability to the network node. The indication of availability for the network node may be communicated (e.g., output, transmitted, obtained, or received) via control plane signaling.

In some approaches, if the indication of availability corresponds to data related to an AI/ML-based positioning use case, a non-AI/ML-based positioning use case, or another use case relevant to a location or sensing server (e.g., LMF or SnMF) of the one or more network entities 405, the wireless device 415 may output the indication of availability to the location or sensing server. The indication of availability for the location or sensing server may be communicated (e.g., output, transmitted, obtained, or received) via control plane or user plane signaling (e.g., using LPP signaling).

In some aspects, if the indication of availability corresponds to data related to an AI/ML-based use case or a non-AI/ML-based use case relevant to a network function or service of the one or more network entities 405 (and if the wireless device 415 may communicate with the network function or service directly or transparently, for instance), the wireless device 415 may output the indication of availability to the network function or service. The indication of availability for the network function or service may be communicated (e.g., output, transmitted, obtained, or received) via control plane or user plane signaling.

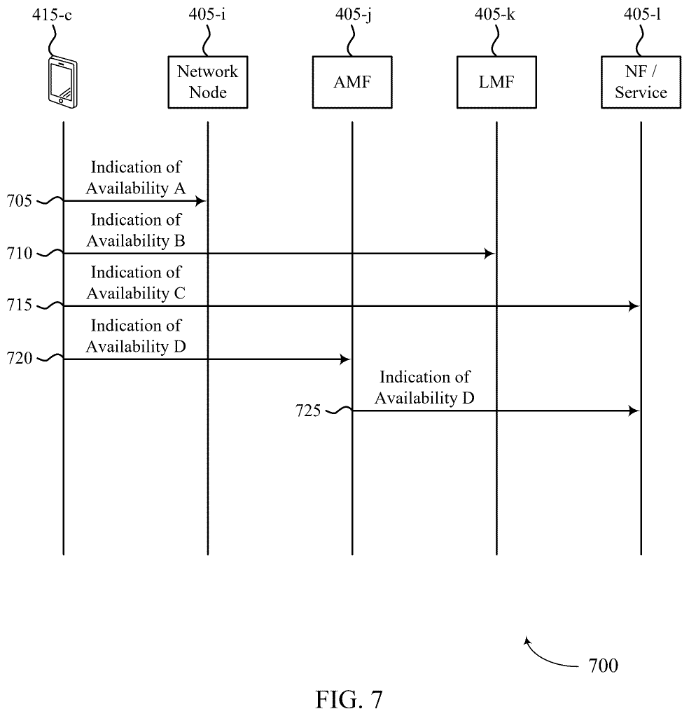

In some approaches, if the indication of availability corresponds to data related to an AI/ML-based use case or a non-AI/ML-based use case relevant to a network function or service of the one or more network entities 405 (and if the wireless device 415 may not communicate with the network function or service directly or transparently, for instance), the wireless device 415 may output the indication of availability to an AMF (of the one or more network entities 405), which may communicate (e.g., relay) the indication of availability to the network function or service (of the one or more network entities 405). The indication of availability for the network function or service may be communicated (e.g., output, transmitted, obtained, or received) via control plane or user plane signaling. Examples of the indication of availability are provided with reference to FIG. 7.

In some examples, the one or more network entities 405 may output (e.g., transmit), or the wireless device 415 may obtain, a request for at least a portion of the data. For instance, the one or more network entities 405 may output a request (e.g., command) for the wireless device 415 to report data collected during an access stratum state (e.g., connectivity state) or for a use case. The request may be indicated per use case in some approaches. Additionally, or alternatively, the request for data may be communicated per terminating node (e.g., a RAN node, network function, or service).

In some aspects, the request may indicate a condition to select the at least a portion of the data. For example, a RAN node, network function, or service may select one or more use cases for which data collection reporting is requested. Additionally, or alternatively, the RAN node, network function, or service may provide a condition, which may operate as a filtering mechanism for reporting (e.g., a quantity of samples or size per use case, an age of samples or data, among other examples). The wireless device 415 may select the at least a portion of the data based on the condition. For example, the condition may include a quantity of samples of the at least a portion of the data, a size of the at least a portion of the data, an age of the at least a portion of the data, a use case of the at least a portion of the data, a quality of the at least a portion of the data collected in at least one of the one or more access stratum states, a quality of the at least a portion of the data collected for at least one of the one or more use cases, or any combination thereof. In some approaches, the wireless device 415 (e.g., UE) may output (e.g., transmit), or the one or more network entities 405 may obtain (e.g., receive) the data based on the request (e.g., based on one or more conditions indicated by a RAN node, network function, or service).

A network entity (e.g., a terminating node) may request the wireless device 415 (e.g., UE) to report all of the data (e.g., regardless of the use case associated with or terminating at the network entity or terminating node), to report data per use case (by indicating a use case for which a report is requested, for instance), or to report data in accordance with a size or quantity of samples requested per use case.

In some examples, a network node (e.g., RAN entity, gNB, CU, DU, or RU, among other examples) of the one or more network entities 405 may output the request to the wireless device 415, where the request corresponds to data related to an AI/ML-based CSI feedback use case, an AI/ML-based beam management use case, an AI/ML-based mobility use case, an AI/ML-based positioning use case, an AI/ML-based cell reselection use case, an AI/ML-based RACH procedure, a use case for AI/ML-based power management, a non-AI/ML-based CSI feedback use case, a non-AI/ML-based beam management use case, a non-AI/ML-based mobility use case, a non-AI/ML-based positioning use case, a non-AI/ML-based cell reselection use case, a non-AI/ML-based RACH procedure, a use case for non-AI/ML-based power management, a sensing use case, or another use case relevant to the network node. The request from the network node may be communicated (e.g., output, transmitted, obtained, or received) via control plane signaling.

In some approaches, a location or sensing server (e.g., LMF or SnMF) of the one or more network entities 405, may output the request to the wireless device 415, where the request corresponds to data related to an AI/ML-based positioning or sensing use case, a non-AI/ML-based positioning or sensing use case, or another use case relevant to the location or sensing server. The request from the location or sensing server may be communicated (e.g., output, transmitted, obtained, or received) via control plane or user plane signaling (e.g., using LPP signaling or other signaling, such as NR positioning protocol A (NRPPa) signaling).

In some aspects, a network function or service of the one or more network entities 405 (if the wireless device 415 may communicate with the network function or service directly or transparently, for instance), may output the request to the wireless device 415, where the request corresponds to data related to a use case (e.g., an AI/ML-based use case or a non-AI/ML-based use case) relevant to the network function or service. The request from the network function or service may be communicated (e.g., output, transmitted, obtained, or received) via control plane or user plane signaling.

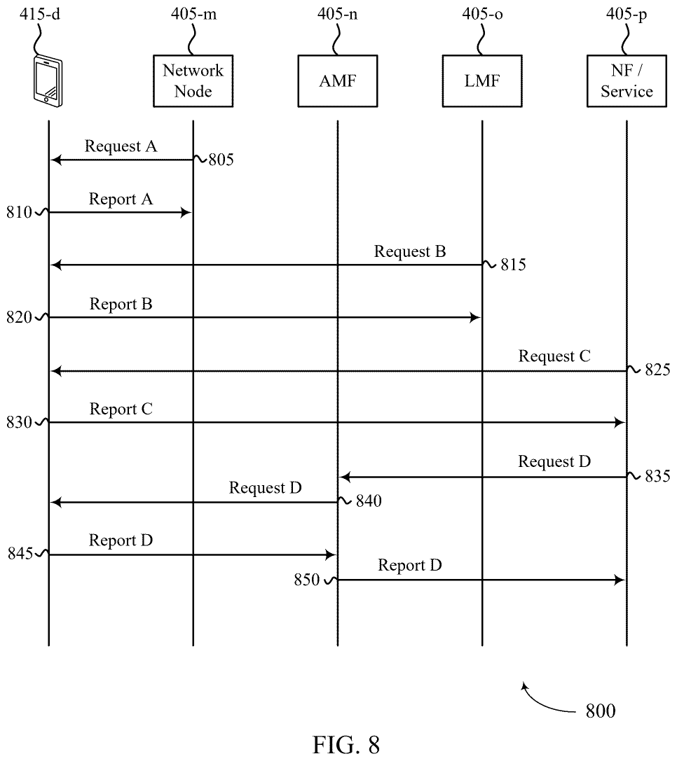

In some approaches, a network function or service of the one or more network entities 405 (if the wireless device 415 may not communicate with the network function or service directly or transparently, for instance) may output the request to an AMF (of the one or more network entities 405), which may communicate (e.g., relay) the request to the wireless device 415, where the request corresponds to data related to a use case (e.g., an AI/ML-based use case or a non-AI/ML-based use case) relevant to the network function or service. The request from the network function or service may be communicated (e.g., output, transmitted, obtained, or received) via control plane signaling. Examples of the request are provided with reference to FIG. 8.

In some examples, the wireless device 415 may output (e.g., transmit), or the one or more network entities 405 may obtain (e.g., receive) at least a portion of the data. In some approaches, the wireless device 415 (e.g., UE) may report information with the at least a portion of the data. In some aspects, the wireless device 415 may output (e.g., transmit), or the one or more network entities 405 may obtain (e.g., receive), an indication of an access stratum state associated with the at least a portion of the data, an indication of a configuration identifier associated with the at least a portion of the data, a use case associated with at least a portion of the data, or an indication of a level of a configuration associated with the at least a portion of the data. For example, the wireless device 415 may report an access stratum state in which the data (e.g., sample) is collected or logged, a use case for which the data (e.g., sample) is collected or logged, a relaxation configuration identifier applied during data collection (which may be reported per use case), or an indication of whether the data is collected when the wireless device 415 is using a relaxation configuration.

In some approaches, communicating (e.g., outputting, transmitting, obtaining, or receiving) the at least a portion of the data may include communicating all of the data to the one or more network entities 405 (regardless of use case, for instance), outputting the at least a portion of the data based on at least one use case (e.g., reporting data during an access stratum or connectivity state per use case), or outputting the at least a portion of the data based on a requested size or quantity of samples.

In some examples, if the data is related to an AI/ML-based CSI feedback use case, an AI/ML-based beam management use case, an AI/ML-based mobility use case, an AI/ML-based cell reselection use case, an AI/ML-based RACH procedure, a use case for AI/ML-based power management, a non-AI/ML-based CSI feedback use case, a non-AI/ML-based beam management use case, a non-AI/ML-based mobility use case, a non-AI/ML-based positioning use case, a non-AI/ML-based cell reselection use case, a non-AI/ML-based RACH procedure, a use case for non-AI/ML-based power management, or a sensing use case, or another use case relevant to a network node (e.g., RAN entity, gNB, CU, DU, or RU, among other examples) of the one or more network entities 405, the wireless device 415 may output the data to the network node. The data for the network node may be communicated (e.g., output, transmitted, obtained, or received) via control plane signaling. In some examples, signaling related to one or more use cases (e.g., a subset of use cases) may be exclusive to one or more types of network entities (e.g., RAN entity, gNB, CU, CU, RU, LMF, or SnMF, location or sensing server, among other examples).

In some approaches, if the data is related to an AI/ML-based positioning or sensing use case or another use case relevant to a location or sensing server (e.g., LMF or SnMF) of the one or more network entities 405, the wireless device 415 may output the data to the location or sensing server. The data for the location or sensing server may be communicated (e.g., output, transmitted, obtained, or received) via control plane or user plane signaling (e.g., using LPP signaling).

In some aspects, if the data is related to an AI/ML-based use case relevant to a network function or service of the one or more network entities 405 (and if the wireless device 415 may communicate with the network function or service directly or transparently, for instance), the wireless device 415 may output the data to the network function or service. The data for the network function or service may be communicated (e.g., output, transmitted, obtained, or received) via control plane or user plane signaling.

In some approaches, if the data is related to an AI/ML-based use case relevant to a network function or service of the one or more network entities 405 (and if the wireless device 415 may not communicate with the network function or service directly or transparently, for instance), the wireless device 415 may output the data to an AMF (of the one or more network entities 405), which may communicate (e.g., relay) the data to the network function or service (of the one or more network entities 405). The data for the network function or service may be communicated (e.g., output, transmitted, obtained, or received) via NAS signaling. Examples of the report of data are provided with reference to FIG. 8.

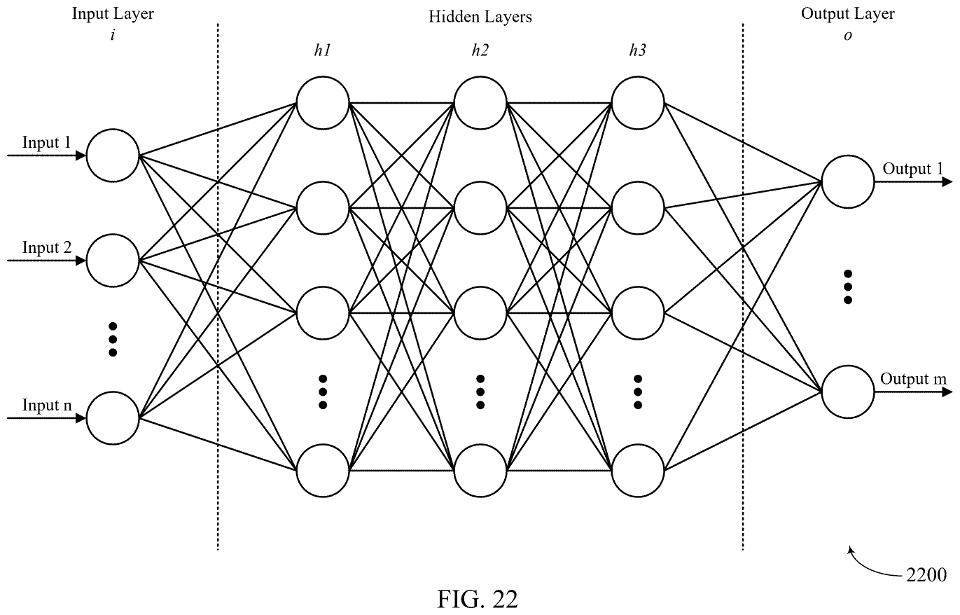

In accordance with some of the techniques described herein, the data may be collected and utilized to train one or more AI/ML models for one or more corresponding use cases. For instance, an AI/ML model may be trained based on the data to predict or infer CSI-RS feedback, beam measurements or beam selection, measurements for handover or cell switching, handover or cell switching events, RACH procedure signaling or events, or for positioning. The AI/ML model may be utilized at a wireless device (e.g., the wireless device 415) or one or more network entities (e.g., one or more network entities 405) for performing one or more operations in accordance with one or more use cases. As an example, data collected for a positioning use case may be communicated to a location or sensing server (e.g., LMF or SnMF). The location or sensing server or another device may utilize the data to train one or more AI/ML models for the positioning use case (e.g., to perform one or more AI/ML-based positioning procedures). An example of an AI/ML model that may be trained based on the data described herein is provided with reference to FIG. 22 in the context of a positioning use case.

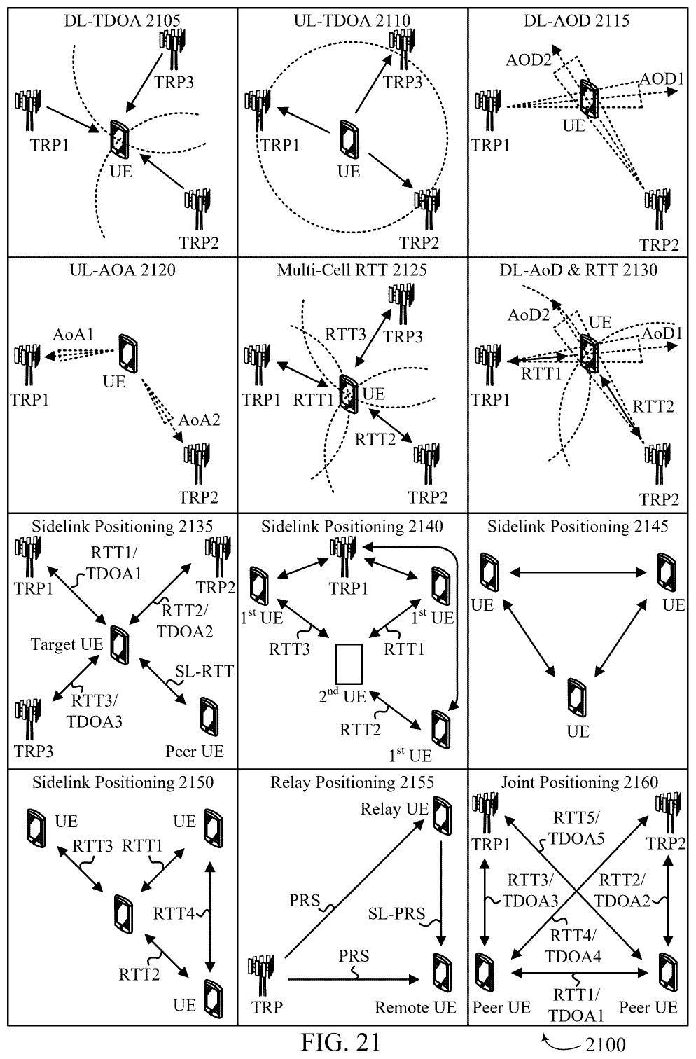

A positioning procedure may be one or more operations for estimating a location of a device (e.g., the wireless device 415 or a UE). For instance, a positioning procedure may include one or more operations of A-GNSS positioning, OTDOA positioning, E-CID positioning, sensor-based positioning, WLAN-based positioning, Bluetooth-based positioning, TBS positioning, DL-TDOA positioning, DL-AOD positioning, Multi-RTT positioning, NR E-CID positioning, UL-TDOA positioning, or UL-AOA positioning, among other examples. Position information may include an estimated position (e.g., estimated location) or one or more measurements associated with a positioning procedure (e.g., AI/ML-based positioning procedure or non-AI/ML-based positioning procedure). For instance, position information may include a position or measurement determined based on one or more positioning procedures, such as A-GNSS positioning, OTDOA positioning, E-CID positioning, sensor-based positioning, WLAN-based positioning, Bluetooth-based positioning, TBS positioning, DL-TDOA positioning, DL-AOD positioning, Multi-RTT positioning, NR E-CID positioning, UL-TDOA positioning, or UL-A positioning, among other examples. Examples of positioning procedures are described with reference to FIG. 21.

As used herein, the term “AI/ML-based positioning or sensing procedure” may refer to a positioning or sensing procedure performed with an AI model or ML model. An “AI/ML-based positioning or sensing procedure” may refer to direct AI/ML (D-AI/ML) positioning or sensing or assisted AI/ML positioning or sensing (A-AI/ML). An “AI/ML model” for positioning or sensing may refer generally to a physical AIML model, a logical AI/ML model, an AI/ML function, AI/ML functionality, or an AI/ML method, among other examples. The term “non-AI/ML-based positioning or sensing procedure” may refer to a positioning or sensing procedure performed without an AI model or ML model. AI/ML-based positioning or sensing procedures may improve positioning or sensing accuracy.

A non-AI/ML-based positioning or sensing procedure may include one or more positioning or sensing procedures where an AI/ML technique is not utilized to determine (e.g., infer or predict) a location or measurement. For instance, A-GNSS positioning, OTDOA positioning, E-CID positioning, sensor-based positioning, WLAN-based positioning, Bluetooth-based positioning, TBS positioning, DL-TDOA positioning, DL-AOD positioning, Multi-RTT positioning, NR E-CID positioning, UL-TDOA positioning, UL-AOA positioning, or other positioning performed without the use of an AI/ML technique or model may be examples of a non-AI/ML-based positioning or sensing procedure.

An AI/ML-based positioning or sensing procedure may include one or more positioning or sensing procedures where one or more AI/ML techniques (e.g., AI/ML model(s) or AI/ML function(s)) are utilized to determine (e.g., infer or predict) a position or measurement. In some examples, an AI model may be utilized to perform one or more operations of a positioning or sensing procedure (e.g., to infer or predict a measurement, value, quantity, or location). For instance, A-GNSS positioning, OTDOA positioning, E-CID positioning, sensor-based positioning, WLAN-based positioning, Bluetooth-based positioning, TBS positioning, DL-TDOA positioning, DL-AOD positioning, Multi-RTT positioning, NR E-CID positioning, UL-TDOA positioning, UL-AOA positioning, bistatic sensing, monostatic sensing, multi-static sensing, or other positioning or sensing performed with the use of an AI/ML technique(s) or model(s) may be examples of an AI/ML-based positioning or sensing procedure. For instance, an AI model may be trained to model one or more operations of a positioning or sensing procedure. When the AI model is executed, for instance, a position or one or more measurements may be generated (e.g., inferred or predicted) without directly performing the one or more operations of the positioning or sensing procedure.

A position may be information or data indicating a point, area, or region where an object (e.g., the wireless device 415) is located. A location may be expressed as coordinates (e.g., latitude, longitude, or altitude of a geographic coordinate system (GCS), universal transverse mercator (UTM) coordinates, state plane coordinate system (SPCS) coordinates, or Earth-centered Earth-fixed (ECEF) coordinates, among other examples), an address, or a location relative to another location, among other examples.

A measurement may be measured, generated, calculated, inferred, or predicted based on one or more samples, data, information, or characteristics of a reference signal. Examples of measurements may include signal strength, reference signal received power (RSRP), reference signal received path power (RSRPP), received signal strength indicator (RSSI), reference signal received quality (RSRQ), signal-to-interference plus noise ratio (SINR), SNR, channel frequency response (CFR), channel impulse response (CIR), power delay profile (PDP), delay profile (DP), channel quality indicator (CQI), CSI, line-of-sight (LOS) indicator, time of arrival (TOA), angle of arrival (AOA), angle of departure (AOD), round-trip time (RTT), reference signal time difference (RSTD), time difference of arrival (TDOA), reference signal carrier phase (RSCP), reference signal carrier phase difference (RSCPD), or reception-to-transmission (Rx-Tx) time difference, among other examples. In some examples, a measurement may be data or an indicator that indicates one or more of the aforementioned values.

In some examples, a network node may output (e.g., transmit), or the wireless device 415 may obtain (e.g., receive), a reference signal. In some examples, the network node may be a PRU. The reference signal may be a signal (e.g., electromagnetic signal, RF signal) with one or more established characteristics (e.g., signaling pattern, strength, amplitude, magnitude, frequency, timing, modulation, phase, or data, among other examples). For instance, the wireless device 415 or the network entity 405 may store information indicating one or more of the characteristics of the reference signal, which may allow for comparison of one or more stored characteristics and one or more characteristics of the received reference signal. The reference signal (e.g., the comparison) may enable channel estimation (e.g., channel attenuation, phase, frequency shift, or Doppler effects, among other examples), positioning, sensing, or tracking. Examples of the reference signal may include a reference signal of a synchronization signal block (SSB), a CSI-RS, a positioning reference signal (PRS), a sounding reference signal (SRS), a demodulation reference signal (DMRS), a sensing reference signal, or a tracking reference signal (TRS), among other examples.

In some examples, a wireless device 415 or a network entity 405 may obtain, receive, sense, capture, or generate one or more measurements. For instance, a wireless device 415 or a network entity 405 may include, may communicate with, or may be coupled with one or more sensors to obtain one or more measurements. Examples of a sensor may include an image sensor(s), infrared sensor(s), light sensor(s), depth sensor(s) (e.g., light detection and ranging (LIDAR), stereoscopic camera(s), or time-of-flight (TOF) sensor(s)), microphone(s), or RF sensor(s), among other examples. Examples of one or more measurements may include a range map (e.g., depth map), Doppler map, space map, angle map, light spectrum data, pixel(s), image(s) (e.g., red-green-blue-depth (RGBD) image(s)), audio signal(s), temperature map, TOF measurement(s), RF measurement(s), or other information (e.g., information regarding one or more objects).

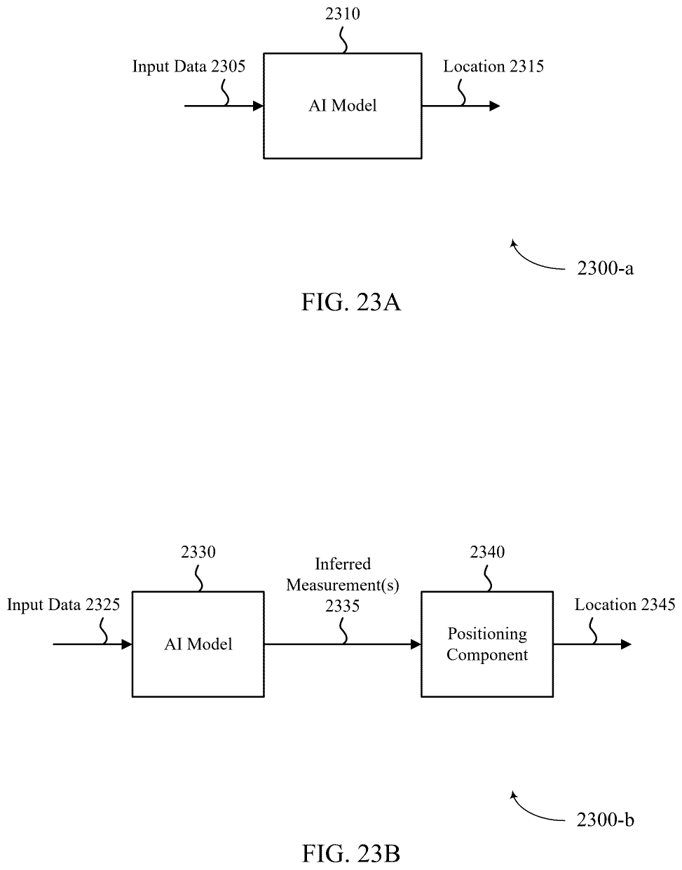

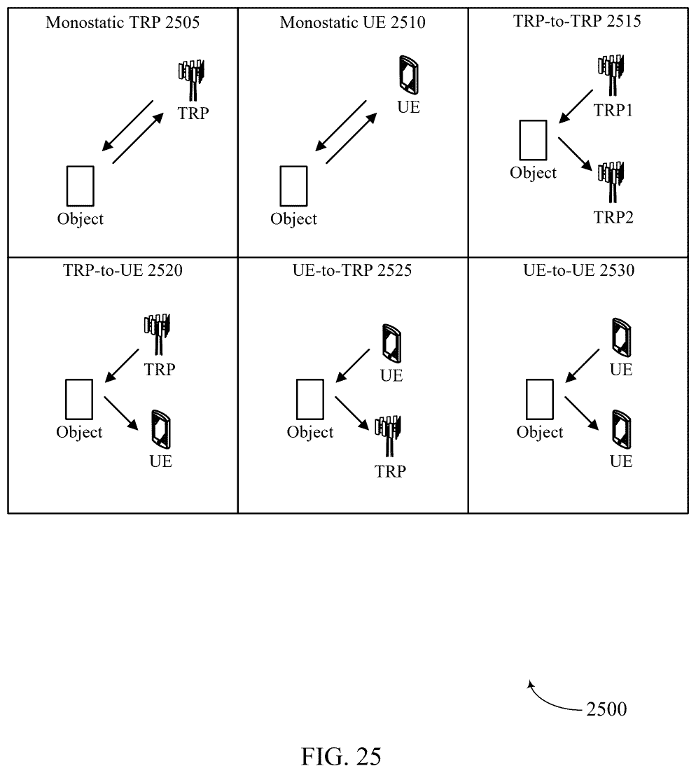

The measurement(s) may be processed to generate input (e.g., input data) to an AI/ML model, to generate data (e.g., a dataset), or may be utilized by an AI/ML model to generate an inferred position, object characteristic(s), or other measurements. Examples of input data, inferred measurements, and positions (e.g., locations) are provided with reference to FIG. 23A and FIG. 23B. Examples of sensing modes that may be utilized or performed with the measurements or data are described with reference to FIG. 25. In some aspects, an indication of one or more measurements or positions (e.g., one or more inferred measurements or positions) may be communicated with (e.g., transmitted to or received from) the wireless device 415 or the network entity 405. For example, the wireless device 415 may output (e.g., transmit) or the network entity 405 may obtain (e.g., receive) an indication of one or more inferred measurements or positions based on the one or more processing operations associated with AI/ML.

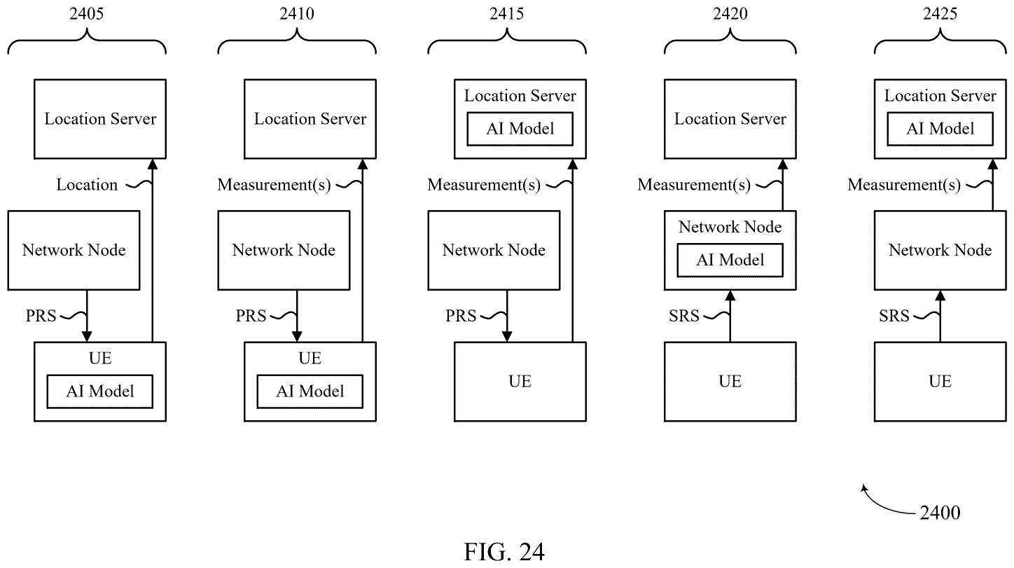

In some examples, one or more AI/ML models may be stored or processed on the wireless device 415 (e.g., a UE or a network node) or on the network entity 405 (e.g., a network node or a location or sensing server). Examples of locations where an AI/ML model may be stored or processed are provided with reference to FIG. 24.

FIG. 5 shows an example of a process flow 500 that supports data procedures associated with access stratum states or use cases in accordance with one or more aspects of the present disclosure. The process flow 500 may include a wireless device 415-a, which may be an example of a UE 115, UE 115-a, UE 115-b, or a wireless device 415, as described herein. The process flow 500 may also include a network node 405-a, which may be an example of a network node 105, gNB 255, ng-eNB 260, CU 160, CU 160-a, CU 160-b, DU 165, DU 165-a, DU 165-b, RU 170, RU 170-a, RU 170-b, or network entity 405, as described herein. The process flow 500 may additionally include an AMF 405-b, which may be an example of the AMF 210 or network entity 405, as described herein. The process flow 500 may further include an LMF 405-c, which may be an example of the location or sensing server 185, LMF 265, external device 230, SLP 235, or network entity 405, as described herein. The process flow 500 may further include a network function or service 405-d, which may be an example of the location or sensing server 185, LMF 265, external device 230, SLP 235, AMF 210, SMF 220, UPF 215, or network entity 405, as described herein.

In the following description of the process flow 500, the communications between the wireless device 415-a, the network node 405-a, the AMF 405-b, the LMF 405-c, or the network function or service 405-d may be transmitted in a different order than the example order shown, or the operations performed by the wireless device 415-a, the network node 405-a, the AMF 405-b, the LMF 405-c, or the network function or service 405-d may be performed in different orders or at different times. One or more operations may be omitted from the process flow 500, or one or more other operations may be added to the process flow 500. Although some operations or signaling may be shown to occur at different times for discussion purposes, these operations may actually occur at the same time or in overlapping time periods in some examples.

In some examples, the wireless device 415-a, the network node 405-a, the AMF 405-b, the LMF 405-c, or the network function or service 405-d may communicate information via the network node 405-a or the AMF 405-b or independent of the network node 405-a or the AMF 405-b. In some examples, the wireless device 415-a, the network node 405-a, or the AMF 405-b may communicate information, where the information may be relayed transparently via the network node 405-a or the AMF 405-b, may be processed by the network node 405-a or the AMF 405-b before communication to the wireless device 415-a, the network node 405-a, the AMF 405-b, the LMF 405-c, or the network function or service 405-d, or may not be transmitted to the wireless device 415-a, the network node 405-a, the AMF 405-b, the LMF 405-c, or the network function or service 405-d.

At 505, the wireless device 415-a may output (e.g., transmit), or the network node 405-a may obtain (e.g., receive) capability information A. In some examples, capability information A may be communicated as described with reference to FIG. 4. For example, capability information A may indicate a capability of the wireless device 415-a per use case for the network node 405-a (e.g., RAN node) via control plane signaling. Capability information A may indicate a capability for an AI/ML-based CSI feedback use case, which may indicate a flag, a size (e.g., maximum size) for logged data (e.g., in KBs or quantity of samples), an age (e.g., maximum duration or age) of data to be logged, or a quality of data collected in one or more access stratum states. Capability information A may indicate a capability for an AI/ML-based beam management use case, which may indicate a flag, a size (e.g., maximum size) for logged data (e.g., in KBs or quantity of samples), an age (e.g., maximum duration or age) of data to be logged, or a quality of data collected in one or more access stratum states. Capability information A may indicate a capability for an AI/ML-based mobility use case, which may indicate a flag, a size (e.g., maximum size) for logged data (e.g., in KBs or quantity of samples), an age (e.g., maximum duration or age) of data to be logged, or a quality of data collected in one or more access stratum states. Capability information A may indicate a capability for another use case(s), which may indicate a flag, a size (e.g., maximum size) for logged data (e.g., in KBs or quantity of samples), an age (e.g., maximum duration or age) of data to be logged, or a quality of data collected in one or more access stratum states.

At 510, the wireless device 415-a may output (e.g., transmit), or the LMF 405-c may obtain (e.g., receive) capability information B. In some examples, capability information B may be communicated as described with reference to FIG. 4. For example, capability information B may indicate a capability of the wireless device 415-a per use case via control plane signaling or user plane signaling (e.g., LPP signaling). Capability information B may indicate a capability for an AI/ML-based positioning use case, which may indicate a flag, a size (e.g., maximum size) for logged data (e.g., in KBs or quantity of samples), an age (e.g., maximum duration or age) of data to be logged, or a quality of data collected in one or more access stratum states.

At 515, the wireless device 415-a may output (e.g., transmit), or the network function or service 405-d may obtain (e.g., receive) capability information C. In some examples, capability information C may be communicated as described with reference to FIG. 4. For example, capability information C may indicate a capability of the wireless device 415-a per use case for the network function or service 405-d via control plane signaling or user plane signaling. Capability information C may indicate a capability for one or more AI/ML-based use cases, which may indicate a flag, a size (e.g., maximum size) for logged data (e.g., in KBs or quantity of samples), an age (e.g., maximum duration or age) of data to be logged, or a quality of data collected in one or more access stratum states. Capability information C may be communicated for scenarios where the wireless device 415-a may communicate directly with the network function or service 405-d.

At 520, the wireless device 415-a may output (e.g., transmit), or the AMF 405-b may obtain (e.g., receive) capability information D. In some examples, capability information D may be communicated as described with reference to FIG. 4. For example, capability information D may indicate a capability of the wireless device 415-a per use case via NAS signaling. Capability information D may indicate a capability for one or more AI/ML-based use cases, which may indicate a flag, a size (e.g., maximum size) for logged data (e.g., in KBs or quantity of samples), an age (e.g., maximum duration or age) of data to be logged, or a quality of data collected in one or more access stratum states. Capability information D may be communicated for scenarios where the wireless device 415-a may not communicate directly with the network function or service 405-d.

At 525, the AMF 405-b may output (e.g., transmit), or the network function or service 405-d may obtain (e.g., receive) capability information D. In some examples, capability information D may be communicated as described with reference to FIG. 4. For example, capability information D may indicate a capability of the wireless device 415-a per use case.

FIG. 6 shows an example of a process flow 600 that supports data procedures associated with access stratum states or use cases in accordance with one or more aspects of the present disclosure. The process flow 600 may include a wireless device 415-b, which may be an example of a UE 115, UE 115-a, UE 115-b, or a wireless device 415, as described herein. The process flow 600 may also include a network node 405-e, which may be an example of a network node 105, gNB 255, ng-eNB 260, CU 160, CU 160-a, CU 160-b, DU 165, DU 165-a, DU 165-b, RU 170, RU 170-a, RU 170-b, or network entity 405, as described herein. The process flow 600 may additionally include an AMF 405-f, which may be an example of the AMF 210 or network entity 405, as described herein. The process flow 600 may further include an LMF 405-g, which may be an example of the location or sensing server 185, LMF 265, external device 230, SLP 235, or network entity 405, as described herein. The process flow 600 may further include a network function or service 405-h, which may be an example of the location or sensing server 185, LMF 265, external device 230, SLP 235, AMF 210, SMF 220, UPF 215, or network entity 405, as described herein.

In the following description of the process flow 600, the communications between the wireless device 415-b, the network node 405-e, the AMF 405-f, the LMF 405-g, or the network function or service 405-h may be transmitted in a different order than the example order shown, or the operations performed by the wireless device 415-b, the network node 405-e, the AMF 405-f, the LMF 405-g, or the network function or service 405-h may be performed in different orders or at different times. One or more operations may be omitted from the process flow 600, or one or more other operations may be added to the process flow 600. Although some operations or signaling may be shown to occur at different times for discussion purposes, these operations may actually occur at the same time or in overlapping time periods in some examples.

In some examples, the wireless device 415-b, the network node 405-e, the AMF 405-f, the LMF 405-g, or the network function or service 405-h may communicate information via the network node 405-e or the AMF 405-f or independent of the network node 405-e or the AMF 405-f. In some examples, the wireless device 415-b, the network node 405-e, or the AMF 405-f may communicate information, where the information may be relayed transparently via the network node 405-e or the AMF 405-f, may be processed by the network node 405-e or the AMF 405-f before communication to the wireless device 415-b, the network node 405-e, the AMF 405-f, the LMF 405-g, or the network function or service 405-h, or may not be transmitted to the wireless device 415-b, the network node 405-e, the AMF 405-f, the LMF 405-g, or the network function or service 405-h.

At 605, the network node 405-e may output (e.g., transmit), or the wireless device 415-b may obtain (e.g., receive) configuration information A. In some examples, configuration information A may be communicated as described with reference to FIG. 4. For example, configuration information A may indicate a configuration for data collection for the wireless device 415-b per use case for the network node 405-e (e.g., RAN node) via control plane signaling. Configuration information A may indicate information for an AI/ML-based CSI feedback use case, which may indicate one or more access stratum states (e.g., RRC connected, RRC inactive, RRC idle) or a relaxation configuration for a data operation (e.g., data collection, data logging, data reporting, or any combination thereof). Configuration information A may indicate information for an AI/ML-based beam management use case, which may indicate one or more access stratum states (e.g., RRC connected, RRC inactive, RRC idle) or a relaxation configuration for a data operation (e.g., data collection, data logging, data reporting, or any combination thereof). Configuration information A may indicate information for an AI/ML-based mobility use case, which may indicate one or more access stratum states (e.g., RRC connected, RRC inactive, RRC idle) or a relaxation configuration for a data operation (e.g., data collection, data logging, data reporting, or any combination thereof). Configuration information A may indicate information for another use case(s), which may indicate one or more access stratum states (e.g., RRC connected, RRC inactive, RRC idle) or a relaxation configuration for a data operation (e.g., data collection, data logging, data reporting, or any combination thereof).

At 610, the LMF 405-g may output (e.g., transmit), or the wireless device 415-b may obtain (e.g., receive) configuration information B. In some examples, configuration information B may be communicated as described with reference to FIG. 4. For example, configuration information B may indicate a configuration for data collection for the wireless device 415-b per use case via control plane signaling or user plane signaling (e.g., LPP signaling). Configuration information B may indicate information for an AI/ML-based positioning use case, which may indicate one or more access stratum states (e.g., RRC connected, RRC inactive, RRC idle) or a relaxation configuration for a data operation (e.g., data collection, data logging, data reporting, or any combination thereof).

At 615, the network function or service 405-h may output (e.g., transmit), or the wireless device 415-b may obtain (e.g., receive) configuration information C. In some examples, configuration information C may be communicated as described with reference to FIG. 4. For example, configuration information C may indicate a configuration for data collection for the wireless device 415-b per use case via control plane signaling or user plane signaling. Configuration information C may indicate information for one or more AI/ML-based use cases, which may indicate one or more access stratum states (e.g., RRC connected, RRC inactive, RRC idle) or a relaxation configuration for a data operation (e.g., data collection, data logging, data reporting, or any combination thereof). Configuration information C may be communicated for scenarios where the wireless device 415-b may communicate directly with the network function or service 405-h.

At 620, the network function or service 405-h may output (e.g., transmit), or the AMF 405-f may obtain (e.g., receive) configuration information D. In some examples, configuration information D may be communicated as described with reference to FIG. 4. For example, configuration information D may indicate a configuration for data collection for the wireless device 415-b per use case via control plane signaling. Configuration information D may indicate information for one or more AI/ML-based use cases, which may indicate one or more access stratum states (e.g., RRC connected, RRC inactive, RRC idle) or a relaxation configuration for a data operation (e.g., data collection, data logging, data reporting, or any combination thereof. Configuration information D may be communicated for scenarios where the wireless device 415-b may not communicate directly with the network function or service 405-h.

At 625, the AMF 405-f may output (e.g., transmit), or the wireless device 415-b may obtain (e.g., receive) configuration information D. In some examples, configuration information D may be communicated as described with reference to FIG. 4. For example, configuration information D may indicate a configuration for data collection for the wireless device 415-b per use case.

FIG. 7 shows an example of a process flow 700 that supports data procedures associated with access stratum states or use cases in accordance with one or more aspects of the present disclosure. The process flow 700 may include a wireless device 415-c, which may be an example of a UE 115, UE 115-a, UE 115-b, or a wireless device 415, as described herein. The process flow 700 may also include a network node 405-i, which may be an example of a network node 105, gNB 255, ng-eNB 260, CU 160, CU 160-a, CU 160-b, DU 165, DU 165-a, DU 165-b, RU 170, RU 170-a, RU 170-b, or network entity 405, as described herein. The process flow 700 may additionally include an AMF 405-j, which may be an example of the AMF 210 or network entity 405, as described herein. The process flow 700 may further include an LMF 405-k, which may be an example of the location or sensing server 185, LMF 265, external device 230, SLP 235, or network entity 405, as described herein. The process flow 700 may further include a network function or service 405-l, which may be an example of the location or sensing server 185, LMF 265, external device 230, SLP 235, AMF 210, SMF 220, UPF 215, or network entity 405, as described herein.

In the following description of the process flow 700, the communications between the wireless device 415-c, the network node 405-i, the AMF 405-j, the LMF 405-k, or the network function or service 405-l may be transmitted in a different order than the example order shown, or the operations performed by the wireless device 415-c, the network node 405-i, the AMF 405-j, the LMF 405-k, or the network function or service 405-l may be performed in different orders or at different times. One or more operations may be omitted from the process flow 700, or one or more other operations may be added to the process flow 700. Although some operations or signaling may be shown to occur at different times for discussion purposes, these operations may actually occur at the same time or in overlapping time periods in some examples.

In some examples, the wireless device 415-c, the network node 405-i, the AMF 405-j, the LMF 405-k, or the network function or service 405-l may communicate information via the network node 405-i or the AMF 405-j or independent of the network node 405-i or the AMF 405-j. In some examples, the wireless device 415-c, the network node 405-i, or the AMF 405-j may communicate information, where the information may be relayed transparently via the network node 405-i or the AMF 405-j, may be processed by the network node 405-i or the AMF 405-j before communication to the wireless device 415-c, the network node 405-i, the AMF 405-j, the LMF 405-k, or the network function or service 405-l, or may not be transmitted to the wireless device 415-c, the network node 405-i, the AMF 405-j, the LMF 405-k, or the network function or service 405-l.

At 705, the wireless device 415-c may output (e.g., transmit), or the network node 405-i may obtain (e.g., receive) indication of availability A. In some examples, indication of availability A may be communicated as described with reference to FIG. 4. For example, indication of availability A may indicate an availability of data for the network node 405-i (e.g., RAN node) via control plane signaling. Indication of availability A may indicate an availability of data for an AI/ML-based CSI feedback use case, which may indicate a flag, a size (e.g., maximum size) for logged data (e.g., in KBs or quantity of samples), an age (e.g., maximum duration or age) of logged data, or a quality of data collected in one or more access stratum states. Indication of availability A may indicate an availability of data for an AI/ML-based beam management use case, which may indicate a flag, a size (e.g., maximum size) for logged data (e.g., in KBs or quantity of samples), an age (e.g., maximum duration or age) of logged data, or a quality of data collected in one or more access stratum states. Indication of availability A may indicate an availability of data for an AI/ML-based mobility use case, which may indicate a flag, a size (e.g., maximum size) for logged data (e.g., in KBs or quantity of samples), an age (e.g., maximum duration or age) of logged data, or a quality of data collected in one or more access stratum states. Indication of availability A may indicate an availability of data for another use case(s), which may indicate a flag, a size (e.g., maximum size) for logged data (e.g., in KBs or quantity of samples), an age (e.g., maximum duration or age) of logged data, or a quality of data collected in one or more access stratum states.

At 710, the wireless device 415-c may output (e.g., transmit), or the LMF 405-k may obtain (e.g., receive) indication of availability B. In some examples, indication of availability B may be communicated as described with reference to FIG. 4. For example, indication of availability B may indicate an availability of data via control plane signaling or user plane signaling (e.g., LPP signaling). Indication of availability B may indicate an availability of data for an AI/ML-based positioning use case, which may indicate a flag, a size (e.g., maximum size) for logged data (e.g., in KBs or quantity of samples), an age (e.g., maximum duration or age) of logged data, or a quality of data collected in one or more access stratum states.

At 715, the wireless device 415-c may output (e.g., transmit), or the network function or service 405-l may obtain (e.g., receive) indication of availability C. In some examples, indication of availability C may be communicated as described with reference to FIG. 4. For example, indication of availability C may indicate an availability of data for the network function or service 405-l via control plane signaling or user plane signaling. Indication of availability C may indicate an availability of data for one or more AI/ML-based use cases, which may indicate a flag, a size (e.g., maximum size) for logged data (e.g., in KBs or quantity of samples), an age (e.g., maximum duration or age) of logged data, or a quality of data collected in one or more access stratum states. Indication of availability C may be communicated for scenarios where the wireless device 415-c may communicate directly with the network function or service 405-l.

At 720, the wireless device 415-c may output (e.g., transmit), or the AMF 405-j may obtain (e.g., receive) indication of availability D. In some examples, indication of availability D may be communicated as described with reference to FIG. 4. For example, indication of availability D may indicate an availability of data via control plane signaling. Indication of availability D may indicate an availability of data for one or more AI/ML-based use cases, which may indicate a flag, a size (e.g., maximum size) for logged data (e.g., in KBs or quantity of samples), an age (e.g., maximum duration or age) of logged data, or a quality of data collected in one or more access stratum states. Indication of availability D may be communicated for scenarios where the wireless device 415-c may not communicate directly with the network function or service 405-l.

At 725, the AMF 405-j may output (e.g., transmit), or the network function or service 405-l may obtain (e.g., receive) indication of availability D. In some examples, indication of availability D may be communicated as described with reference to FIG. 4. For example, indication of availability D may indicate an availability of data via control plane or user plane signaling.

FIG. 8 shows an example of a process flow 800 that supports data procedures associated with access stratum states or use cases in accordance with one or more aspects of the present disclosure. The process flow 800 may include a wireless device 415-d, which may be an example of a UE 115, UE 115-a, UE 115-b, or a wireless device 415, as described herein. The process flow 800 may also include a network node 405-m, which may be an example of a network node 105, gNB 255, ng-eNB 260, CU 160, CU 160-a, CU 160-b, DU 165, DU 165-a, DU 165-b, RU 170, RU 170-a, RU 170-b, or network entity 405, as described herein. The process flow 800 may additionally include an AMF 405-n, which may be an example of the AMF 210 or network entity 405, as described herein. The process flow 800 may further include an LMF 405-o, which may be an example of the location or sensing server 185, LMF 265, external device 230, SLP 235, or network entity 405, as described herein. The process flow 800 may further include a network function or service 405-p, which may be an example of the location or sensing server 185, LMF 265, external device 230, SLP 235, AMF 210, SMF 220, UPF 215, or network entity 405, as described herein.

In the following description of the process flow 800, the communications between the wireless device 415-d, the network node 405-m, the AMF 405-n, the LMF 405-o, or the network function or service 405-p may be transmitted in a different order than the example order shown, or the operations performed by the wireless device 415-d, the network node 405-m, the AMF 405-n, the LMF 405-o, or the network function or service 405-p may be performed in different orders or at different times. One or more operations may be omitted from the process flow 800, or one or more other operations may be added to the process flow 800. Although some operations or signaling may be shown to occur at different times for discussion purposes, these operations may actually occur at the same time or in overlapping time periods in some examples.

In some examples, the wireless device 415-d, the network node 405-m, the AMF 405-n, the LMF 405-o, or the network function or service 405-p may communicate information via the network node 405-m or the AMF 405-n or independent of the network node 405-m or the AMF 405-n. In some examples, the wireless device 415-d, the network node 405-m, or the AMF 405-n may communicate information, where the information may be relayed transparently via the network node 405-m or the AMF 405-n, may be processed by the network node 405-m or the AMF 405-n before communication to the wireless device 415-d, the network node 405-m, the AMF 405-n, the LMF 405-o, or the network function or service 405-p, or may not be transmitted to the wireless device 415-d, the network node 405-m, the AMF 405-n, the LMF 405-o, or the network function or service 405-p.

At 805, the network node 405-m may output (e.g., transmit), or the wireless device 415-d may obtain (e.g., receive) request A. In some examples, request A may be communicated as described with reference to FIG. 4. For example, request A may indicate a request for data for the network node 405-m (e.g., RAN node) via control plane signaling. Request A may indicate a request for data for an AI/ML-based CSI feedback use case, which may indicate a flag, a size (e.g., maximum size) for logged data (e.g., in KBs or quantity of samples), an age (e.g., maximum duration or age) of logged data, or a quality of data requested for one or more access stratum states. Request A may indicate a request for data for an AI/ML-based beam management use case, which may indicate a flag, a size (e.g., maximum size) for logged data (e.g., in KBs or quantity of samples), an age (e.g., maximum duration or age) of logged data, or a quality of data requested for one or more access stratum states. Request A may indicate a request for data for an AI/ML-based mobility use case, which may indicate a flag, a size (e.g., maximum size) for logged data (e.g., in KBs or quantity of samples), an age (e.g., maximum duration or age) of logged data, or a quality of data requested for one or more access stratum states. Request A may indicate a request for data for another use case(s), which may indicate a flag, a size (e.g., maximum size) for logged data (e.g., in KBs or quantity of samples), an age (e.g., maximum duration or age) of logged data, or a quality of data requested for one or more access stratum states.

At 810, the wireless device 415-d may output (e.g., transmit), or the network node 405-m may obtain (e.g., receive) report A. In some examples, report A may be communicated as described with reference to FIG. 4. For example, report A may indicate at least a portion of data in accordance with one or more conditions of request A for the network node 405-m (e.g., RAN node) via control plane signaling. Report A may indicate at least a portion of data in accordance with one or more conditions of request A for an AI/ML-based CSI feedback use case. Report A may indicate at least a portion of data in accordance with one or more conditions of request A for an AI/ML-based beam management use case. Report A may indicate at least a portion of data in accordance with one or more conditions of request A for an AI/ML-based mobility use case. Report A may indicate at least a portion of data in accordance with one or more conditions of request A for another use case(s).

At 815, the LMF 405-o may output (e.g., transmit), or the wireless device 415-d may obtain (e.g., receive) request B. In some examples, request B may be communicated as described with reference to FIG. 4. For example, request B may indicate a request for data via control plane signaling or user plane signaling (e.g., LPP signaling). Request B may indicate a request for data for an AI/ML-based positioning use case, which may indicate a flag, a size (e.g., maximum size) for logged data (e.g., in KBs or quantity of samples), an age (e.g., maximum duration or age) of logged data, or a quality of data requested for one or more access stratum states.

At 820, the wireless device 415-d may output (e.g., transmit), or the LMF 405-o may obtain (e.g., receive) report B. In some examples, report B may be communicated as described with reference to FIG. 4. For example, report B may indicate at least a portion of data in accordance with one or more conditions of request B via control plane signaling or user plane signaling (e.g., LPP signaling). Report B may indicate at least a portion of data in accordance with one or more conditions of request B for an AI/ML-based positioning use case.

At 825, the network function or service 405-p may output (e.g., transmit), or the wireless device 415-d may obtain (e.g., receive) request C. In some examples, request C may be communicated as described with reference to FIG. 4. For example, request C may indicate a request for data for the network function or service 405-p via control plane signaling or user plane signaling. Request C may indicate a request for data for one or more AI/ML-based use cases, which may indicate a flag, a size (e.g., maximum size) for logged data (e.g., in KBs or quantity of samples), an age (e.g., maximum duration or age) of logged data, or a quality of data requested for one or more access stratum states. Request C may be communicated for scenarios where the wireless device 415-d may communicate directly with the network function or service 405-p.

At 830, the wireless device 415-d may output (e.g., transmit), or the network function or service 405-p may obtain (e.g., receive) report C. In some examples, report C may be communicated as described with reference to FIG. 4. For example, report C may indicate at least a portion of data in accordance with one or more conditions of request C for the network function or service 405-p via control plane signaling or user plane signaling. Report C may indicate at least a portion of data in accordance with one or more conditions of request C for one or more AI/ML-based use cases. Report C may be communicated for scenarios where the wireless device 415-d may communicate directly with the network function or service 405-p.

At 835, the network function or service 405-p may output (e.g., transmit), or the AMF 405-n may obtain (e.g., receive) request D. In some examples, request D may be communicated as described with reference to FIG. 4. For example, request D may indicate a request for data via control plane signaling. Request D may indicate a request for data for one or more AI/ML-based use cases, which may indicate a flag, a size (e.g., maximum size) for logged data (e.g., in KBs or quantity of samples), an age (e.g., maximum duration or age) of logged data, or a quality of data requested for one or more access stratum states. Request D may be communicated for scenarios where the wireless device 415-d may not communicate directly with the network function or service 405-p.

At 840, the AMF 405-n may output (e.g., transmit), or the wireless device 415-d may obtain (e.g., receive) request D. In some examples, request D may be communicated as described with reference to FIG. 4. For example, request D may indicate a request for data via control plane or user plane signaling.

At 845, the wireless device 415-d may output (e.g., transmit), or the AMF 405-n may obtain (e.g., receive) report D. In some examples, report D may be communicated as described with reference to FIG. 4. For example, report D may indicate at least a portion of data in accordance with one or more conditions of request D via control plane signaling. Report D may indicate at least a portion of data in accordance with one or more conditions of request D for one or more AI/ML-based use cases. Report D may be communicated for scenarios where the wireless device 415-d may not communicate directly with the network function or service 405-p.

At 850, the AMF 405-n may output (e.g., transmit), or the network function or service 405-p may obtain (e.g., receive) report D. In some examples, report D may be communicated as described with reference to FIG. 4. For example, report D may indicate at least a portion of data in accordance with one or more conditions of request D via control plane or user plane signaling.

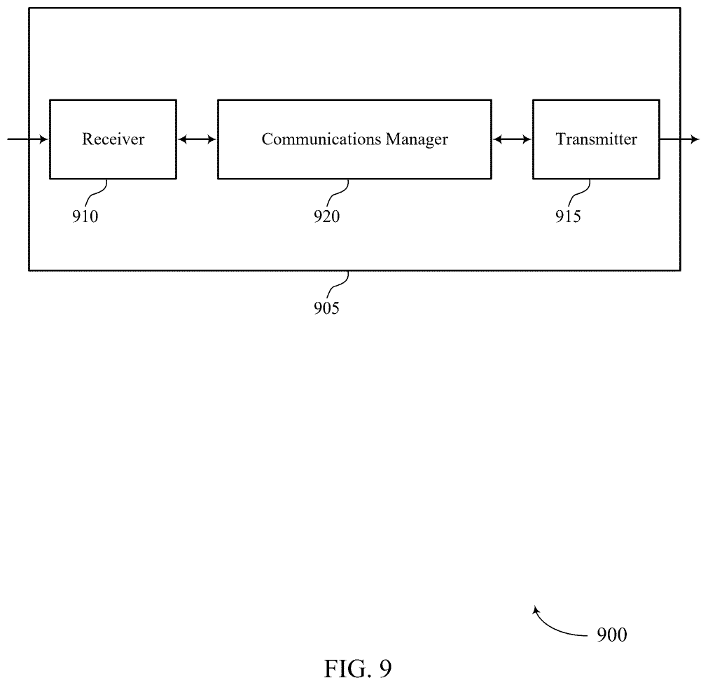

FIG. 9 shows a block diagram 900 of a device 905 that supports data procedures associated with access stratum states or use cases in accordance with one or more aspects of the present disclosure. The device 905 may be an example of aspects of a wireless device as described herein. The device 905 may include a receiver 910, a transmitter 915, and a communications manager 920. The device 905, or one or more components of the device 905 (e.g., the receiver 910, the transmitter 915, the communications manager 920), may include one or more processors, memory coupled with the one or more processors, and instructions stored in the memory that are executable by the one or more processors to enable the one or more processors to perform the data procedures associated with access stratum states or use cases features discussed herein. Each of these components may be in communication with one another (e.g., via one or more buses).

The receiver 910 may provide a means for receiving information such as packets, user data, control information, or any combination thereof associated with various information channels (e.g., control channels, data channels, information channels related to data procedures associated with access stratum states or use cases). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to data procedures associated with access stratum states or use cases). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of data procedures associated with access stratum states or use cases as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

For example, the communications manager 920 is capable of, configured to, or operable to support a means for outputting, to one or more network entities based on one or more use cases, capability information indicating a capability of the wireless device to participate in a data collection procedure (e.g., training data collection, measurement collection, or other data collection procedure), where the capability information indicates one or more parameters for the data collection procedure, and where the data collection procedure is associated with data for training an AI/ML model for the one or more use cases. The communications manager 920 is capable of, configured to, or operable to support a means for obtaining, from the one or more network entities based on the one or more use cases, configuration information indicating that the wireless device is configured for the data collection procedure.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, or more efficient utilization of communication resources.

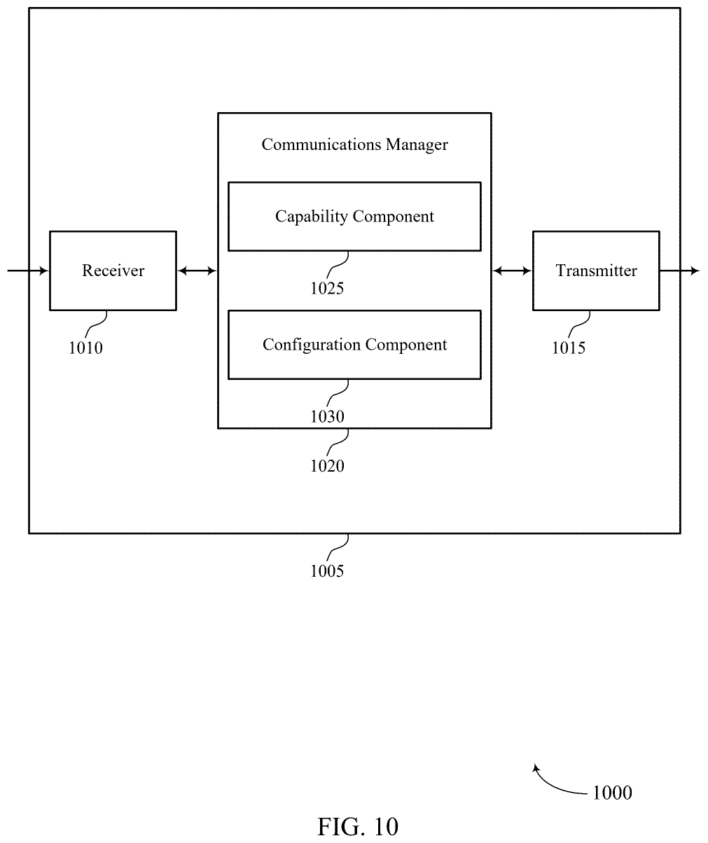

FIG. 10 shows a block diagram 1000 of a device 1005 that supports data procedures associated with access stratum states or use cases in accordance with one or more aspects of the present disclosure. The device 1005 may be an example of aspects of a device 905 or a wireless device 415 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to data procedures associated with access stratum states or use cases). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to data procedures associated with access stratum states or use cases). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of data procedures associated with access stratum states or use cases as described herein. For example, the communications manager 1020 may include a capability component 1025 a configuration component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The capability component 1025 is capable of, configured to, or operable to support a means for outputting, to one or more network entities based on one or more use cases, capability information indicating a capability of the wireless device to participate in a data collection procedure, where the capability information indicates one or more parameters for the data collection procedure (e.g., training data collection, measurement collection, or other data collection procedure), and where the data collection procedure is associated with data for training an AI/ML model for the one or more use cases. The configuration component 1030 is capable of, configured to, or operable to support a means for obtaining, from the one or more network entities based on the one or more use cases, configuration information indicating that the wireless device is configured for the data collection procedure.

In some cases, the capability component 1025 or the configuration component 1030 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the capability component 1025 or the configuration component 1030 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

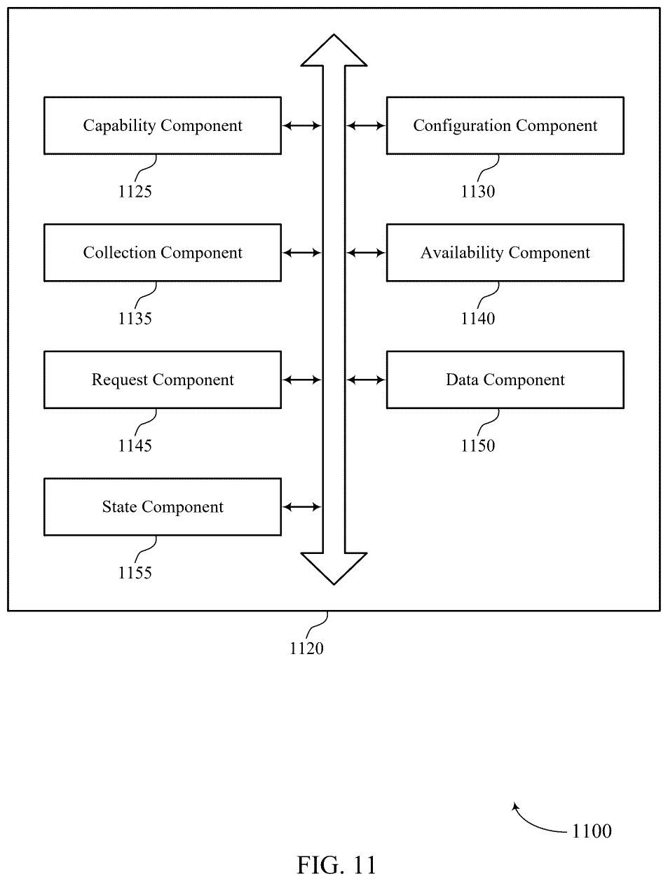

FIG. 11 shows a block diagram 1100 of a communications manager 1120 that supports data procedures associated with access stratum states or use cases in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of data procedures associated with access stratum states or use cases as described herein. For example, the communications manager 1120 may include a capability component 1125, a configuration component 1130, a collection component 1135, an availability component 1140, a request component 1145, a data component 1150, a state component 1155, or any combination thereof. Each of these components, or components or subcomponents thereof (e.g., one or more processors, one or more memories), may communicate, directly or indirectly, with one another (e.g., via one or more buses).

The capability component 1125 is capable of, configured to, or operable to support a means for outputting, to one or more network entities based on one or more use cases, capability information indicating a capability of the wireless device to participate in a data collection procedure (e.g., training data collection, measurement collection, or other data collection procedure), where the capability information indicates one or more parameters for the data collection procedure, and where the data collection procedure is associated with data for training an AI/ML model for the one or more use cases. The configuration component 1130 is capable of, configured to, or operable to support a means for obtaining, from the one or more network entities based on the one or more use cases, configuration information indicating that the wireless device is configured for the data collection procedure.

In some examples, the capability information indicates at least one of the one or more use cases corresponding to the capability of the wireless device to participate in the data collection procedure.

In some examples, the one or more use cases include an AI/ML-based CSI feedback use case, an AI/ML-based beam management use case, an AI/ML-based mobility use case, an AI/ML-based positioning use case, an AI/ML-based cell reselection use case, an AI/ML-based RACH procedure, or a use case for AI/ML-based power management, a non-AI/ML-based CSI feedback use case, a non-AI/ML-based beam management use case, a non-AI/ML-based mobility use case, a non-AI/ML-based positioning use case, a non-AI/ML-based cell reselection use case, a non-AI/ML-based RACH procedure, a use case for non-AI/ML-based power management, or a sensing use case.

In some examples, the one or more parameters indicated by the capability information include a quantity of samples of at least a portion of the data, a size of at least a portion of the data, an age of at least a portion of the data, a quality of the data collected (e.g., in at least one of the one or more access stratum states or of the one or more use cases), or any combination thereof.

In some examples, the one or more access stratum states include a connected state, an inactive state, or an idle state. In some examples, the configuration information indicates that the wireless device is configured to participate in the data collection procedure in at least one of the connected state, the inactive state, the idle state, or any combination thereof.

In some examples, the collection component 1135 is capable of, configured to, or operable to support a means for participating in the data collection procedure for the at least one of the one or more access stratum states based on the configuration information, where participating in the data collection procedure includes performing one or more measurements associated with data collection, data logging, data reporting, or any combination thereof.

In some examples, the availability component 1140 is capable of, configured to, or operable to support a means for outputting, to the one or more network entities based on the one or more use cases, an indication of availability of the data.

In some examples, the indication of availability indicates at least one of the one or more use cases associated with the data.

In some examples, the indication of availability indicates a quantity of samples of the data, a size of the data, an age of the data corresponding to at least one of the one or more use cases, or a quality of the data collected (e.g., in at least one of the one or more access stratum states or of the one or more use cases).

In some examples, the request component 1145 is capable of, configured to, or operable to support a means for obtaining, from at least one of the one or more network entities, a request for at least a portion of the data.

In some examples, the request indicates a condition to select the at least a portion of the data. In some examples, the at least a portion of the data is selected based on the condition.

In some examples, the condition includes a quantity of samples of the at least a portion of the data, a size of the at least a portion of the data, an age of the at least a portion of the data, a use case of the at least a portion of the data, a quality of the at least a portion of the data collected (e.g., in at least one of the one or more access stratum states or of the one or more use cases), or any combination thereof.

In some examples, the data component 1150 is capable of, configured to, or operable to support a means for outputting, to at least one of the one or more network entities, at least a portion of the data.

In some examples, the state component 1155 is capable of, configured to, or operable to support a means for outputting, to at least one of the one or more network entities, an indication of an access stratum state associated with the at least a portion of the data, an indication of a configuration identifier associated with the at least a portion of the data, or an indication of a level of a configuration associated with the at least a portion of the data.

In some examples, outputting the at least a portion of the data includes outputting all of the data to the one or more network entities, outputting the at least a portion of the data based on at least one use case, or outputting the at least a portion of the data based on a requested size or quantity of samples.

In some examples, the configuration information indicates at least one use case and at least one access stratum state for performing one or more measurements associated with data collection, for performing data logging, for performing data reporting, or any combination thereof.

In some examples, the configuration information indicates a first level of the data collection procedure and a second level of the data collection procedure for at least one use case or for at least one access stratum state. In some examples, the second level of the data collection procedure utilizes fewer resources than the first level.

In some examples, the second level of the data collection procedure is associated with an operating condition of the wireless device.

In some examples, the wireless device is a UE. In some examples, the one or more network entities include a network node, a network function, an AMF, a LMF, SnMF, or a server.

In some cases, the capability component 1125, configuration component 1130, collection component 1135, availability component 1140, request component 1145, data component 1150, or state component 1155 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the capability component 1125, configuration component 1130, collection component 1135, availability component 1140, request component 1145, data component 1150, or state component 1155 discussed herein.

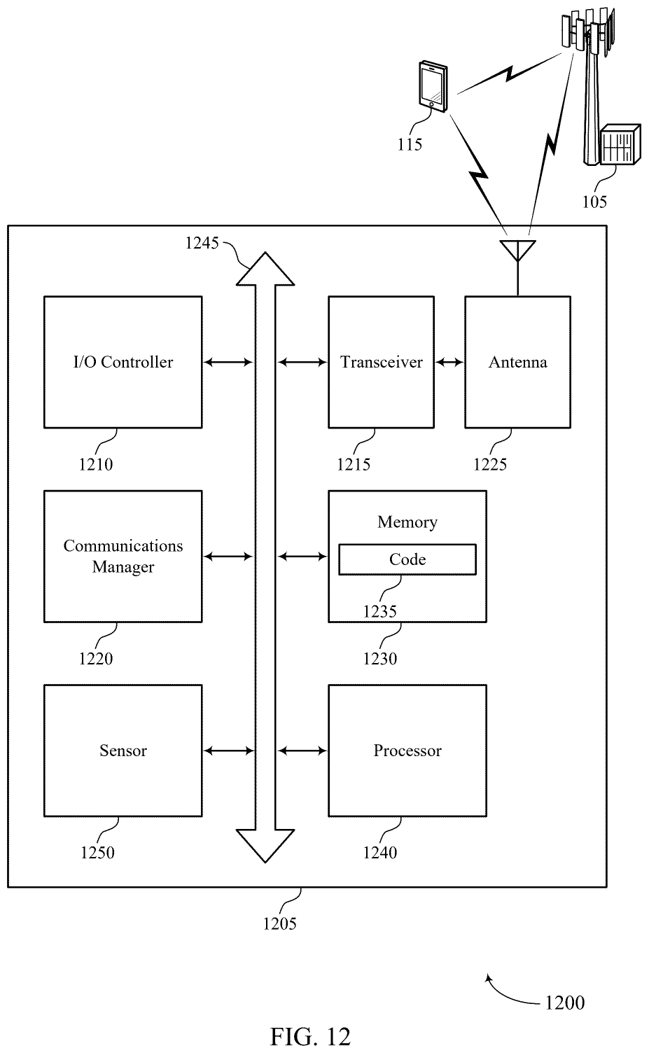

FIG. 12 shows a diagram of a system 1200 including a device 1205 that supports data procedures associated with access stratum states or use cases in accordance with one or more aspects of the present disclosure. The device 1205 may be an example of or include components of a device 905, a device 1005, or a wireless device 415 as described herein. The device 1205 may include components for bi-directional voice and data communications including components for transmitting and receiving communications, such as a communications manager 1220, an I/O controller, such as an I/O controller 1210, one or more transceivers 1215, one or more antennas 1225, at least one memory 1230, code 1235, and at least one processor 1240. The device 1205 may include one or more sensors 1250. These components may be in electronic communication or otherwise coupled (e.g., operatively, communicatively, functionally, electronically, electrically) via one or more buses (e.g., a bus 1245). The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver(s) 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The one or more transceivers 1215 may include one or more wireless wide area network (WWAN) transceivers, one or more short-range wireless transceivers, or one or more satellite transceivers. The WWAN transceiver(s) may communicate with (e.g., transmit one or more signals to, or receive one or more signals from) one or more wireless communication networks, such as an NR network, an LTE network, or a GSM network, among other examples. The WWAN transceiver(s) may be connected to one or more of the antenna(s) 1225 for communicating with other devices, such as one or more UEs 115, network nodes 105, access points, base stations (e.g., eNBs, gNBs), or another device(s), via at least one RAT (e.g., NR, LTE, or GSM, among other examples) over a wireless communication medium (e.g., time or frequency resources of a frequency spectrum). The WWAN transceiver(s) may be configured for transmitting and encoding signals (e.g., messages, indications, or information, among other examples) or for receiving and decoding signals (e.g., messages, indications, information, or pilots, among other examples), in accordance with the RAT. For instance, the WWAN transceiver(s) may include one or more transmitters for transmitting and encoding signals, or one or more receivers for receiving and decoding signals.

The short-range wireless transceivers may be connected to one or more of the antenna(s) 1225 to communicate with (e.g., transmit one or more signals to, or receive one or more signals from) one or more network entities, such as one or more UEs 115, network nodes 105, access points, base stations, or another device(s), via at least one RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), or ultra-wideband (UWB), among other examples) over a wireless communication medium. The short-range wireless transceiver(s) may be configured for transmitting and encoding signals (e.g., messages, indications, or information, among other examples), or for receiving and decoding signals (e.g., messages, indications, information, or pilots, among other examples), in accordance with the RAT. For instance, the short-range wireless transceiver(s) may include one or more transmitters for transmitting and encoding signals, or one or more receivers for receiving and decoding signals. In some examples, the short-range wireless transceiver(s) may be one or more Wi-Fi transceivers, BLUETOOTH® transceivers, ZIGBEE® transceivers, Z-WAVE® transceivers, NFC transceivers, UWB transceivers, vehicle-to-vehicle (V2V) transceivers, or vehicle-to-everything (V2X) transceivers, among other examples.

The satellite transceiver(s) may include one or more satellite signal receivers, or one or more satellite signal transmitters. In some cases, the device 1205 may be a terrestrial device that may communicate one or more satellites via the satellite transceiver(s). In other cases, device 1205 may be a satellite (or other non-terrestrial entity) that uses the satellite transceiver(s) to communicate with one or more terrestrial networks or other satellites.

The satellite signal receiver(s) may be connected to one or more of the antenna(s) 1225 for receiving or measuring satellite positioning or communication signals. In some examples, the satellite signal receiver(s) may include one or more satellite positioning system receivers, where the satellite positioning or communication signals may be GPS signals, GLONASS signals, Galileo signals, BeiDou signals, Indian Regional Navigation Satellite System (NAVIC), or Quasi-Zenith Satellite System (QZSS) signals, among other examples. In some examples, the satellite signal receiver(s) may include one or more NTN receivers, where the satellite positioning or communication signals may be communication signals (e.g., carrying control or user data) originating from a device or network. The satellite signal receiver(s) may include hardware or a combination of hardware and instructions for receiving and processing satellite positioning or communication signals. The satellite signal receiver(s) or the processor 1240 may perform calculations to determine a location of the device 1205, the UE 115, the network node 105, or another device using measurements obtained from one or more satellite signals.

The one or more satellite signal transmitters may be connected to one or more of the antennas 1225 for transmitting satellite positioning communication signals. In some examples, the satellite signal transmitter(s) may be satellite positioning system transmitters, and the satellite positioning or communication signals may be GPS signals, GLONASS® signals, Galileo signals, BeiDou signals, NAVIC, or QZSS signals, among other examples. In some examples, the satellite signal transmitter(s) include one or more NTN transmitters, and the satellite positioning or communication signals may be communication signals (e.g., carrying control or user data). The satellite signal transmitter(s) may comprise hardware or a combination of hardware and instructions for transmitting satellite positioning or communication signals.

The device 1205 may include one or more sensors 1250 coupled with the one or more processors 1240 for obtaining sensor data (e.g., image data, RF data, motion data, orientation data, or audio data, among other examples). For example, the one or more sensors 1250 may sense or detect movement or orientation information. In some aspects, the movement or orientation information may be independent from motion data derived from signals received by the one or more WWAN transceivers, the one or more short-range wireless transceivers, or the satellite signal interface. In some examples, the sensor(s) 1250 may include an accelerometer (e.g., a micro-electrical mechanical systems (MEMS) device), a gyroscope, a geomagnetic sensor (e.g., a compass), an altimeter (e.g., a barometric pressure altimeter), or any other type of movement detection sensor. Additionally, or alternatively, the one or more sensors 1250 may include an image sensor, camera, microphone, light detector, or pressure sensor, among other examples. In some aspects, the sensor(s) 1250 may include a plurality of different types of devices, and the device 1205 (e.g., sensor(s) or 1250 processor(s) 1240) may combine the outputs of the different types of devices to provide motion information. For example, the sensor(s) 1250 may use a combination of a multi-axis accelerometer sensors, orientation sensors, or image sensors to provide the ability to compute positions in two-dimensional (2D) or three-dimensional (3D) coordinate systems.

The at least one memory 1230 may include RAM and ROM. The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a BIOS which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting data procedures associated with access stratum states or use cases). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

For example, the communications manager 1220 is capable of, configured to, or operable to support a means for transmitting, to one or more network entities based at least in part on one or more use cases, capability information indicating a capability of the wireless device to participate in a data collection procedure, where the capability information indicates one or more parameters for the data collection procedure, and where the data collection procedure is associated with data for the one or more use cases. The communications manager 1220 is capable of, configured to, or operable to support a means for receiving, from the one or more network entities based at least in part on the one or more use cases, configuration information that indicates that the wireless device is configured for the data collection procedure.

By including or configuring the communications manager 1220 in accordance with examples as described herein, the device 1205 may support techniques for enhanced positioning accuracy, improved communication reliability, reduced latency, reduced power consumption, more efficient utilization of communication resources, improved coordination between devices, longer battery life, or improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of data procedures associated with access stratum states or use cases as described herein, or the at least one processor 1240 and the at least one memory 1230 may be otherwise configured to, individually or collectively, perform or support such operations.

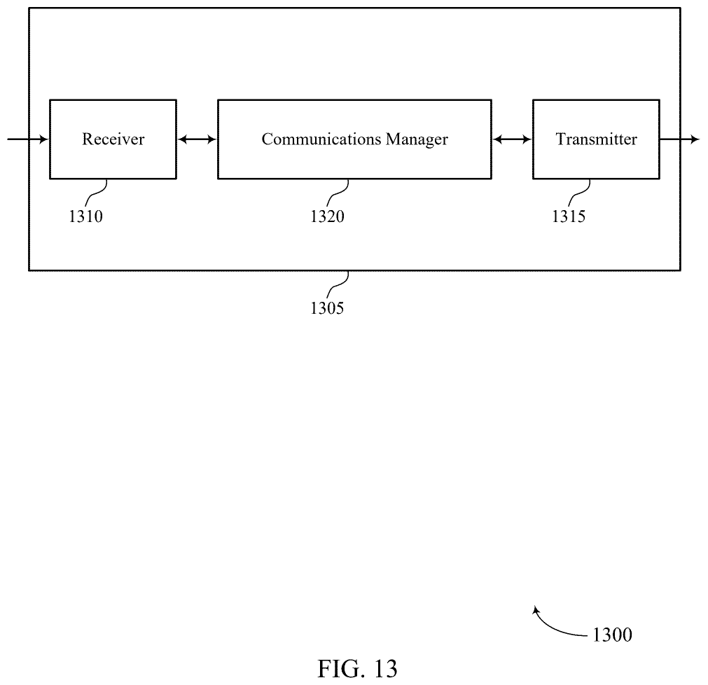

FIG. 13 shows a block diagram 1300 of a device 1305 that supports data procedures associated with access stratum states or use cases in accordance with one or more aspects of the present disclosure. The device 1305 may be an example of aspects of a network entity 405 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include one or more processors, memory coupled with the one or more processors, and instructions stored in the memory that are executable by the one or more processors to enable the one or more processors to perform the data procedures associated with access stratum states or use cases features discussed herein. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of data procedures associated with access stratum states or use cases as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

For example, the communications manager 1320 is capable of, configured to, or operable to support a means for obtaining, from a wireless device based on one or more use cases, capability information indicating a capability of the wireless device to participate in a data collection procedure (e.g., training data collection, measurement collection, or other data collection procedure), where the capability information indicates one or more parameters for the data collection procedure, and where the data collection procedure is associated with data for training an AI/ML model for the one or more use cases. The communications manager 1320 is capable of, configured to, or operable to support a means for outputting, to the wireless device based on the one or more use cases, configuration information indicating that the wireless device is configured for the data collection procedure.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for reduced processing, reduced power consumption, or more efficient utilization of communication resources.

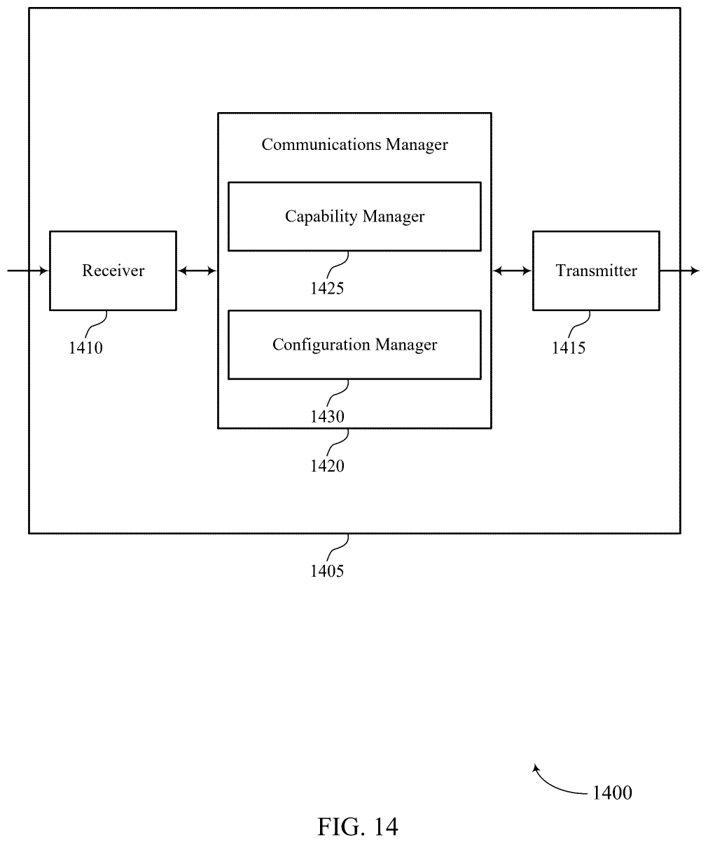

FIG. 14 shows a block diagram 1400 of a device 1405 that supports data procedures associated with access stratum states or use cases in accordance with one or more aspects of the present disclosure. The device 1405 may be an example of aspects of a device 1305 or a network entity 405 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of data procedures associated with access stratum states or use cases as described herein. For example, the communications manager 1420 may include a capability manager 1425 a configuration manager 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The capability manager 1425 is capable of, configured to, or operable to support a means for obtaining, from a wireless device based on one or more use cases, capability information indicating a capability of the wireless device to participate in a data collection procedure (e.g., training data collection, measurement collection, or other data collection procedure), where the capability information indicates one or more parameters for the data collection procedure, and where the data collection procedure is associated with data for training an AI/ML model for the one or more use cases. The configuration manager 1430 is capable of, configured to, or operable to support a means for outputting, to the wireless device based on the one or more use cases, configuration information indicating that the wireless device is configured for the data collection procedure.

In some cases, the capability manager 1425 or the configuration manager 1430 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the capability manager 1425 or the configuration manager 1430 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

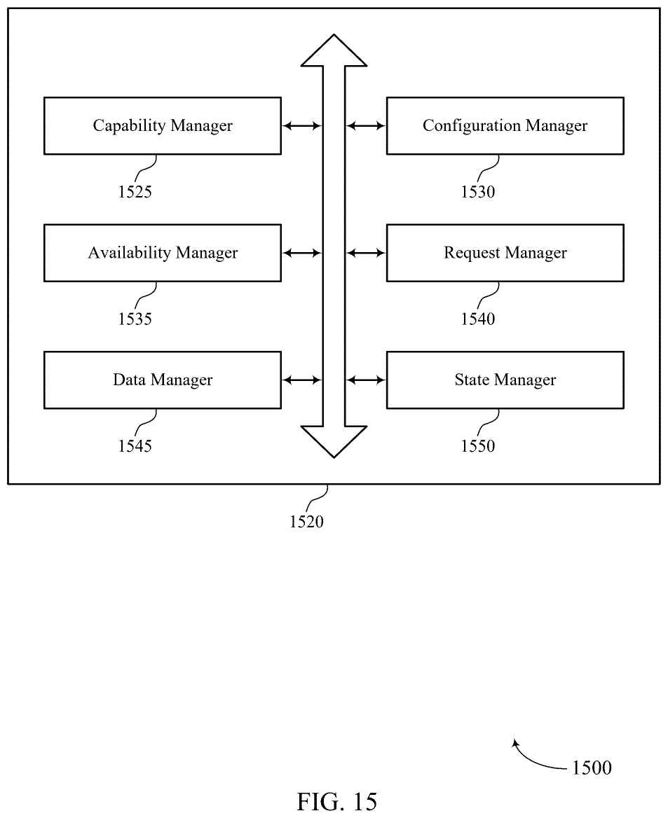

FIG. 15 shows a block diagram 1500 of a communications manager 1520 that supports data procedures associated with access stratum states or use cases in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of data procedures associated with access stratum states or use cases as described herein. For example, the communications manager 1520 may include a capability manager 1525, a configuration manager 1530, an availability manager 1535, a request manager 1540, a data manager 1545, a state manager 1550, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 405, between devices, components, or virtualized components associated with a network entity 405), or any combination thereof.

The capability manager 1525 is capable of, configured to, or operable to support a means for obtaining, from a wireless device based on one or more use cases, capability information indicating a capability of the wireless device to participate in a data collection procedure, where the capability information indicates one or more parameters for the data collection procedure (e.g., training data collection, measurement collection, or other data collection procedure), and where the data collection procedure is associated with data for training an AI/ML model for the one or more use cases. The configuration manager 1530 is capable of, configured to, or operable to support a means for outputting, to the wireless device based on the one or more use cases, configuration information indicating that the wireless device is configured for the data collection procedure.

In some examples, the capability information indicates at least one of the one or more use cases corresponding to the capability of the wireless device to participate in the data collection procedure.

In some examples, the one or more use cases include an AI/ML-based CSI feedback use case, an AI/ML-based beam management use case, an AI/ML-based mobility use case, an AI/ML-based positioning use case, an AI/ML-based cell reselection use case, an AI/ML-based RACH procedure, or a use case for AI/ML-based power management, a non-AI/ML-based CSI feedback use case, a non-AI/ML-based beam management use case, a non-AI/ML-based mobility use case, a non-AI/ML-based positioning use case, a non-AI/ML-based cell reselection use case, a non-AI/ML-based RACH procedure, a use case for non-AI/ML-based power management, or a sensing use case.

In some examples, the one or more parameters indicated by the capability information include a quantity of samples of at least a portion of the data, a size of at least a portion of the data, or an age of at least a portion of the data, a quality of the data collected (e.g., in at least one of the one or more access stratum states or of the one or more use cases), or any combination thereof.

In some examples, the one or more access stratum states include a connected state, an inactive state, or an idle state. In some examples, the configuration information indicates that the wireless device is configured to participate in the data collection procedure in at least one of the connected state, the inactive state, the idle state, or any combination thereof.

In some examples, the availability manager 1535 is capable of, configured to, or operable to support a means for obtaining, from the wireless device based on the one or more use cases, an indication of availability of the data.

In some examples, the indication of availability indicates at least one of the one or more use cases associated with the data.

In some examples, the indication of availability indicates a quantity of samples of the data, a size of the data, an age of the data corresponding to at least one of the one or more use cases, or a quality of the data collected (e.g., in at least one of the one or more access stratum states or of the one or more use cases).

In some examples, the request manager 1540 is capable of, configured to, or operable to support a means for outputting, to the wireless device, a request for at least a portion of the data.

In some examples, the request indicates a condition to select the at least a portion of the data. In some examples, the at least a portion of the data is selected based on the condition.

In some examples, the condition includes a quantity of samples of the at least a portion of the data, a size of the at least a portion of the data, an age of the at least a portion of the data, a use case of the at least a portion of the data, a quality of the at least a portion of the data collected (e.g., in at least one of the one or more access stratum states or of the one or more use cases), or any combination thereof.

In some examples, the data manager 1545 is capable of, configured to, or operable to support a means for obtaining, from the wireless device, at least a portion of the data.

In some examples, the state manager 1550 is capable of, configured to, or operable to support a means for obtaining, from the wireless device, an indication of an access stratum state associated with the at least a portion of the data, an indication of a configuration identifier associated with the at least a portion of the data, or an indication of a level of a configuration associated with the at least a portion of the data.

In some examples, obtaining the at least a portion of the data includes obtaining all of the data from the wireless device, obtaining the at least a portion of the data based on at least one use case, or obtaining the at least a portion of the data based on a requested size or quantity of samples.

In some examples, the configuration information indicates at least one use case and at least one access stratum state for performing one or more measurements associated with data collection, for performing data logging, for performing data reporting, or any combination thereof.

In some examples, the configuration information indicates a first level of the data collection procedure and a second level of the data collection procedure for at least one use case or for at least one access stratum state. In some examples, the second level of the data collection procedure utilizes fewer resources than the first level.

In some examples, the second level of the data collection procedure is associated with an operating condition of the wireless device.

In some examples, the wireless device is a UE. In some examples, the network entity includes a network node, a network function, an AMF, a LMF, SnMF, or a server.

In some cases, the capability manager 1525, configuration manager 1530, availability manager 1535, request manager 1540, data manager 1545, or state manager 1550 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the capability manager 1525, configuration manager 1530, availability manager 1535, request manager 1540, data manager 1545, or state manager 1550 discussed herein.

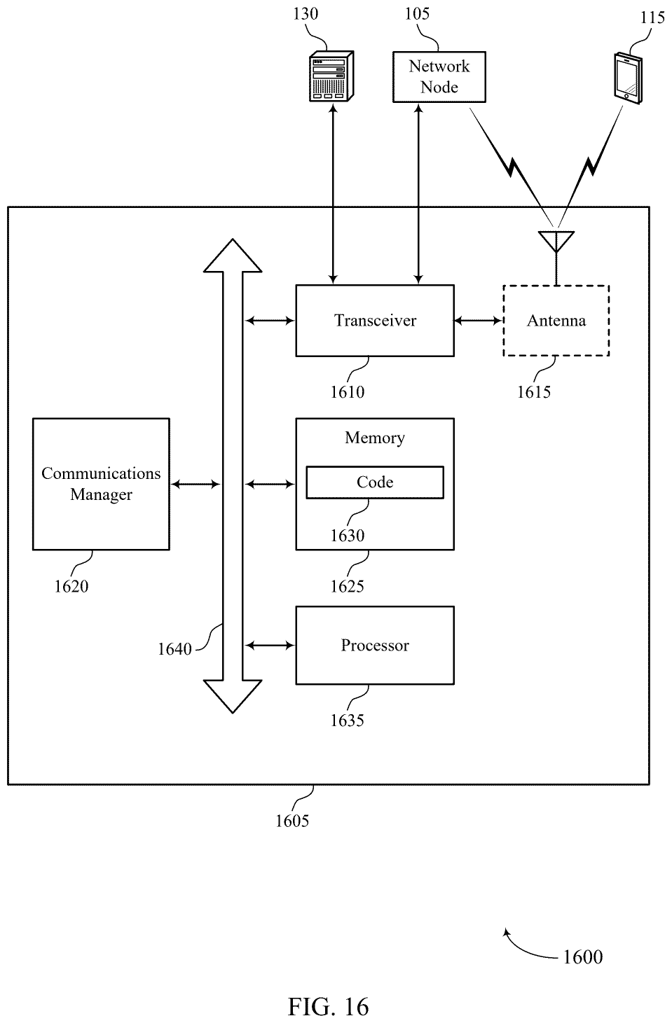

FIG. 16 shows a diagram of a system 1600 including a device 1605 that supports data procedures associated with access stratum states or use cases in accordance with one or more aspects of the present disclosure. The device 1605 may be an example of or include components of a device 1305, a device 1405, or a network entity 405 as described herein. The device 1605 may include components for bi-directional voice and data communications including components for transmitting and receiving communications, such as a communications manager 1620, one or more transceivers 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The one or more transceivers 1610 may include one or more WWAN transceivers, one or more short-range wireless transceivers, or one or more satellite transceivers. The WWAN transceiver(s) may communicate with (e.g., transmit one or more signals to, or receive one or more signals from) one or more wireless devices, such as the network node 105 or the UE 115, among other examples. The WWAN transceiver(s) may be connected to one or more of the antenna(s) 1615 for communicating with other devices, such as one or more UEs 115, network nodes 105, access points, base stations (e.g., eNBs, gNBs), or another device(s), via at least one RAT (e.g., NR, LTE, or GSM, among other examples) over a wireless communication medium (e.g., time or frequency resources of a frequency spectrum). The WWAN transceiver(s) may be configured for transmitting and encoding signals (e.g., messages, indications, or information, among other examples) or for receiving and decoding signals (e.g., messages, indications, information, or pilots, among other examples), in accordance with the RAT. For instance, the WWAN transceiver(s) may include one or more transmitters for transmitting and encoding signals, or one or more receivers for receiving and decoding signals.

The short-range wireless transceivers may be connected to one or more of the antenna(s) 1615 to communicate with (e.g., transmit one or more signals to, or receive one or more signals from) one or more network entities, such as one or more UEs 115, network nodes 105, access points, base stations, or another device(s), via at least one RAT (e.g., Wi-Fi, LTE Direct, BLUETOOTH®, ZIGBEE®, Z-WAVE®, PC5, DSRC, WAVE, NFC, or UWB, among other examples) over a wireless communication medium. The short-range wireless transceiver(s) may be configured for transmitting and encoding signals (e.g., messages, indications, or information, among other examples), or for receiving and decoding signals (e.g., messages, indications, information, or pilots, among other examples), in accordance with the RAT. For instance, the short-range wireless transceiver(s) may include one or more transmitters for transmitting and encoding signals, or one or more receivers for receiving and decoding signals. In some examples, the short-range wireless transceiver(s) may be one or more Wi-Fi transceivers, BLUETOOTH® transceivers, ZIGBEE® transceivers, Z-WAVE® transceivers, NFC transceivers, UWB transceivers, V2V transceivers, or V2X transceivers, among other examples.

The satellite transceiver(s) may include one or more satellite signal receivers, or one or more satellite signal transmitters. In some cases, the device 1605 may be a terrestrial device that may communicate one or more satellites via the satellite transceiver(s). In other cases, device 1605 may be a satellite (or other non-terrestrial entity) that uses the satellite transceiver(s) to communicate with one or more terrestrial networks or other satellites.

The satellite signal receiver(s) may be connected to one or more of the antenna(s) 1615 for receiving or measuring satellite positioning or communication signals. In some examples, the satellite signal receiver(s) may include one or more satellite positioning system receivers, where the satellite positioning or communication signals may be GPS signals, GLONASS signals, Galileo signals, BeiDou signals, NAVIC, or QZSS signals, among other examples. In some examples, the satellite signal receiver(s) may include one or more NTN receivers, where the satellite positioning or communication signals may be communication signals (e.g., carrying control or user data) originating from a device or network. The satellite signal receiver(s) may include hardware or a combination of hardware and instructions for receiving and processing satellite positioning or communication signals. The satellite signal receiver(s) or the processor 1635 may perform calculations to determine a location of the device 1605, the UE 115, the network node 105, or another device using measurements obtained from one or more satellite signals.

The one or more satellite signal transmitters may be connected to one or more of the antennas 1615 for transmitting satellite positioning communication signals. In some examples, the satellite signal transmitter(s) may be satellite positioning system transmitters, and the satellite positioning or communication signals may be GPS signals, GLONASS® signals, Galileo signals, BeiDou signals, NAVIC, or QZSS signals, among other examples. In some examples, the satellite signal transmitter(s) include one or more NTN transmitters, and the satellite positioning or communication signals may be communication signals (e.g., carrying control or user data). The satellite signal transmitter(s) may comprise hardware or a combination of hardware and instructions for transmitting satellite positioning or communication signals.

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting data procedures associated with access stratum states or use cases). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625).

In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network nodes 105, and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network nodes 105.

For example, the communications manager 1620 is capable of, configured to, or operable to support a means for receiving, from a wireless device based at least in part on one or more use cases, capability information indicating a capability of the wireless device to participate in a data collection procedure, where the capability information indicates one or more parameters for the data collection procedure, and where the data collection procedure is associated with data for the one or more use cases. The communications manager 1620 is capable of, configured to, or operable to support a means for transmitting, to the wireless device based at least in part on the one or more use cases, configuration information that indicates that the wireless device is configured for the data collection procedure.

By including or configuring the communications manager 1620 in accordance with examples as described herein, the device 1605 may support techniques for increased positioning accuracy, improved communication reliability, reduced latency, improved user experience related to reduced processing, reduced power consumption, more efficient utilization of communication resources, improved coordination between devices, longer battery life, improved utilization of processing capability.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of data procedures associated with access stratum states or use cases as described herein, or the at least one processor 1635 and the at least one memory 1625 may be otherwise configured to, individually or collectively, perform or support such operations.

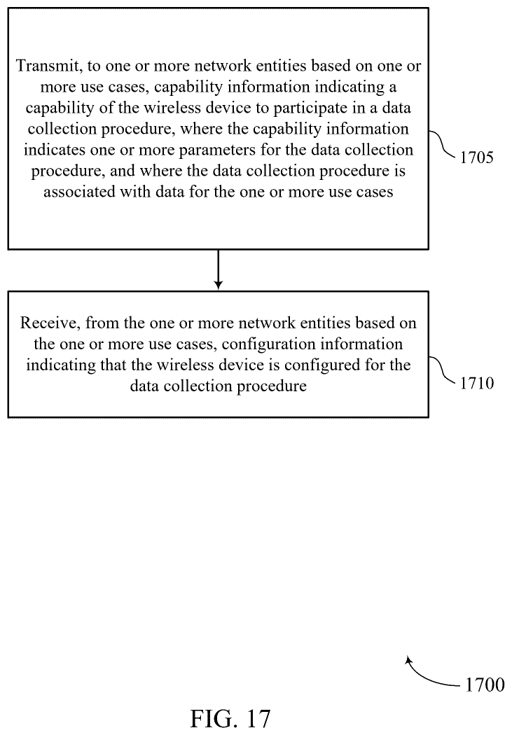

FIG. 17 shows a flowchart illustrating a method 1700 that supports data procedures associated with access stratum states or use cases in accordance with one or more aspects of the present disclosure. The operations of the method 1700 may be implemented by a wireless device or its components as described herein. For example, the operations of the method 1700 may be performed by a wireless device as described with reference to FIGS. 1 through 12. In some examples, a wireless device may execute a set of instructions to control the functional elements of the wireless device to perform the described functions. Additionally, or alternatively, the wireless device may perform aspects of the described functions using special-purpose hardware.

At 1705, the method may include outputting, to one or more network entities based on one or more use cases, capability information indicating a capability of the wireless device to participate in a data collection procedure (e.g., training data collection, measurement collection, or other data collection procedure), where the capability information indicates one or more parameters for the data collection procedure, and where the data collection procedure is associated with data for training an AI/ML model for the one or more use cases. The operations of 1705 may be performed in accordance with examples as disclosed herein. In some examples, aspects of the operations of 1705 may be performed by a capability component 1125 as described with reference to FIG. 11.

At 1710, the method may include obtaining, from the one or more network entities based on the one or more use cases, configuration information indicating that the wireless device is configured for the data collection procedure. The operations of 1710 may be performed in accordance with examples as disclosed herein. In some examples, aspects of the operations of 1710 may be performed by a configuration component 1130 as described with reference to FIG. 11.

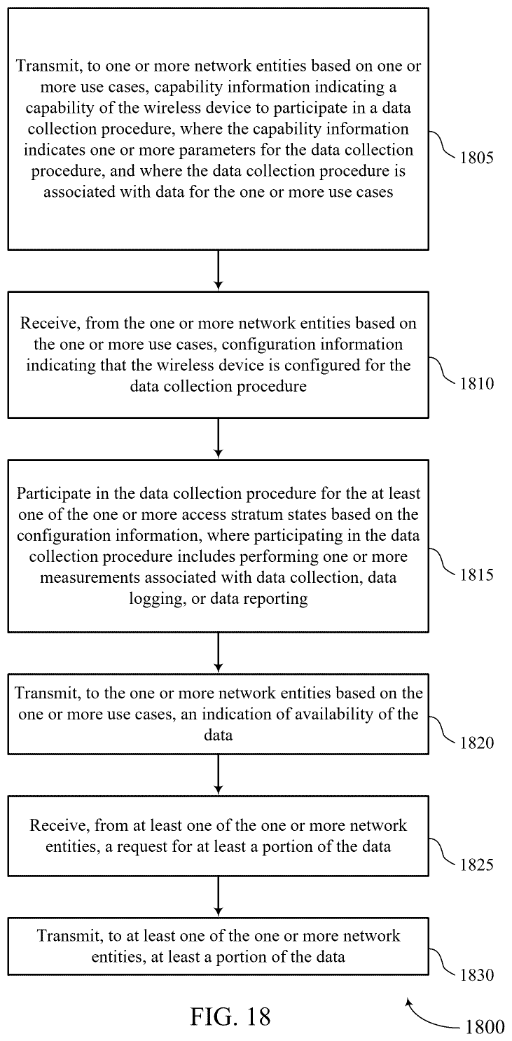

FIG. 18 shows a flowchart illustrating a method 1800 that supports data procedures associated with access stratum states or use cases in accordance with one or more aspects of the present disclosure. The operations of the method 1800 may be implemented by a wireless device or its components as described herein. For example, the operations of the method 1800 may be performed by a wireless device as described with reference to FIGS. 1 through 12. In some examples, a wireless device may execute a set of instructions to control the functional elements of the wireless device to perform the described functions. Additionally, or alternatively, the wireless device may perform aspects of the described functions using special-purpose hardware.

At 1805, the method may include outputting, to one or more network entities based on one or more use cases, capability information indicating a capability of the wireless device to participate in a data collection procedure, where the capability information indicates one or more parameters for the data collection procedure, and where the data collection procedure is associated with data for training an AI/ML model for the one or more use cases. The operations of 1805 may be performed in accordance with examples as disclosed herein. In some examples, aspects of the operations of 1805 may be performed by a capability component 1125 as described with reference to FIG. 11.

At 1810, the method may include obtaining, from the one or more network entities based on the one or more use cases, configuration information indicating that the wireless device is configured for the data collection procedure. The operations of 1810 may be performed in accordance with examples as disclosed herein. In some examples, aspects of the operations of 1810 may be performed by a configuration component 1130 as described with reference to FIG. 11.

At 1815, the method may include participating in the data collection procedure for the at least one of the one or more access stratum states based on the configuration information, where participating in the data collection procedure includes performing one or more measurements associated with data collection, data logging, data reporting, or any combination thereof. The operations of 1815 may be performed in accordance with examples as disclosed herein. In some examples, aspects of the operations of 1815 may be performed by a collection component 1135 as described with reference to FIG. 11.

At 1820, the method may include outputting, to the one or more network entities based on the one or more use cases, an indication of availability of the data. The operations of 1820 may be performed in accordance with examples as disclosed herein. In some examples, aspects of the operations of 1820 may be performed by an availability component 1140 as described with reference to FIG. 11.

At 1825, the method may include obtaining, from at least one of the one or more network entities, a request for at least a portion of the data. The operations of 1825 may be performed in accordance with examples as disclosed herein. In some examples, aspects of the operations of 1825 may be performed by a request component 1145 as described with reference to FIG. 11.

At 1830, the method may include outputting, to at least one of the one or more network entities, at least a portion of the data. The operations of 1830 may be performed in accordance with examples as disclosed herein. In some examples, aspects of the operations of 1830 may be performed by a data component 1150 as described with reference to FIG. 11.

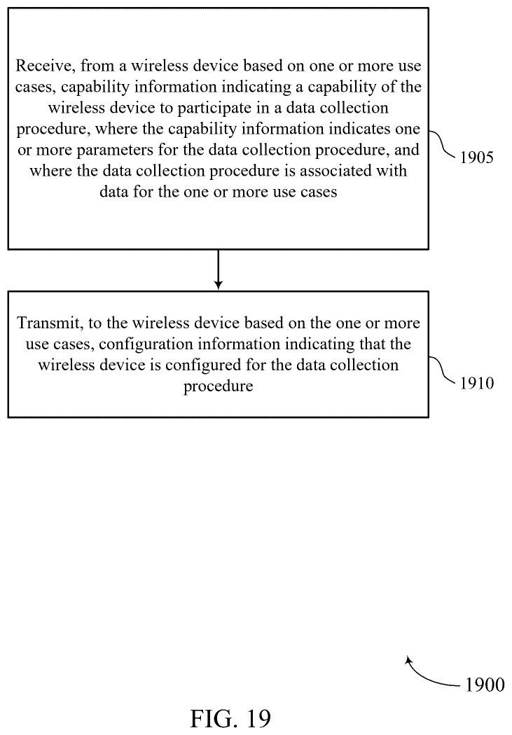

FIG. 19 shows a flowchart illustrating a method 1900 that supports data procedures associated with access stratum states or use cases in accordance with one or more aspects of the present disclosure. The operations of the method 1900 may be implemented by a network entity or its components as described herein. For example, the operations of the method 1900 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1905, the method may include obtaining, from a wireless device based on one or more use cases, capability information indicating a capability of the wireless device to participate in a data collection procedure, where the capability information indicates one or more parameters for the data collection procedure, and where the data collection procedure is associated with data for training an AI/ML model for the one or more use cases. The operations of 1905 may be performed in accordance with examples as disclosed herein. In some examples, aspects of the operations of 1905 may be performed by a capability manager 1525 as described with reference to FIG. 15.

At 1910, the method may include outputting, to the wireless device based on the one or more use cases, configuration information indicating that the wireless device is configured for the data collection procedure. The operations of 1910 may be performed in accordance with examples as disclosed herein. In some examples, aspects of the operations of 1910 may be performed by a configuration manager 1530 as described with reference to FIG. 15.

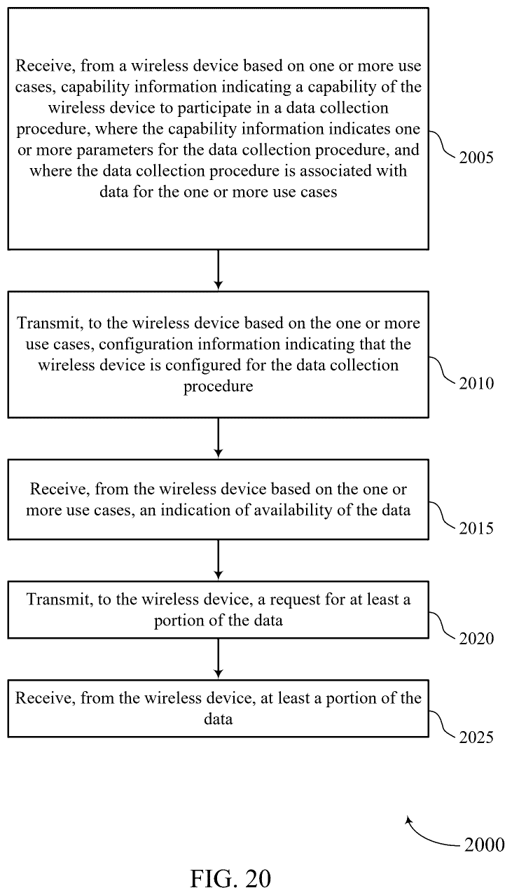

FIG. 20 shows a flowchart illustrating a method 2000 that supports data procedures associated with access stratum states or use cases in accordance with one or more aspects of the present disclosure. The operations of the method 2000 may be implemented by a network entity or its components as described herein. For example, the operations of the method 2000 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2005, the method may include obtaining, from a wireless device based on one or more use cases, capability information indicating a capability of the wireless device to participate in a data collection procedure, where the capability information indicates one or more parameters for the data collection procedure, and where the data collection procedure is associated with data for training an AI/ML model for the one or more use cases. The operations of 2005 may be performed in accordance with examples as disclosed herein. In some examples, aspects of the operations of 2005 may be performed by a capability manager 1525 as described with reference to FIG. 15.

At 2010, the method may include outputting, to the wireless device based on the one or more use cases, configuration information indicating that the wireless device is configured for the data collection procedure. The operations of 2010 may be performed in accordance with examples as disclosed herein. In some examples, aspects of the operations of 2010 may be performed by a configuration manager 1530 as described with reference to FIG. 15.

At 2015, the method may include obtaining, from the wireless device based on the one or more use cases, an indication of availability of the data. The operations of 2015 may be performed in accordance with examples as disclosed herein. In some examples, aspects of the operations of 2015 may be performed by an availability manager 1535 as described with reference to FIG. 15.

At 2020, the method may include outputting, to the wireless device, a request for at least a portion of the data. The operations of 2020 may be performed in accordance with examples as disclosed herein. In some examples, aspects of the operations of 2020 may be performed by a request manager 1540 as described with reference to FIG. 15.

At 2025, the method may include obtaining, from the wireless device, at least a portion of the data. The operations of 2025 may be performed in accordance with examples as disclosed herein. In some examples, aspects of the operations of 2025 may be performed by a data manager 1545 as described with reference to FIG. 15.

FIG. 21 shows examples of wireless communications systems 2100 that support data procedures associated with access stratum states or use cases in accordance with one or more aspects of the present disclosure. Various positioning techniques are illustrated in the context of the wireless communications systems 2100. Some examples of the positioning procedures described herein may be performed in accordance with one or more aspects of the positioning techniques. While TRPs and UEs are provided in the examples illustrated in FIG. 21, other devices (e.g., network entities, base stations, RRHs, RUs, APs, wireless devices, or stations, among other examples) may be similarly utilized in other examples. The examples of positioning techniques include downlink-based positioning techniques, uplink-based positioning techniques, and downlink-and-uplink-based positioning techniques.

Examples of OTDOA or DL-TDOA 2105 are illustrated in FIG. 21. One or more of the OTDOA or DL-TDOA 2105 positioning techniques may be included in a downlink-based positioning procedure. In OTDOA or DL-TDOA 2105 positioning techniques, a UE may measure a difference between TOAs of reference signals (e.g., PRSs) received from one or more pairs of TRPs (e.g., TRP2 and TRP3). In some approaches, a difference in TOAs may be referred to as an RSTD or a TDOA measurement. A positioning device (e.g., the UE, a location or sensing server, an LMF, SnMF, an SLP, or another device) may utilize the differences in TOAs to determine (e.g., estimate) a location of the UE.

In some aspects, the UE may receive an identifier (ID) associated with a reference TRP (e.g., a serving base station) and one or more IDs associated with one or more non-reference TRPs in received data (e.g., assistance data). The UE may measure the difference of TOAs between the reference TRP and each of the non-reference TRPs to produce RSTDs or TDOAs. In some aspects, the UE may report an indication of the RSTDs or TDOAs to the positioning device (e.g., a location or sensing server, LMF, SnMF, an SLP, or another device). Based on established locations of the base stations and the RSTD measurements, the positioning device (e.g., the UE for UE-based positioning or a location or sensing server for UE-assisted positioning) may estimate the UE's location.

An example of UL-TDOA 2110 is illustrated in FIG. 21. One or more of the UL-TDOA 2110 positioning techniques may be included in an uplink-based positioning procedure. UL-TDOA 2110 may have some similarities to DL-TDOA 2105. The UL-TDOA 2110 positioning techniques may be based on uplink reference signals (e.g., SRS) transmitted from the UE to multiple TRPs. For example, the UE transmits one or more uplink reference signals that are measured by a reference TRP (e.g., TRP3) and non-reference TRPs (e.g., TRP1 and TRP2). Each TRP then reports the reception time (which may be referred to as a relative time of arrival (RTOA)) of the reference signal(s) to a positioning device (e.g., a location or sensing server, LMF, SnMF, SLP, or UE) that has information about the locations and relative timing of the TRPs. Based on the reception-to-reception (Rx-Rx) time differences between the reported RTOA of the reference TRP and the reported RTOA of each non-reference TRP, the locations of the TRPs, and the corresponding timing offsets, the positioning device may estimate the location of the UE using TDOA.

An example of DL-AOD 2115 is illustrated in FIG. 21. One or more of the DL-AOD 2115 positioning techniques may be included in a downlink-based positioning procedure. In DL-AOD 2115, a UE may obtain received signal strength measurements corresponding to multiple downlink transmit beams for one or more TRPs (e.g., TRP1 and TRP2). In some approaches, the UE reports the measurements to a positioning device. The positioning device may use the signal strength measurements of the multiple downlink transmit beams to determine the angle(s) (e.g., AOD1 and AOD2) between the UE and the transmitting TRP(s). The positioning device (e.g., location or sensing server, LMF, SnMF, SLP, UE, or another device) may estimate the location of the UE based on the determined angle(s) and the established location(s) of the transmitting TRP(s).

An example of UL-AOA 2120 is illustrated in FIG. 21. One or more of the UL-AOA 2120 positioning techniques may be included in an uplink positioning procedure. In UL-AOA 2120, one or more TRPs (e.g., TRP1 and TRP2) measure the received signal strength of one or more uplink reference signals (e.g., SRSs) received from a UE on one or more uplink receive beams. In some aspects, the signal strength measurements may be reported to a positioning device. A positioning device (e.g., LFM, SLP, UE, or another device) may use the signal strength measurements and the angle(s) of the receive beam(s) to determine the angle(s) between the UE and the TRP(s). Based on the determined angle(s) and the established location(s) of the TRP(s), the positioning device may estimate the location of the UE.

Some positioning techniques or procedures may include a combination downlink-based and uplink-based positioning techniques. Examples of downlink-based and uplink-based positioning techniques may include E-CID positioning and multi-round-trip-time (RTT) positioning (which may be referred to as “multi-RTT” or “multi-cell RTT”when multiple cells are utilized).

In multi-RTT, a first device (e.g., a TRP or UE) may transmit a first RTT-related signal (e.g., a PRS or SRS) to a second device (e.g., the UE or TRP). The second device may transmit a second RTT-related signal (e.g., an SRS or PRS) back to the first device. Each device may measure a time difference between the TOA of the received RTT-related signal and the transmission time of the transmitted RTT-related signal. The time difference may be referred to as a reception-to-transmission (Rx-Tx) time difference. In some aspects, the Rx-Tx time difference measurement may be obtained or adjusted to include (e.g., include only) a time difference between nearest slot boundaries for the received and transmitted signals. The first device or the second device may send the corresponding Rx-Tx time difference measurements to a positioning device (e.g., a location or sensing server, LMF, SnMF, SLP, UE, or other device), which may calculate a round trip propagation time (or RTT) between the two device based on the two Rx-Tx time difference measurements (e.g., as a sum of the two Rx-Tx time difference measurements). Additionally, or alternatively, one device may send a corresponding Rx-Tx time difference measurement to the other device, which may calculate the RTT. The distance between the two devices may be determined from the RTT and a signal speed (e.g., the speed of light).

An example of multi-cell RTT 2125 is illustrated in FIG. 21. One or more of the multi-RTT or multi-cell RTT techniques described may be included in an uplink-based or downlink-based positioning procedure. In multi-cell RTT 2125, a first device (e.g., a UE or TRP) may perform an RTT positioning procedure with multiple second devices (e.g., multiple TRPs or UEs) to enable the location of the first device to be determined (e.g., using multilateration) based on distances to, and the established locations of, the second devices.

In some examples, RTT or multi-RTT techniques may be combined with one or more other positioning techniques (e.g., UL-AOA, DL-AOD, or other positioning techniques), to enhance location accuracy. Examples of combined DL-AOD and RTT 2130 positioning techniques are illustrated in FIG. 21.

E-CID positioning techniques may be based on radio resource management (RRM) measurements. In E-CID, a UE may obtain or report a serving cell ID, a timing advance (TA), identifiers of one or more detected neighbor TRPs, estimated timing of one or more detected neighbor TRPs, or a signal strength measurement of one or more detected neighbor TRPs. A positioning device (e.g., an LFM, SLP, UE, or another device) may utilize the serving cell ID, TA, identifiers, estimated timing, or signal strength measurements with one or more established locations of one or more TRPs to estimate the location of the UE.

In some approaches, a positioning device (e.g., location or sensing server, LMF, SnMF, SLP, or another device) may provide assistance data to the UE. Assistance data is data to assist with one or more positioning operations (e.g., to detect one or more neighboring TRPs or to receive reference signaling). For instance, the assistance data may indicate IDs of the TRPs (e.g., IDs of one or more cells or TRPs corresponding to a network node) from which reference signals may be measured. In some examples, a positioning device may transmit assistance data or other information indicating one or more reference signal configuration parameters. The reference signal configuration parameter(s) may include or indicate a quantity of consecutive slots including PRS, a periodicity of consecutive slots including PRS, a muting sequence, a frequency hopping sequence, a reference signal identifier, a reference signal bandwidth, or one or more other parameters applicable to a positioning technique or procedure. Additionally, or alternatively, the assistance data may be sent from one or more TRPs (e.g., in periodically broadcasted overhead messages, a scheduled message, a unicast message, or a multicast message, among other examples). In some examples, a UE may be able to detect one or more neighboring TRPs (e.g., network entities) without the use of assistance data.

For OTDOA positioning techniques or DL-TDOA positioning techniques, the assistance data may indicate an expected RSTD value and an associated uncertainty or search window around the expected RSTD. For example, an expected RSTD value may have an associated uncertainty or search window with a range of ±500 microseconds (μs). In another example, when any of the resources used for the positioning measurement(s) are in frequency range 1 (FR1), an expected RSTD value may have an associated uncertainty or search window with a range of ±32 μs. In another example, when all of the resources used for the positioning measurement(s) are in frequency range 2 (FR2), an expected RSTD value may have an associated uncertainty or search window with a range of ±8 μs.

In some examples, a location may be referred to as a position estimate, location estimate, position, position fix, or fix, among other examples. A location may be geodetic and include coordinates (e.g., latitude, longitude, or altitude) or may be civic and include a street address, postal address, or another description of a location. In some aspects, a location may be defined relative to another location or may be defined in absolute terms (e.g., latitude, longitude, or altitude). A location may include an indication of error or uncertainty (e.g., by including an area or volume within which the location may be included with a specified or default level of confidence).

Various examples of sidelink positioning techniques are illustrated in FIG. 21. Sidelink positioning techniques may include positioning techniques that are based on sidelink communication (e.g., based exclusively on sidelink communication or based on sidelink communication jointly with other communication(s), such as Uu interface communication).

A first example of sidelink positioning 2135 is illustrated in FIG. 21. In the first example of sidelink positioning 2135, at least one peer UE with an established location may improve location estimation (e.g., Uu-based positioning, multi-cell RTT, DL-TDOA, or UL-TDOA, among other examples) for a target UE by providing an additional anchor (e.g., sidelink RTT (SL-RTT)).

A second example of sidelink positioning 2140 is illustrated in FIG. 21. In the second example of sidelink positioning 2140, different types (e.g., categories, classes, or capabilities) of UEs may be utilized. For example, first UEs and a second UE may be utilized. Relative to the second UE, the first UEs may have one or more increased capabilities, such as one or more additional sensors, a faster processor, greater memory capacity, one or more additional antenna elements, a higher transmit power capability, access to one or more additional frequency bands, or any combination thereof. In some aspects, the second UE may be a reduced capacity or “RedCap”UE. The second UE may be assisted by the first UEs to determine the location of the second UE. For instance, sidelink-based positioning or ranging procedures may be performed with the first UEs, which may enhance the location accuracy of the second UE.

A third example of sidelink positioning 2145 is illustrated in FIG. 21. The third example of sidelink positioning 2145 may be performed via one or more sidelink connections (e.g., via sidelink connections exclusively or jointly with one or more Uu-based connections). In the third example of sidelink positioning 2145, the UEs may perform peer-to-peer (P2P) positioning or ranging. Sidelink positioning may be helpful for out-of-coverage or public safety scenarios. For instance, the UEs may be out of coverage of a network and may determine a location or a relative distance and a relative position among the UEs using sidelink positioning techniques. In some examples, sidelink positioning may be performed by UEs in public safety scenarios (e.g., for police, firefighters, search-and-rescue, or paramedics, among other examples).

A fourth example of sidelink positioning 2150 is illustrated in FIG. 21. The fourth example of sidelink positioning 2150 may be performed via one or more sidelink connections (e.g., via sidelink connections exclusively or jointly with one or more Uu-based connections). In the fourth example of sidelink positioning 2150, one or more of the UEs may determine a location or a relative distance and a relative position using sidelink positioning techniques, such as SL-RTT. For instance, one or more of the UEs may be out of coverage of a network and may determine a location or a relative distance and a relative position among the UEs using sidelink positioning techniques.

An example of relay positioning 2155 is illustrated in FIG. 21. In the example of relay positioning 2155, a relay UE (e.g., with an established location) may participate in the location estimation of a remote UE (without performing uplink reference signal transmission over the Uu interface, for instance). For example, the relay UE may receive a downlink PRS from a TRP and may relay an SL-PRS to the remote UE. In some cases, the remote UE may also receive another downlink PRS from the TRP. A positioning device (e.g., location or sensing server, LMF, SnMF, SLP, UE, or other device) may utilize a downlink PRS measurement and an SL-PRS measurement with the established location of the relay UE to estimate the location of the remote UE.

An example of joint positioning 2160 is illustrated in FIG. 21. In the example of joint positioning 2160, multiple peer UEs (without established locations, for instance) may be located. In some approaches, multiple peer UEs may be jointly located in NLOS conditions by utilizing one or more constraints from one or more peer (e.g., neighboring or nearby) UEs. As illustrated in FIG. 21, RTT or TDOA techniques may be performed between TRP1 and each of the peer UEs, may be performed between TRP2 and each of the peer UEs, and may be performed between the peer UEs. In some examples, one or more of the peer UEs may report measurements from the RTT or TDOA technique(s) to a positioning device. The positioning device (e.g., location or sensing server, LMF, SnMF, SLP, UE, or other device) may utilize the measurements from the RTT or TDOA technique(s) to estimate the locations of the peer UEs.

Some aspects of the techniques described herein may be performed in conjunction with one or more of the positioning techniques described with reference to FIG. 21. For instance, one or more samples of a reference signal (e.g., PRS, SRS, or other reference signal) may be measured or transmitted in accordance with one or more of the techniques described with reference to FIG. 4 for one or more of the positioning techniques. Some examples of the positioning techniques may be performed in one or more wireless communications systems 2100, such as LTE and NR, where NR may support sidelink communications.

FIG. 22 shows an example of a node diagram 2200 that supports data procedures associated with access stratum states or use cases in accordance with one or more aspects of the present disclosure. AI models are programmatic or algorithmic structures that simulate intelligent behavior. Machine learning models may be examples of AI models. Machine learning models are programmatic or algorithmic structures that may be trained to infer or predict an output based on an input. For example, a machine learning model may be trained using training input data and ground truth data.

Machine learning models may be categorized as unsupervised or supervised. Unsupervised learning may be utilized to draw inferences and find patterns from input data without references to labeled outcomes. Two examples of unsupervised learning models include clustering and dimensionality reduction. Clustering is an unsupervised technique that involves the grouping, or clustering, of data points. Clustering techniques may include k-means clustering, hierarchical clustering, mean shift clustering, and density-based clustering. Dimensionality reduction may be a procedure for reducing a quantity of random variables under consideration by obtaining a set of principal variables. Dimensionality reduction may reduce the dimension of a feature set or reduce a quantity of features). Some dimensionality reduction techniques may be categorized as feature elimination or feature extraction. One example of dimensionality reduction may be referred to as principal component analysis (PCA). PCA may involve projecting higher dimensional data (e.g., three dimensions) to a lower-dimensional space (e.g., two dimensions), which may result in a lower dimension of data (e.g., two dimensions instead of three dimensions) while maintaining one or more variables in the model.

Supervised learning involves learning a function that maps an input to an output based on associated inputs and outputs. For instance, supervised learning may be utilized to draw inferences and find patterns from input data based on labeled data (e.g., training input data with associated ground truth data). A supervised model may sub-categorized as a regression or classification model. Regression models may provide continuous outputs. One example of a regression model is a linear regression, which may determine a line that fits (e.g., best fits) input data. Extensions of linear regression include multiple linear regression (e.g., finding a plane of best fit) and polynomial regression (e.g., finding a curve of best fit).

In classification models, the output may be discrete. One example of a classification model is logistic regression. Logistic regression may be similar to linear regression, but may be used to model a probability for a finite quantity of outcomes. For example, a logistic regression may be utilized such that the output values may be between 0 and 1. Another example of a classification model is a support vector machine. For two classes of data, for example, a support vector machine may determine a hyperplane or a boundary between the two classes of data that maximizes a margin between the two classes. For instance, many planes may separate two classes, while one plane may maximize the margin or distance between the classes. Another example of a classification model is Naïve Bayes, which is based on Bayes Theorem.

Other examples of classification models include decision tree models, random forest models, and neural network models, where an output may be discrete. In a decision tree model, a tree structure is defined with multiple nodes. Decisions may be used to move from a root node at the top of the decision tree to a leaf node (e.g., a node without a child node) at the bottom of the decision tree. A higher quantity of nodes in the decision tree model may correlate with higher decision accuracy.

Random forest models may utilize ensemble learning techniques that build from decision tree models. Random forests involve creating multiple decision trees using bootstrapped datasets of the original data and randomly selecting a subset of variables at each tier of the decision tree. The model may select the mode of all of the predictions of each decision tree. By relying on a “majority wins” model, the risk of error from an individual tree may be reduced.

Another example of a machine learning model is a neural network (NN). A neural network may be a network of functional nodes. Neural networks may utilize one or more input variables to traverse the nodes and generate one or more output variables. For example, a neural network may utilize an input vector to generate an output vector.

The AI model illustrated in FIG. 22 is an example of a neural network. The neural network includes an input layer i that receives n (one or more) inputs (illustrated as “Input 1,” “Input 2,” and “Input n”), one or more hidden layers (illustrated as hidden layers “h1,” “h2,” and “h3”) for processing the inputs from the input layer, and an output layer o that provides m (one or more) outputs (labeled “Output 1” and “Output m”). While examples of quantities of inputs n, hidden layers h, and outputs m are illustrated in FIG. 22, same or different quantities of inputs, hidden layers, or outputs may be utilized in other examples. In some approaches, the hidden layers h may include linear function(s) or activation function(s) that the nodes (illustrated as circles) of each successive hidden layer process from the nodes of the previous hidden layer.

In some aspects, the AI model illustrated in FIG. 22 or another AI model may be trained in accordance with one or more training techniques. In some examples of the training techniques described herein, one or more AI models (e.g., implemented by one or more devices) may be trained based on training input data (e.g., measurements of reference signals to or from various UEs) and ground truth data (e.g., locations of the various UEs), thereby enabling later determination of an output (e.g., an inferred or prediction location or measurement) when an AI model is executed with runtime input data (e.g., from other UEs).

Ground truth data may be data representing a target output associated with training input data. Ground truth data may be generated or observed (e.g., empirical) data. In some examples, ground truth data may indicate one or more observed locations (e.g., coordinates or addresses, among other examples) corresponding to training input data. Examples of training input data may include reference signal data (e.g., measurements of a PRS, SRS, reference signal of an SSB, CSI-RS, DMRS, or TRS, among other examples), signal data (e.g., signal strength data, RSRP data, RSRPP data, RSSI data, RSRQ data, SINR data, or SNR data, among other examples), channel data (e.g., CIR data, PDP data, DP data, CQI data, CSI data, decoding failure rate, or retransmission request rate, among other examples), AOA data, AOD data, TDOA data, RTT data, TA data, sensor data (e.g., image data, RF data, motion data, orientation data, or audio data, among other examples), or identifier data (e.g., cell ID data or service set identifier (SSID) data, among other examples), among other examples.

In some examples, ground truth data may indicate one or more measurements or values (e.g., AOA measurements, AOD measurements, TDOA measurements, RTT measurements, line-of-sight (LOS) angle(s), or other values) corresponding to training input data. Examples of training input data may include reference signal data (e.g., measurements of a PRS, SRS, reference signal of an SSB, CSI-RS, DMRS, or TRS, among other examples), signal data (e.g., signal strength data, RSRP data, RSSI data, RSRQ data, SINR data, or SNR data, among other examples), channel data (e.g., CIR data, PDP data, DP data, CQI data, CSI data, decoding failure rate, or retransmission request rate, among other examples), TA data, sensor data (e.g., image data, RF data, motion data, orientation data, or audio data, among other examples), or identifier data (e.g., cell ID data or SSID data, among other examples), among other examples.

An AI model (e.g., the AI model illustrated in FIG. 22 or a machine learning model) may be trained by executing the AI model with the training data to produce an output, comparing the output with the ground truth data, and adjusting weights of the AI model to reduce a disparity between the output and the ground truth data. For example, one or more of the nodes or connections of the AI model may have an associated weight that may be adjusted to modify one or more of the outputs. In some approaches, a cost function may be utilized to compare the output with the ground truth data to indicate a cost (e.g., error or disparity). Adjustments to the weights that reduce the cost may be retained, advanced, or increased, while adjustments to the weights that increase the cost may be discarded, avoided, or decreased. Training procedures may be repeated or iterated to improve AI model performance.

Input data (e.g., runtime input data) may be provided to a trained AI model, which may infer or predict an output based on the input data. Some examples of AI models may be trained to infer or predict a location based on input data (e.g., reference signal data, signal data, channel data, AOA data, AOD data, TDOA data, RTT data, TA data, sensor data, or identifier data, among other examples). Some examples of AI models may be trained to infer or predict measurements or values (e.g., timing measurement(s), angle measurement(s), AOA measurement(s), AOD measurement(s), TDOA measurement(s), RTT measurement(s), LOS angle(s), or other values) based on input data.

Some examples of the techniques described herein may be performed in conjunction with one or more of the AI models described with reference to FIG. 22. For instance, an AI model may be trained based on training data as described with reference to FIG. 4.

FIG. 23A shows examples of block diagrams 2300-a that support data procedures associated with access stratum states or use cases in accordance with one or more aspects of the present disclosure. In some examples of the techniques described herein, a positioning device (e.g., location or sensing server, LMF, SnMF, SLP, UE, or other device) may utilize D-AI/ML positioning. In D-AI/ML positioning, one or more AI models 2310 (e.g., machine learning model(s) or D-AI/ML model(s)) may be trained to utilize input data 2305 to output (e.g., infer or predict) a location 2315 (e.g., a position estimate, coordinates, or an address of a UE). Examples of the input data 2305 may include reference signal data (e.g., measurements of a PRS, SRS, reference signal of an SSB, CSI-RS, DMRS, or TRS, among other examples), signal data (e.g., signal strength data, RSRP data, RSRPP data, RSSI data, RSRQ data, SINR data, or SNR data, among other examples), channel data (e.g., CFR data, CIR data, PDP data, DP data, CQI data, CSI data, decoding failure rate, or retransmission request rate, among other examples), AOA data, AOD data, TDOA data, RTT data, TA data, RSTD data, difference of RSTDs (diff-RSTD) data, RTOA data, difference of RTOAs (diff-RTOA) data, sensor data (e.g., image data, RF data, motion data, orientation data, or audio data, among other examples), or identifier data (e.g., cell ID data or SSID data, among other examples), among other examples.

FIG. 23B shows a block diagram 2300-b that supports data procedures associated with access stratum states or use cases in accordance with one or more aspects of the present disclosure. In some examples of the techniques described herein, a positioning device (e.g., location or sensing server, LMF, SnMF, SLP, UE, or other device) may utilize A-AI/ML (or indirect) positioning. In A-AI/ML, one or more AI models 2330 (e.g., machine learning model(s) or “A-AI/ML” model(s)) may be trained to utilize input data 2325 to output (e.g., infer or predict) one or more inferred measurements 2335. For instance, an AI/ML model may output a new measurement or an enhancement of a measurement (e.g., LOS/NLOS identification, timing of measurement, angle of measurement, or likelihood of measurement). The AI model(s) 2330 may be located at a wireless device or network entity (e.g., UE or network node). Examples of the input data 2325 may include reference signal data (e.g., measurements of a PRS, SRS, reference signal of an SSB, CSI-RS, DMRS, or TRS, among other examples), signal data (e.g., signal strength data, RSRP data, RSRPP data, RSSI data, RSRQ data, SINR data, or SNR data, among other examples), channel data (e.g., CFR data, CIR data, PDP data, DP data, CQI data, CSI data, decoding failure rate, or retransmission request rate, among other examples), AOA data, AOD data, TDOA data, RTT data, TA data, RSTD data, diff-RSTD data, RTOA data, diff-RTOA data, sensor data (e.g., image data, RF data, motion data, orientation data, or audio data, among other examples), or identifier data (e.g., cell ID data or SSID data, among other examples), among other examples. Examples of the inferred measurements 2335 may include one or more intermediate positioning measurements, timing measurements, Rx-Tx time difference measurements (e.g., from the perspective of a wireless device or network node), RSTD measurements, RTOA measurements, angle measurements, AOA measurements, AOD measurements, TDOA measurements, RTT measurements, a LOS indicator, LOS angles, or other values.

In A-AI/ML, the input data 2325 or AI model(s) 2330 may be structured in accordance with one or more approaches. Different model input structures may have different implications regarding model output accuracy, generalization, robustness, or model complexity.

In some approaches, a same AI model 2330 may be utilized (e.g., separately utilized) for input data 2325 from multiple (e.g., P) TRPs, where a separate input may be utilized for input data 2325 from each respective TRP. For instance, a first CIR corresponding to a first TRP may be utilized as an input for the AI model 2330 to generate a first TOA corresponding to the first TRP, a second CIR corresponding to a second TRP may be utilized as an input for the AI model 2330 to generate a second TOA corresponding to the second TRP, and an Kth CIR corresponding to an Kth TRP may be utilized as an input for the AI model 2330 to generate an Kth TOA corresponding to the Kth TRP. The first TOA, the second TOA, and the Kth TOA may be examples of the inferred measurements 2335.

In some approaches, different AI models 2330 (e.g., K AI models) may be utilized for input data 2325 from multiple (e.g., K) TRPs, where a separate input may be utilized for input data 2325 from each respective TRP. For instance, a first CIR corresponding to a first TRP may be utilized as an input for a first AI model to generate a first TOA corresponding to the first TRP, a second CIR corresponding to a second TRP may be utilized as an input for a second AI model to generate a second TOA corresponding to the second TRP, and an Kth CIR corresponding to an Kth TRP may be utilized as an input for an Kth AI model to generate an Kth TOA corresponding to the Kth TRP. The first AI model, the second AI model, and the Kth AI model may be examples of the AI models 2330. The first TOA, the second TOA, and the Kth TOA may be examples of the inferred measurements 2335.

In some approaches, one AI model 2330 may be utilized (e.g., jointly or concurrently utilized) for input data 2325 from multiple (e.g., P) TRPs, where a separate input may be utilized for input data 2325 from each respective TRP. For instance, a first CIR corresponding to a first TRP, a second CIR corresponding to a second TRP, and an Kth CIR corresponding to an Kth TRP may be utilized as inputs for the AI model 2330 to generate a first TOA corresponding to the first TRP, a second TOA corresponding to the second TRP, and an Kth TOA corresponding to the Kth TRP. The first TOA, the second TOA, and the Kth TOA may be examples of the inferred measurements 2335.

The inferred measurement(s) 2335 may be provided to, or utilized by, a positioning device (e.g., location or sensing server, LMF, SnMF, SLP, UE, or other device) to output a location 2345 (e.g., a position estimate, coordinates, or an address of a UE). For example, the positioning device may include a positioning component 2340. The positioning component may be, or may utilize, one or more other AI models (e.g., positioning model(s)) or non-AI models (trilateration with Chan's algorithm or a Kalman filter, among other examples) to determine the location 2345 (e.g., UE coordinates). In some examples, the AI model(s) 2330 and the positioning component 2340 may be implemented at the same device (e.g., location or sensing server, LMF, SnMF, SLP, UE, or other device) or at different devices. For network-assisted positioning, for instance, a UE may apply the AI model(s) 2330 to generate the inferred measurement(s) 2335, which may be reported to an network entity (e.g., location or sensing server or LMF, SnMF, among other examples). The network entity may apply the positioning component 2340 to generate the location 2345. For UE-based positioning, a device (e.g., a network node, location or sensing server, LMF, SnMF, or another UE with a sidelink connection to the UE) may apply the AI model(s) 2330 to generate the inferred measurement(s) 2335, which may be reported to the UE, which may apply the positioning component 2340 to generate the location 2345.

In some examples of non-AI/ML-based positioning, a path finding procedure (e.g., LOSQuad, multiple signal classification (MUSIC), or matching pursuit (MP), among other examples), may utilize input data (e.g., reference signal data (e.g., PRS or SRS measurements) or channel data (e.g., CFR data, CIR data, PDP data, or DP data) to produce intermediate positioning measurements. Examples of the intermediate positioning measurements may include Rx-Tx time difference measurements (e.g., from the perspective of a wireless device or network node), RSTD measurements, RTOA measurements, a LOS indicator, or other values. The intermediate positioning measurements may be provided to a positioning engine, which may perform one or more procedures (e.g., trilateration with Chan's algorithm or a Kalman filter, among other examples) to determine a location (e.g., UE coordinates). Some non-AI/ML-based positioning procedures (e.g., RAT-dependent positioning procedures) may fail in NLOS conditions. One or more AI/ML-based positioning procedures may enhance positioning accuracy in NLOS conditions because the AI/ML model(s) may learn a channel multipath profile and the profile's mapping to location information.

Some examples of the techniques described herein may be performed in conjunction with one or more of the D-AI/ML positioning described with reference to FIG. 23A or the A-AI/ML described with reference to FIG. 23B. For instance, one or more AI/ML models may be trained using the training data described with reference to FIG. 4. The one or more AI/ML models may be executed to perform one or more operations of one or more use cases.

FIG. 24 shows examples of block diagrams 2400 that support data procedures associated with access stratum states or use cases in accordance with one or more aspects of the present disclosure. A first scenario 2405 (e.g., “Case 1”) may be an example of UE-based positioning, where the UE includes an AI model. In the first scenario 2405, the AI model may be utilized for D-AI/ML positioning or A-AI/ML (e.g., UE-based positioning with UE-side A-AI/ML or D-AI/ML). For example, a network node may transmit a reference signal (e.g., PRS) to the UE. In a D-AI/ML positioning approach, the UE may execute the AI model based on measurements of the reference signal to determine a location. An indication of the location (e.g., UE coordinates) may be transmitted to the location or sensing server (e.g., LMF). In an A-AI/ML approach, the UE may execute the AI model based on measurements of the reference signal to determine one or more inferred measurements (e.g., based on the PRS). The UE may utilize the inferred measurement(s) to determine the location using another AI model or a non-AI model. An indication of the location may be transmitted to the location or sensing server.

A second scenario 2410 (e.g., “Case 2a”) may be an example of UE-assisted or location or sensing server-based positioning, where the UE includes an AI model. In the second scenario 2410, the AI model may be utilized for AI/ML assisted positioning (e.g., UE-assisted positioning with UE-side A-AI/ML). For example, a network node may transmit a reference signal (e.g., PRS) to the UE. In the A-AI/ML approach, the UE may execute the AI model based on measurements of the reference signal to determine one or more inferred measurements (e.g., based on the PRS). For instance, the inferred measurement(s) may include PRS-based measurement(s) (e.g., an RSTD, LOS indicator, or UE Rx-Tx time difference, among other examples) as model output(s). An indication of the inferred measurement(s) may be transmitted to the location or sensing server (e.g., LMF). The location or sensing server may utilize the inferred measurement(s) to determine the location using an AI model or non-AI model.

A third scenario 2415 (e.g., “Case 2b”) may be an example of UE-assisted or location or sensing server-based positioning, where the location or sensing server (e.g., LMF) includes an AI model (e.g., UE-assisted positioning with location or sensing server-side D-AI/ML). In the third scenario 2415, the AI model may be utilized for D-AI/ML positioning. For example, a network node may transmit a reference signal (e.g., PRS) to the UE. The UE may measure the reference signal and transmit an indication of the measurement(s) to the location or sensing server. In a D-AI/ML positioning approach, the location or sensing server may execute the AI model based on the measurement(s) of the reference signal to determine a location. For instance, the measurement(s) may include one or more PRS-based measurements as model input (e.g., CIR, PDP, DP, RSTD, diff-RSTD, RSRP, or RSRPP, among other examples).

A fourth scenario 2420 (e.g., “Case 3a”) may be an example of network node-assisted positioning, where the network node includes an AI model. In the fourth scenario 2420, the AI model may be utilized for A-AI/ML (e.g., network node-assisted positioning with network node-side A-AI/ML). For example, a UE may transmit a reference signal (e.g., SRS) to the network node. The network node may measure the reference signal. In the A-AI/ML approach, the network node may execute the AI model based on a measurement(s) of the reference signal to determine one or more inferred measurements (e.g., based on the SRS). For instance, the inferred measurement(s) may include an SRS-based measurement as model output (e.g., an RTOA, LOS indicator, network node Rx-Tx time difference, among other examples). An indication of the inferred measurement(s) may be transmitted to the location or sensing server (e.g., LMF). The location or sensing server may utilize the inferred measurement(s) to determine the location using an AI model or a non-AI model.

A fifth scenario 2425 (e.g., “Case 3b”) may be an example of network node-assisted positioning, where the location or sensing server (e.g., LMF) includes an AI model. In the fifth scenario 2425, the AI model may be utilized for D-AI/ML positioning (e.g., network node-assisted positioning with location or sensing server-side D-AI/ML). For example, a UE may transmit a reference signal (e.g., SRS) to the network node. The network node may measure the reference signal (e.g., based on the SRS) and transmit an indication of the measurement(s) to the location or sensing server. For instance, the measurement(s) may include an SRS-based measurement as model input (e.g., CIR, PDP, DP, RTOA, diff-RTOA, RSRP, or RSRPP, among other examples). In a D-AI/ML positioning approach, the location or sensing server may execute the AI model based on the measurement(s) of the reference signal to determine a location.

Some examples of the techniques described herein may utilize one or more AI/ML models. For instance, some of the techniques may be utilized for signaling or protocol aspects for enabling AI/ML model selection, activation, deactivation, switching, or fallback. Some techniques may provide a signaling mechanism of one or more applicable functionalities or models. Some aspects may be utilized for identification related signaling, other signaling, or mechanism(s) to facilitate model training, inference, performance monitoring, or data collection of UE-sided model training data for UE-sided or network-sided AI models (e.g., with or without data collection for core network, operations, administration, and maintenance (OAM), or an over-the-top (OTT) device).

Some examples of the techniques described herein may provide positioning accuracy enhancements for D-AI/ML positioning or A-AI/ML positioning. D-AI/ML scenarios may include Case 1 (e.g., UE-based positioning with a UE-side AI model and D-AI/ML positioning), Case 2b (e.g., UE-assisted or location or sensing server-based positioning with an location or sensing server-side AI model and D-AI/ML positioning), Case 3b: NG-RAN node assisted positioning with an location or sensing server-side AI model and D-AI/ML positioning). A-AI/ML scenarios may include Case 2a (e.g., UE-assisted or location or sensing server-based positioning with a UE-side AI model and A-AI/ML positioning) or Case 3a (e.g., NG-RAN node assisted positioning with a gNB-side AI model and A-AI/ML positioning.

Some examples of the techniques described herein may include measurement aspects, signaling, or one or more other mechanisms to facilitate one or more operations (e.g., LCM operations) related to positioning accuracy enhancements. Some aspects may include measurement signaling or approaches to help ensure correspondence or alignment between training and inferencing related to network-side conditions for performing inferencing at a UE for positioning scenarios. Some aspects may be utilized for performance monitoring.

One or more of the techniques described herein may be utilized for AI model identification or procedures for utilizing an AI model. In some examples, a network entity (e.g., core network device, OAM device, or OTT device) may collect UE-sided model training data. In some approaches, an AI model may be communicated (e.g., transferred or delivered) between devices. In some aspects, one-sided models or two-sided models may be utilized. For example, a wireless device and network entity may interoperate. Performance monitoring or testing (e.g., static or non-static scenarios, propagation conditions for clustered delay line (CDL) or field data, among other examples) may be utilized in some approaches.

In some examples, offline or online AI model training may be utilized. Post-deployment validation may be performed to manage AI model changes or drift over time.

Some examples of the techniques described herein may be performed in conjunction with one or more of the scenarios (e.g., the first scenario 2405, the second scenario 2410, the third scenario 2415, the fourth scenario 2420, or the fifth scenario 2425) described with reference to FIG. 24. It should be noted that while examples of some scenarios are illustrated in FIG. 24, other scenarios in which a device (e.g., wireless device, network entity, UE, network node, location or sensing server, or LMF, SnMF, among other examples) may receive a reference signal, measure a reference signal, report measurements, infer measurements, infer a location, or report a location may be implemented.

For AI/ML assisted positioning with UE-assisted positioning (Case 2a) or NG-RAN node-assisted positioning (Case 3a), a measurement report may include or indicate a model output to the location or sensing server. A measurement report may include information indicating TOA, path phase, RSTD, a LOS or NLOS indicator, or RSRPP. In some approaches, a measurement report may include probabilistic (e.g., soft) information or an increased resolution of RSTD. One or more AI model inference outputs may improve performance, such as timing estimation (where a report to the location or sensing server may be derived based on the AI model inference output or may be different from the model inference output, for instance), or a LOS or NLOS indicator. Assistance signaling (e.g., reference signal configuration information) may be utilized to facilitate model inferencing for a UE-side or network-side model(s).

For AI/ML assisted positioning (e.g., Case 3a), an LOS indicator, NLOS indicator, or timing information may be supported for reporting. If an LOS indicator or NLOS indicator is reported, the indicator can be reported as a soft indicator or a hard indicator. If timing information is reported, the timing information may be reported via UL RTOA or gNB Rx-Tx time difference. For AI/ML assisted positioning (e.g., Case 2a), an LOS indicator, NLOS indicator, or timing information may be supported for reporting. If the LOS indicator or NLOS indicator is reported, the indicator may be reported as a soft indicator or a hard indicator. If timing information is reported, the timing information may be reported via downlink RSTD or UE Rx-Tx time difference.

FIG. 25 shows examples of sensing modes 2500 that support data procedures associated with access stratum states or use cases in accordance with one or more aspects of the present disclosure. Various sensing modes are illustrated in the context of one or more devices (e.g., TRPs and UEs). While TRPs are illustrated in FIG. 25, a TRP may instead be a base station (e.g., gNB) in some examples. The objects illustrated in FIG. 25 may be devices (e.g., UEs, AGVs, or vehicles, among other examples) or passive objects (e.g., roads, signs, barriers, or rocks, among other examples).

One or more sensing operations may be performed in accordance with one or more of the techniques described herein. Sensing operations may include monostatic sensing (e.g., radar-like sensing, where a sensing transmitter and a sensing receiver may be co-located in the same entity) or bistatic sensing (e.g., where a sensing receiver and sensing transmitter are located in different entities). Multi-static sensing may be performed in some examples, where multiple sensing transmitters or receivers may be utilized.

In some approaches, one or more reflections of a sensing signal sent from a sensing transmitter may be received by a sensing receiver and processed to determine one or more characteristics of the sensed object or an environment (e.g., location). In sensing operations, one or more sensing signal reflections may be received. The sensing signal reflections may be processed locally (e.g., in a device that received the sensing signal reflections) or may be communicated to another device for processing. For instance, a device may execute one or more AI/ML models to determine a position of the object based on the sensing signal reflections.

An example of monostatic TRP sensing 2505 is given in FIG. 25. For example, a TRP (e.g., gNB) may transmit a signal and receive a signal reflection from the object.

An example of monostatic UE sensing 2510 is given in FIG. 25. For example, a UE may transmit a signal and receive a signal reflection from the object.

An example of bistatic TRP-to-TRP sensing 2515 is given in FIG. 25. For example, a first TRP (e.g., a first gNB) may transmit a signal, and a second TRP may receive a signal reflection from the object.

An example of bistatic TRP-to-UE sensing 2520 is given in FIG. 25. For example, a TRP (e.g., a gNB) may transmit a signal, and a UE may receive a signal reflection from the object.

An example of bistatic UE-to-TRP sensing 2525 is given in FIG. 25. For example, a UE may transmit a signal, and a TRP may receive a signal reflection from the object.

An example of bistatic UE-to-UE sensing 2530 is given in FIG. 25. For example, a first UE may transmit a signal, and a second UE may receive a signal reflection from the object.

In some aspects, one or more of the AI/ML-based positioning or sensing procedures or communications (e.g., capability information, request information, indications, or meaning information, among other examples) described herein may be utilized for one or more sensing use cases. For instance, sensing may be performed to determine a position or motion of an object (e.g., a wireless device or other object). Examples of sensing use cases may include one or more of transportation, unmanned aerial vehicles (UAVs), smart cities, smart homes, smart factories, or health monitoring. For instance, a transportation use case may include intrusion detection on a highway, sensing assisted automotive maneuvering or navigation, smart parking, or other assistance, among other examples. A UAV use case may include UAV flight trajectory tracing or sensing for UAV intrusion detection, among other examples. A smart city use case may include rainfall monitoring, tourist spot traffic management, flooding awareness, weather forecasting, or public safety search and rescue, among other examples. A smart home use case may include intruder detection in a smart home, gesture recognition, or extended reality (XR) streaming, among other examples. A smart factory use case may include automated guided vehicle (AGV) detection and tracking in factories or inventory tracking, among other examples. A health monitoring use case may include monitoring vital signs and health related measures, sleep monitoring, or health monitoring, among other examples. Examples of sensing modes that may be employed in some examples of the techniques may be implemented in the wireless communications system (e.g., the wireless device 415 or the network entity 405) described with reference to FIG. 4.

In some examples, one or more of the AI/ML models described herein may correspond to one or more sensing key performance indicators (KPIs) (with equivalent A-AI/ML sensing or D-AI/ML sensing). Some examples of sensing KPIs may include an accuracy of positioning (e.g., horizontal or vertical), an accuracy of range or cross-range of target, an accuracy of AOA of a target (e.g., azimuth or elevation), an accuracy of velocity (e.g., horizontal or vertical), a sensing range or cross-range resolutions, a sensing velocity resolution, a sensing angle resolution, a sensing latency, a sensing refreshing rate, a receiver operating characteristics (ROC) (e.g., misdetection or false alarm probabilities), a confidence interval or level of sensing, or target discrimination.

Some examples of the techniques described herein may utilize one or more terms relating to sensing. Sensing data may include data derived from one or more radio signals impacted (e.g., reflected, refracted, diffracted) by an object or environment of interest for sensing purposes, and optionally processed. 5G Wireless sensing (5GS) may be a feature providing one or more capabilities to obtain information about characteristics of the environment or objects within the environment (e.g., shape, size, orientation, speed, location, distances or relative motion between objects, among other examples) using radio frequency signals. Non-3GPP sensing data may be data provided by non-3GPP sensors (e.g., video, LIDAR, sonar) about an object or environment of interest for sensing purposes. Sensing assistance information may be information that is provided to a wireless system from a third-party and may be used to support the derivation of a sensing result. Examples of sensing assistance information may include map information, area information, a UE ID attached to or in the proximity of the sensing target, UE position information, or UE velocity information, among other examples.

Sensing contextual information may be information that is exposed with the sensing results by a wireless system to a third-party which provides context to the conditions under which the sensing results were derived. Examples may include map information, area information, time of capture, UE location, or an identifier. This contextual information may be required in scenarios where the sensing result is to be combined with data from other sources outside the 5GS. A sensing group may be a set of sensing transmitters and sensing receivers whose location is known and whose sensing data can be collected synchronously. A sensing receiver may be an entity that receives a sensing signal which a sensing service may use in operation. A sensing receiver may be part of a RAN node or a UE. A sensing receiver may be located in the same or different entity as the sensing transmitter. A sensing result may be processed sensing data requested by a service consumer. Sensing signals may be transmissions on a radio interface that can be used for sensing purposes. Some approaches may refer to NR radio frequency signals which, in some cases.

A sensing transmitter may be an entity that sends out a sensing signal which the sensing service will use in its operation. A sensing transmitter may be part of a RAN node or a UE. A sensing transmitter may be located in the same or different entity as the sensing receiver. A target sensing service area may be a cartesian location area to be sensed by deriving characteristics of the environment or objects within the environment with certain sensing service quality from the impacted (e.g., reflected, refracted, diffracted) radio signals. This may include indoor or outdoor environments.

RF sensing may extend positioning capabilities to one or more applications. Factors affecting sensing performance may include RCS, mobility, or clutter/scattering patterns. One or more channel modeling aspects may be utilized to support object detection or tracking. A modeling framework may be capable of detecting or tracking one or more objects and to enable them to be distinguished from unintended objects. Some examples of objects may include UAVs, humans (indoors or outdoors), automotive vehicles (at least outdoors), automated guided vehicles (e.g., in indoor factories), or objects creating hazards on roads/railways (e.g., with a minimum size dependent on frequency). In some examples, one or more frequencies from 0.5 to 52.6 GHz may be utilized, with scalability to 100 GHz.

For one or more use cases, sensing modes and frequencies, deployment scenarios may be identified corresponding to one or more use cases. Channel modeling may be utilized for sensing. One or more measurements may be utilized for modeling of sensing targets or a background environment, including, for example, radar cross-section (RCS), mobility, clutter/scattering patterns, or spatial reliability.

In some examples, a sensing data signal processing flow may be performed from Analog-to-Digital Converter (ADC) samples to progressively higher-level data representations. From low levels to high levels, the data types may include raw data, a range-angle-Doppler (RAD) tensor, a point cloud, or grid map. Learning-based frameworks may be utilized, which may support the encoding and decoding of different representation types, and additional quantization can be adopted to reduced data size. For integrated sensing and communication, for instance, one or more types of data representations may be utilized, which may include data quantization, range fast Fourier transform (FFT), Doppler FFT, angle FFT, RAD tensor, point cloud, voxel grids, neural network (NN)-based representations, or parametric objects. In some examples, an ADC signal may be utilized to obtain one or more of the types of representations. In some aspects, a deep learning framework or quantization may be applied for one or more (e.g., all) types of representations. One or more types of representations may be provided to an SnMF for one or more sensing operations.

One or more of the data representations are described as follows. Data quantization: at a relatively low (e.g., lowest) level, sampling and quantization of the sensing signal may be initial operations. To reduce the volume of data that needs to be processed, various techniques may be utilized. Some approaches, such as compressed sensing, may exploit the sparsity of the signal to acquire the signal at a lower sampling rate. Other approaches may use relatively low-bit quantization to reduce complexity and power consumption at the TRP. In particular, the power consumption of ADCs in hybrid architectures may grow exponentially to the number of quantization levels, thus elevating the significance of ADC quantization. In some cases, sampling may be performed with one bit per sample, significantly reducing the data volume to be transmitted by the TRP. Data quantization may be combined with other representations, such as RAD tensors or point clouds, among other examples. Data quantization may be used as the format of data to be exchanged in a case of signal-level fusion where the sensing data is sent directly to a fusion center without performing any further local processing.

RAD tensors: range-angle and range-Doppler maps may be data representations in radar signal processing. The maps may provide a structured way to visualize or analyze spatial or velocity information of detected targets. In the context of integrated sensing and communication, the maps may be useful for tasks like target detection, localization, and tracking.

Point clouds: point clouds may be versatile data representations that may be utilized in various sensing applications, including radar, LiDAR, or computer vision. In the context of integrated sensing and communication, point clouds may provide a spatial representation of multiple targets by capturing discrete points in a three-dimensional space. Each point in the cloud may contain information about the target's range, velocity, azimuth angle, or elevation angle.

Voxel grids: voxel grids may be another form of data representation where the 3D space is divided into a grid of volumetric pixels (voxels). Each voxel can store information such as occupancy, intensity, or other attributes. Voxel grids may be useful for representing an environment in autonomous driving and robotics applications. Voxel grids may provide a structured representation that may be processed by algorithms but can be memory intensive.

Deep Learning-Based Representations: advancements in deep learning may lead to the development of various data representations. For instance, radar data may be transformed into images or tensors that are fed into convolutional neural networks (CNNs) for tasks such as object detection or classification. The representations may leverage deep learning to extract high-level features from raw data, which may improve the accuracy or robustness of sensing systems. Variational auto-encoders (VAE) may be utilized, which may project input data into a distribution over the latent space. In particular, the following forms of deep learning representations may be utilized: embeddings, feature vectors (e.g., outputs of feature extraction layers), or layer weights.

Parametric object representations: by performing object segmentation over point clouds, scene information may be conveyed with relatively less data. This operation may involve: (i) employing clustering algorithms to separate the point cloud into groups that correspond to different environment objects; and (ii) unifying the points of each group to a compact representation, therefore unveiling the shape of each object. To describe shapes of 3D objects, multiple approaches may be taken, such as polygon representations (represented as the convex hulls of each point cloud group), wireframes (interconnected sets of edges), or general parametric shapes, where each shape is represented by the set of its geometric parameters (e.g., center and radius for 3D balls). While accurately representing real objects with geometrical shapes may present challenges, such representation may be utilized such that relatively few bytes of information may be transmitted to describe a scene.

Some examples of the techniques described herein may be utilized for sensing. For instance, one or more of the procedures described with reference to FIG. 4 may be utilized to collect measurements (e.g., sensing measurements) or data for performing one or more sensing procedures.

The following provides an overview of aspects of the present disclosure:

Aspect 1: A method for wireless communications by a wireless device, comprising: outputting (e.g., transmitting), to one or more network entities based at least in part on one or more use cases, capability information indicating a capability of the wireless device to participate in a data collection procedure, wherein the capability information indicates one or more parameters for the data collection procedure, and wherein the data collection procedure is associated with data for training an AI/ML model for the one or more use cases; and obtaining (e.g., receiving), from the one or more network entities based at least in part on the one or more use cases, configuration information indicating that the wireless device is configured for the data collection procedure.

Aspect 2: The method of aspect 1, wherein the capability information indicates at least one of the one or more use cases corresponding to the capability of the wireless device to participate in the data collection procedure.

Aspect 3: The method of any of aspects 1 through 2, wherein the one or more use cases comprise an AI/ML-based CSI feedback use case, an AI/ML-based beam management use case, an AI/ML-based mobility use case, an AI/ML-based positioning use case, an AI/ML-based cell reselection use case, an AI/ML-based RACH procedure, or a use case for AI/ML-based power management based at least in part on the one or more access stratum states.

Aspect 4: The method of any of aspects 1 through 3, wherein the one or more parameters indicated by the capability information comprise a quantity of samples of at least a portion of the data, a size of at least a portion of the data, an age of at least a portion of the data, a quality of the data collected (e.g., in at least one of the one or more access stratum states or of the one or more use cases), or any combination thereof.

Aspect 5: The method of any of aspects 1 through 4, wherein the one or more access stratum states comprise a connected state, an inactive state, or an idle state, and the configuration information indicates that the wireless device is configured to participate in the data collection procedure in at least one of the connected state, the inactive state, the idle state, or any combination thereof.

Aspect 6: The method of any of aspects 1 through 5, further comprising: participating in the data collection procedure for the at least one of the one or more access stratum states based at least in part on the configuration information, wherein participating in the data collection procedure comprises performing one or more measurements associated with data collection, data logging, data reporting, or any combination thereof.

Aspect 7: The method of any of aspects 1 through 6, further comprising: outputting (e.g., transmitting), to the one or more network entities based at least in part on the one or more use cases, an indication of availability of the data.

Aspect 8: The method of aspect 7, wherein the indication of availability indicates at least one of the one or more use cases associated with the data.

Aspect 9: The method of any of aspects 7 through 8, wherein the indication of availability indicates a quantity of samples of the data, a size of the data, an age of the data corresponding to at least one of the one or more use cases, or a quality of the data collected (e.g., in at least one of the one or more access stratum states or of the one or more use cases).

Aspect 10: The method of any of aspects 1 through 9, further comprising: obtaining (e.g., receiving), from at least one of the one or more network entities, a request for at least a portion of the data.

Aspect 11: The method of aspect 10, wherein the request indicates a condition to select the at least a portion of the data, and the at least a portion of the data is selected based at least in part on the condition.

Aspect 12: The method of aspect 11, wherein the condition comprises a quantity of samples of the at least a portion of the data, a size of the at least a portion of the data, an age of the at least a portion of the data, a use case of the at least a portion of the data, a quality of the at least a portion of the data collected (e.g., in at least one of the one or more access stratum states or of the one or more use cases), or any combination thereof.

Aspect 13: The method of any of aspects 1 through 12, further comprising: outputting (e.g., transmitting), to at least one of the one or more network entities, at least a portion of the data.

Aspect 14: The method of aspect 13, further comprising: outputting (e.g., transmitting), to at least one of the one or more network entities, an indication of an access stratum state associated with the at least a portion of the data, an indication of a configuration identifier associated with the at least a portion of the data, or an indication of a level of a configuration associated with the at least a portion of the data.

Aspect 15: The method of any of aspects 13 through 14, wherein outputting (e.g., transmitting) the at least a portion of the data comprises outputting (e.g., transmitting) all of the data to the one or more network entities, outputting (e.g., transmitting) the at least a portion of the data based at least in part on at least one use case, or outputting (e.g., transmitting) the at least a portion of the data based at least in part on a requested size or quantity of samples.

Aspect 16: The method of any of aspects 1 through 15, wherein the configuration information indicates at least one use case and at least one access stratum state for performing one or more measurements associated with data collection, for performing data logging, for performing data reporting, or any combination thereof.

Aspect 17: The method of any of aspects 1 through 16, wherein the configuration information indicates a first level of the data collection procedure and a second level of the data collection procedure for at least one use case or for at least one access stratum state, and the second level of the data collection procedure utilizes fewer resources than the first level.

Aspect 18: The method of aspect 17, wherein the second level of the data collection procedure is associated with an operating condition of the wireless device.

Aspect 19: The method of any of aspects 1 through 18, wherein the wireless device is a UE, and the one or more network entities comprise a network node, a network function, an AMF, a LMF, SnMF, or a server.

Aspect 20: A method for wireless communications by a network entity, comprising: obtaining (e.g., receiving), from a wireless device based at least in part on one or more use cases, capability information indicating a capability of the wireless device to participate in a data collection procedure, wherein the capability information indicates one or more parameters for the data collection procedure, and wherein the data collection procedure is associated with data for training an AI/ML model for the one or more use cases; and outputting (e.g., transmitting), to the wireless device based at least in part on the one or more use cases, configuration information indicating that the wireless device is configured for the data collection procedure.

Aspect 21: The method of aspect 20, wherein the capability information indicates at least one of the one or more use cases corresponding to the capability of the wireless device to participate in the data collection procedure.

Aspect 22: The method of any of aspects 20 through 21, wherein the one or more use cases comprise an AI/ML-based CSI feedback use case, an AI/ML-based beam management use case, an AI/ML-based mobility use case, an AI/ML-based positioning use case, an AI/ML-based cell reselection use case, an AI/ML-based RACH procedure, or a use case for AI/ML-based power management based at least in part on the one or more access stratum states.

Aspect 23: The method of any of aspects 20 through 22, wherein the one or more parameters indicated by the capability information comprise a quantity of samples of at least a portion of the data, a size of at least a portion of the data, or an age of at least a portion of the data, a quality of the data collected (e.g., in at least one of the one or more access stratum states or of the one or more use cases), or any combination thereof.

Aspect 24: The method of any of aspects 20 through 23, wherein the one or more access stratum states comprise a connected state, an inactive state, or an idle state, and the configuration information indicates that the wireless device is configured to participate in the data collection procedure in at least one of the connected state, the inactive state, the idle state, or any combination thereof.

Aspect 25: The method of any of aspects 20 through 24, further comprising: obtaining (e.g., receiving), from the wireless device based at least in part on the one or more use cases, an indication of availability of the data.

Aspect 26: The method of aspect 25, wherein the indication of availability indicates at least one of the one or more use cases associated with the data.

Aspect 27: The method of any of aspects 25 through 26, wherein the indication of availability indicates a quantity of samples of the data, a size of the data, an age of the data corresponding to at least one of the one or more use cases, or a quality of the data collected (e.g., in at least one of the one or more access stratum states or of the one or more use cases).

Aspect 28: The method of any of aspects 20 through 27, further comprising: outputting (e.g., transmitting), to the wireless device, a request for at least a portion of the data.

Aspect 29: The method of aspect 28, wherein the request indicates a condition to select the at least a portion of the data, and the at least a portion of the data is selected based at least in part on the condition.

Aspect 30: The method of aspect 29, wherein the condition comprises a quantity of samples of the at least a portion of the data, a size of the at least a portion of the data, an age of the at least a portion of the data, a use case of the at least a portion of the data, a quality of the at least a portion of the data collected (e.g., in at least one of the one or more access stratum states or of the one or more use cases), or any combination thereof.

Aspect 31: The method of any of aspects 20 through 30, further comprising: obtaining (e.g., receiving), from the wireless device, at least a portion of the data.

Aspect 32: The method of aspect 31, further comprising: obtaining (e.g., receiving), from the wireless device, an indication of an access stratum state associated with the at least a portion of the data, an indication of a configuration identifier associated with the at least a portion of the data, or an indication of a level of a configuration associated with the at least a portion of the data.

Aspect 33: The method of any of aspects 31 through 32, wherein obtaining (e.g., receiving) the at least a portion of the data comprises obtaining (e.g., receiving) all of the data from the wireless device, obtaining (e.g., receiving) the at least a portion of the data based at least in part on at least one use case, or obtaining (e.g., receiving) the at least a portion of the data based at least in part on a requested size or quantity of samples.

Aspect 34: The method of any of aspects 20 through 33, wherein the configuration information indicates at least one use case and at least one access stratum state for performing one or more measurements associated with data collection, for performing data logging, for performing data reporting, or any combination thereof.

Aspect 35: The method of any of aspects 20 through 34, wherein the configuration information indicates a first level of the data collection procedure and a second level of the data collection procedure for at least one use case or for at least one access stratum state, and the second level of the data collection procedure utilizes fewer resources than the first level.

Aspect 36: The method of aspect 35, wherein the second level of the data collection procedure is associated with an operating condition of the wireless device.

Aspect 37: The method of any of aspects 20 through 36, wherein the wireless device is a UE, and the network entity comprises a network node, a network function, an AMF, a LMF, SnMF, or a server.

Aspect 38: A wireless device comprising one or more memories storing processor-executable code, and one or more processors coupled with the one or more memories and individually or collectively operable to execute the code to cause the wireless device to perform a method of any of aspects 1 through 19.

Aspect 39: A wireless device comprising at least one means for performing a method of any of aspects 1 through 19.

Aspect 40: A non-transitory computer-readable medium storing code the code comprising instructions executable by one or more processors to perform a method of any of aspects 1 through 19.

Aspect 41: A network entity comprising one or more memories storing processor-executable code, and one or more processors coupled with the one or more memories and individually or collectively operable to execute the code to cause the network entity to perform a method of any of aspects 20 through 37.

Aspect 42: A network entity comprising at least one means for performing a method of any of aspects 20 through 37.

Aspect 43: A non-transitory computer-readable medium storing code the code comprising instructions executable by one or more processors to perform a method of any of aspects 20 through 37.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations. For instance, one or more processors that are individually or collectively configured to perform multiple operations may mean that all of the multiple operations may be performed by one processor, each of the multiple operations may be performed by a respective processor, subsets of an operation may be performed by one or multiple processors, an operation and a subset of another operation may be performed by one processor, a first processor may perform a first portion of the one or more operations while a group of processors (that includes or excludes the first processor) may perform a second portion of the one or more operations, or any possible combination thereof.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations. For instance, one or more memories that are individually or collectively configured to perform multiple operations may mean that all of the multiple operations may be performed by one memory, each of the multiple operations may be performed by a respective memory, subsets of an operation may be performed by one or multiple memories, an operation and a subset of another operation may be performed by one memory, a first memory may perform a first portion of the one or more operations while a group of memories (that includes or excludes the first memory) may perform a second portion of the one or more operations, or any possible combination thereof.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples. ” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories, wherein the one or more processors are individually or collectively configured to cause the wireless device to:
transmit, to one or more network entities based at least in part on one or more use cases, capability information indicating a capability of the wireless device to participate in a data collection procedure, wherein the capability information indicates one or more parameters for the data collection procedure, and wherein the data collection procedure is associated with data for the one or more use cases; and
receive, from the one or more network entities based at least in part on the one or more use cases, configuration information that indicates that the wireless device is configured for the data collection procedure.

2. The wireless device of claim 1, wherein the capability information indicates at least one of the one or more use cases corresponding to the capability of the wireless device to participate in the data collection procedure.

3. The wireless device of claim 1, wherein the one or more use cases comprise an artificial intelligence or machine learning (AI/ML)-based channel state information (CSI) feedback use case, an AI/ML-based beam management use case, an AI/ML-based mobility use case, an AI/ML-based positioning use case, an AI/ML-based cell reselection use case, an AI/ML-based random access channel (RACH) procedure, a use case for AI/ML-based power management, a non-AI/ML-based CSI feedback use case, a non-AI/ML-based beam management use case, a non-AI/ML-based mobility use case, a non-AI/ML-based positioning use case, a non-AI/ML-based cell reselection use case, a non-AI/ML-based RACH procedure, a use case for non-AI/ML-based power management, or a sensing use case.

4. The wireless device of claim 1, wherein the one or more parameters indicated by the capability information comprise a quantity of samples of at least a portion of the data, a size of at least a portion of the data, an age of at least a portion of the data, a quality of the data collected, or any combination thereof.

5. The wireless device of claim 1, wherein:
one or more access stratum states comprise a connected state, an inactive state, or an idle state, and
the configuration information indicates that the wireless device is configured to participate in the data collection procedure in at least one of the connected state, the inactive state, the idle state, or any combination thereof.

6. The wireless device of claim 1, wherein the one or more processors are individually or collectively further configured to cause the wireless device to:
participate in the data collection procedure for at least one of one or more access stratum states based at least in part on the configuration information, wherein participation in the data collection procedure comprises performing one or more measurements associated with data collection, data logging, data reporting, or any combination thereof.

7. The wireless device of claim 1, wherein the one or more processors are individually or collectively further configured to cause the wireless device to:
transmit, to the one or more network entities based at least in part on the one or more use cases, an indication of availability of the data.

8. The wireless device of claim 1, wherein the one or more processors are individually or collectively further configured to cause the wireless device to:
receive, from at least one of the one or more network entities, a request for at least a portion of the data.

9. The wireless device of claim 1, wherein the one or more processors are individually or collectively further configured to cause the wireless device to:
transmit, to at least one of the one or more network entities, at least a portion of the data.

10. The wireless device of claim 1, wherein:
the configuration information indicates at least one use case or at least one access stratum state for performing one or more measurements associated with data collection, for performing data logging, for performing data reporting, or any combination thereof.

11. The wireless device of claim 1, wherein:
the configuration information indicates a first level of the data collection procedure and a second level of the data collection procedure for at least one use case or for at least one access stratum state, and
the second level of the data collection procedure utilizes fewer resources than the first level.

12. The wireless device of claim 1, wherein:
the wireless device is a user equipment (UE), and
the one or more network entities comprise a network node, a network function, an access and mobility management function (AMF), a location management function (LMF), a sensing management function (SnMF), or a server.

13. A network entity, comprising:
one or more memories storing processor-executable code; and
one or more processors coupled with the one or more memories, wherein the one or more processors are individually or collectively configured to cause the network entity to:
receive, from a wireless device based at least in part on one or more use cases, capability information indicating a capability of the wireless device to participate in a data collection procedure, wherein the capability information indicates one or more parameters for the data collection procedure, and wherein the data collection procedure is associated with data for the one or more use cases; and
transmit, to the wireless device based at least in part on the one or more use cases, configuration information that indicates that the wireless device is configured for the data collection procedure.

14. The network entity of claim 13, wherein the capability information indicates at least one of the one or more use cases corresponding to the capability of the wireless device to participate in the data collection procedure.

15. The network entity of claim 13, wherein the one or more use cases comprise an artificial intelligence or machine learning (AI/ML)-based channel state information (CSI) feedback use case, an AI/ML-based beam management use case, an AI/ML-based mobility use case, an AI/ML-based positioning use case, an AI/ML-based cell reselection use case, an AI/ML-based random access channel (RACH) procedure, a use case for AI/ML-based power management, a non-AI/ML-based CSI feedback use case, a non-AI/ML-based beam management use case, a non-AI/ML-based mobility use case, a non-AI/ML-based positioning use case, a non-AI/ML-based cell reselection use case, a non-AI/ML-based RACH procedure, a use case for non-AI/ML-based power management, or a sensing use case.

16. The network entity of claim 13, wherein the one or more parameters indicated by the capability information comprise a quantity of samples of at least a portion of the data, a size of at least a portion of the data, or an age of at least a portion of the data, a quality of the data collected, or any combination thereof.

17. The network entity of claim 13, wherein:
one or more access stratum states comprise a connected state, an inactive state, or an idle state, and
the configuration information indicates that the wireless device is configured to participate in the data collection procedure in at least one of the connected state, the inactive state, the idle state, or any combination thereof.

18. The network entity of claim 13, wherein the one or more processors are individually or collectively further configured to cause the network entity to:
receive, from the wireless device based at least in part on the one or more use cases, an indication of availability of the data.

19. The network entity of claim 13, wherein the one or more processors are individually or collectively further configured to cause the network entity to:
transmit, to the wireless device, a request for at least a portion of the data.

20. A method for wireless communications by a wireless device, comprising:
transmitting, to one or more network entities based at least in part on one or more use cases, capability information indicating a capability of the wireless device to participate in a data collection procedure, wherein the capability information indicates one or more parameters for the data collection procedure, and wherein the data collection procedure is associated with data for the one or more use cases; and
receiving, from the one or more network entities based at least in part on the one or more use cases, configuration information indicating that the wireless device is configured for the data collection procedure.
